(19) United States
(12) Patent Application Publication
(10) Pub. No.: US 2026/0045791 A1
(43) Pub. Date: Feb. 12, 2026

(54) ELECTRICAL LINE SELECTOR SYSTEM HAVING MULTIPLE SOURCES

(71) Applicant: RELECTRIFY HOLDINGS PTY LTD, Melbourne (AU)

(72) Inventors: Daniel CROWLEY, Melbourne (AU); Antonio Pietro ROCCO, Melbourne (AU); David Elias JAHSHAN, Melbourne (AU); Zhe ZHANG, Melbourne (AU); Jan Valentin MUENZEL, Melbourne (AU); Niall Peter MAI, Melbourne (AU)

(21) Appl. No.: 18/997,799

(22) PCT Filed: Jul. 21, 2023
(86) PCT No.: PCT/AU2023/050669

§ 371 Date: Jan. 22, 2025

(30) Foreign Application Priority Data
Jul. 21, 2022 (AU) 2022902045

(51) Int. Cl. H02J 1/08; B60L 53/22; B60L 53/51; H02J 7/00; H02J 7/35

(52) U.S. Cl. CPC H02J 1/084; B60L 53/22; B60L 53/51; H02J 7/0048; H02J 7/35

(57) ABSTRACT

An electrical line selection system comprising a circuit module configured to connect energy sources with multiple line outputs. The circuit module has a number of inputs configured to connect to energy sources, including rechargeable battery systems, and a number of outputs configured to connect with other electrical systems such as other battery systems, loads, charging sources, and various AC or DC power supplies. A switching circuit is contained by the circuit module and a controller manages the switching circuit based on desired connections and strategies for managing power supplies and current sinks.

### TECHNICAL FIELD

The invention described herein generally relates to an electrical system, in particular an electrical system for generating a controllable voltage profile and/or for receiving a voltage profile.

### BACKGROUND

Energy storage is an important factor in energy and transportation sectors, especially for industries, power grids, electric vehicles, and homes. Battery technologies, such as lithium-ion batteries, represent a leading means of energy storage. Battery packs typically consist of one or more cells, each of which has a positive electrode (the cathode), a negative electrode (the anode), a separator and an electrolyte. Using different chemicals and materials for these components affects the properties of the battery—how much energy it can store and supply, how much power it can provide or the number of times it can be discharged and recharged, which is conventionally referred to as a battery's cycle life.

Various types of battery packs are used these days to store energy. A battery pack typically includes a set of any number of identical batteries or individual battery cells configured in a series, parallel or a mixture of both to deliver the desired voltage, capacity, or power density.

Conventional battery pack architecture can only provide voltage output that is substantially direct current (DC), and then uses either a single-phase inverter to provide single-phase alternating current (AC) or a three-phase inverter to provide three-phase alternating current (AC).

With recent advancements, advanced battery pack architectures with series-module or series-cell connectivity series-control are becoming available that can provide AC and/or rectified AC voltage outputs directly at the battery pack terminals. Some of these series-control battery pack architectures can alternatively also provide substantially DC voltage outputs. These AC and/or rectified AC voltage outputs are typically provided as a two-line output, i.e. forming a single phase.

### SUMMARY

This summary is provided to introduce concepts related to an output selector in a battery system and a method thereof. This summary is neither intended to identify essential features of the present invention nor intended to determine or limit the scope of the present invention.

In one broad aspect the present invention, there is provided a circuit module configured to connect to energy sources, comprising: two or more inputs comprising: a first input configured to connect to a first energy source, a second input configured to connect to a second energy source; three or more electrical lines comprising: a first set of electrical lines comprising a first electrical line and a second electrical line, a second set of electrical lines comprising the first electrical line and a third electrical line; and a switching circuit configured to selectively operate in states comprising: a first state in which the first input is connected to the first set of electrical lines, a second state in which the first input is connected to the second set of electrical lines.

In an embodiment, the first set of electrical lines is configured to connect to a first electrical load, and the second set of electrical lines is configured to connect to at least one of the first electrical load, a second electrical load, and an external power source configured to provide energy to the circuit module.

In an embodiment, the first state of the switching circuit, the second input is connected to the second set of electrical lines, and wherein for the second state of the switching circuit, the second input is connected to the first set of electrical lines.

In an embodiment, the circuit module further comprises a third input configured to connect to a third energy source; and a third set of electrical lines comprising the first electrical line and a fourth electrical line; wherein for the first state of the switching circuit: the second input is connected to the second set of electrical lines, and the third input is connected to the third set of electrical lines.

In an embodiment, the circuit module further comprises a fourth input configured to connect to a fourth energy source; wherein for the first state of the switching circuit: the fourth input is connected to the first set of electrical lines; wherein the states of the switching circuit further comprise a third state in which the fourth input is disconnected.

In an embodiment, a further set of electrical lines comprising the second electrical line and the third electrical line is configured to connect to at least one of a further electrical load, and a further external power source configured to provide energy to the circuit module.

In the present invention disclosure, the term “switch” refers to one or a plurality of circuit elements that can be controlled in a way that changes the path of current flow. In other embodiments, a switch comprises one or a plurality of electromechanical relays. In other embodiments, a switch comprises one or a plurality of transistors.

In this specification, the terms “battery cell unit” or “cell unit” can refer to an individual cell or a block of cells connected in parallel, or a multitude of individual battery cells or blocks of parallel cells or a mix thereof connected in series, and similar reasoning applies to variations of those terms, such as plurals. It can also refer to a block of cells connected in parallel or series in which one or more circuit components such as fuses, resistors or inductors are connected in series and/or parallel with individual cells.

In any embodiment, where a source connection connects either directly or via a switch to only a single electrical line, a switch is considered optional. This means that in such embodiments where a switch is shown, this switch is considered optional. This further means that in such embodiments where a switch is not shown, a switch is considered to be optionally includable. This also applies to a preferable embodiment when the single electrical line, to which a source connection connects to directly or via a switch, is a neutral line.

Any energy storage cell unit may include battery cell units, capacitors, supercapacitors and the like, and/or any combination thereof.

Any sources described can be any energy storage system or any generator of electrical energy (such as a battery system, a supercapacitor storage system, a solar generating system, a fuel-cell generating system, a fuel-cell storage system, a wind generating system, a different energy storage system or a different generating system).

Any DC sources or DC voltages described are substantially steady sources or voltages, but can include slow-changing sources or voltages such as used for maximum power point tracking (MPPT) of solar generation, or charging or discharging of batteries such as in electric vehicle DC chargers.

In another broad aspect of the invention there is an electrical system comprising a circuit module configured to connect energy sources with multiple line outputs, the circuit module comprising: two or more inputs comprising: a first input configured to connect to a first energy source, a second input configured to connect to a second energy source; three or more outputs configured to connect with three or more electrical lines, the three or more outputs comprising connections with: a first set of electrical lines comprising a first electrical line and a second electrical line, a second set of electrical lines comprising the first electrical line and a third electrical line; and a switching circuit configured to selectively operate in states comprising: a first state in which the first input is connected to the first set of electrical lines, a second state in which the first input is connected to the second set of electrical lines.

In some embodiments, the electrical system further comprises one or more controllers configured to selectively operate the switching devices of one or more of: the switching circuit; and one or more switching assemblies inside one or more sources.

In some embodiments, the first set of electrical lines is configured to connect to: a first electrical load; and wherein the second set of electrical lines is configured to connect to at least one of: the first electrical load, a second electrical load, and an external power source.

In some embodiments, the first state of the switching circuit comprises the second input connected to the second set of electrical lines; and the second state of the switching circuit further comprises the second input connected to the first set of electrical lines.

In some embodiments, the electrical system further comprises: a third input configured to connect to a third energy source; and a third set of electrical lines comprising the first electrical line and a fourth electrical line; wherein the switching circuit further comprises states where: the second input is connected to an output to the second set of electrical lines, and the third input is connected to an output to the third set of electrical lines; and wherein the inputs configured to connect with the first, second and third energy source collectively facilitate a three-phase power supply.

In some embodiments, the electrical system further comprises: a fourth input configured to connect to a fourth energy source; wherein for the first state of the switching circuit the fourth input is connected to an output to the first set of electrical lines and in parallel with the first source; and wherein the states of the switching circuit further comprise a third state wherein the fourth input is disconnected.

In some embodiments, the electrical system further comprises a state where: the fourth input is connected to, and the first input is disconnected from, the outputs to the first set of electrical lines, and the first input is connected to, and the fourth input is disconnected from, the outputs to the first set of electrical lines.

In some embodiments, the circuit module comprises: at least four inputs, each input having a first and a second terminal; at least four outputs configured to connect with at least four electrical lines; the first terminal of each input is connected to an output to the first electrical line; the second terminal of each input is connected, via switchable connections of the switching circuit, to an output to at least three of the other lines but the first electrical line; wherein the circuit controller is configured to operate the switchable connections of the first and second terminals to provide a three-phase star power supply to the outputs to electrical lines.

In some embodiments, the circuit module further comprises a third input configured to connect to a third energy source; wherein the three or more outputs comprise connections with a third set of electrical lines comprising the second and a third electrical lines; and wherein the first state of the switching circuit further comprises: the second input connected to outputs to the second set of electrical lines, and the third input connected to outputs to the third set of electrical lines; and wherein the inputs configured to connect with the first, second and third energy source collectively facilitate a three-phase delta power supply.

In some embodiments, the first input comprises two terminals, a first terminal connected, via switchable connections of the switching circuit, to the second or third line, and the second terminal is connected to the first electrical line; the second input comprises two terminals, a first terminal connected, via switchable connections of the switching circuit, to the first or third line, and the second terminal is connected to the second electrical line; and wherein the circuit controller is configured to operate the switchable connections of the first and second terminals to provide power supply to the electrical lines.

In some embodiments, the circuit module further comprises a third input comprising two terminals, a first terminal connected, via switchable connections of the switching circuit, to the first or second line, and the second terminal is connected to the output connected with the third electrical line; and wherein the circuit controller is configured to operate the switchable connections of the first and second terminals to provide a three-phase delta power supply to the electrical lines.

In some embodiments, the first input comprises two terminals: a first terminal selectively connected, via switchable connections of the switching circuit, to the second or third line, selectively, and a second terminal is connected to the first electrical line; and the second input comprises two terminals a first terminal connected, via switchable connections of the switching circuit, to the first or third line, and a second terminal is connected to the second electrical line; a third input comprising two terminals: a first terminal connected, via switchable connections of the switching circuit, to the first or second line, and a second terminal is connected to the output connected with the third electrical line; wherein the circuit controller is configured to operate the switchable connections of the first and second terminals to provide a 3 phase delta power supply to the electrical lines.

In some embodiments, the second terminal of each input is connected to the respective electrical lines via a switch of the switching circuit.

In some embodiments, the controller is configured to: determine one or more measures of at least one energy source, including measures indicative of source performance; and selectively operate the switching circuit to connect at least one other energy source to electrical lines either in place of, or in parallel connection with, or in series with, the at least one energy source based on the determined one or more measures.

In some embodiments, the measures comprise voltage profile information, state-of-charge information and/or state-of-health information, and the controller is configured to selectively operate the switching circuit to: either connect the at least one energy source to electrical lines in place of the at least one other energy source, or connect the at least one energy source to electrical lines in parallel with the at least one other energy source; and to substantially match the voltage profile being delivered to at least one set of electrical lines such that the voltage profile is substantially uninterrupted during a change from one state to another state.

In some embodiments, the one or more measures indicative of source performance comprises one or more of: voltages, currents, temperatures, states of charge, states of health, capacities, cycle lives, historical measurement data, depletion rates and other; and/or information indicative of external lines to load(s), grid(s) and/or other source(s), comprising one or more of: measured currents, voltages, frequencies, phase timings, phase angles, power factors, including any instantaneous or averaged differences of any of such metrics between multiple lines or phases; and/or information based on external inputs comprising one or more of: predicted/anticipated currents or power of loads, predicted/anticipated currents or power of supplies, unit prices of electricity, predicted/anticipated prices of electricity, user inputs or any input or output requests from other external devices.

In some embodiments, the controller is configured to: determine that one of the sources connected to a phase has a lower SoC than any of the other two sources connected to their respective phases of a three phase power supply, operate the switching circuit to replace the one of the sources with another source with a higher SoC, OR operate the switching circuit to connect the one of the sources in parallel with another source with a higher SoC; Such that the 3 phase power supply is uninterrupted by the depletion (SoC=0%) of the one of the sources.

In some embodiments, “lower SoC” means at least 1%, 5%, 10%, 20%, 30%, or 40% lower SoC in one source compared to another.

In some embodiments, the controller is configured to determine a predicted depletion time for each of two or more power sources is outside of a range indicative of a substantially matched depletion time for two or more sources, and operate the switching circuit such that to target a substantially matched depletion time range.

In some embodiments, the controller is configured to operate the switching circuit to effect one or more of: sources reach depletion at about the same time so that all phases are supplied with energy from the rechargeable energy sources for the maximum possible time before the batteries are depleted; and sources reach elapse cycle lives at about the same time range.

In some embodiments, a range is indicative of up to 0.1, 1, 2, 5, 10 or 20% capacity remaining in one source compared to another.

In some embodiments, the controller is configured to reconfigure a load connected to at least one source determined to be outside of the range with a source determined to be within the range.

In some embodiments, the circuit module further comprises at least (0 to n) additional inputs and at least three outputs configured to connect with at least three lines; and each input comprises two terminals; a first of the two terminals of each input is connected to a line which is different from the other inputs, and the second of the two terminals is connected to each of the lines not connected to by the first input, via switchable connections of the switching circuit; and wherein the circuit controller is configured to operate the switchable connections of the first and second terminals to provide a three-phase delta power supply to the electrical lines.

In some embodiments, the first and second inputs comprise two terminals, and one of the two terminals of each input is connected, via the switching circuit, to a combination of two electrical lines which is different from the combination of two outputs configured to connect with electrical lines of the first terminal of the other sources via a switched connection; the other of the two terminals of each input is connected, via the switching circuit to a combination of two electrical lines which is different from the combination of two outputs configured to connect with electrical lines of the second terminal of the other sources via a switched connection; and wherein the first and second terminals of each input share one connection to an output configured to connect with one of the electrical lines which is the same as the shared connection of the other inputs.

In some embodiments, at least one source is a controllable and variable voltage source comprising: a plurality of energy storage cell units connected in series; one or more cell switching assemblies configured to: disconnect any one or more of the energy storage cell units from being connected with any other energy storage cell units, and connect in series any one of the energy storage cell units with any other energy storage cell unit; one or more source controllers configured to selectively control the one or more switching assemblies.

In some embodiments, the controllable and variable voltage source comprises a rechargeable energy storage unit configured to selectively receive power from any source via the circuit module.

In some embodiments, the first energy source is configured to provide a controllable voltage profile of a rectified-AC voltage output and the second energy source is is a source able to provide a controllable voltage profile of a rectified-AC voltage output; wherein the first energy source is configured to provide a rectified AC voltage output that is approximately in phase with but of opposite polarity to the rectified AC voltage output of the second energy source; and wherein for the first state of the switching circuit in which the first input is connected to the first set of electrical lines: the first energy source provides a half-sine-wave voltage output; wherein for the second state of the switching circuit in which the first input is connected to the second set of electrical lines: the first energy source provides a subsequent half-sine-wave voltage output.

In some embodiments, the system comprises four inputs, each input configured to receive one of: a first source having a positive controllable voltage profile, a second source having a bipolar controllable voltage profile, a third source having a negative controllable voltage profile; and the controller is configured to: selectively operate the switching circuit to connect the four inputs to the three electrical lines to thereby provide a three-phase voltage output such that: the first source is connected to each of the electrical lines to provide a positive voltage part-phase for each of the three phases, the third source is connected to each of the electrical lines to provide a negative voltage part-phase for each of the three phases, and the second source is connected to each of the electrical lines to provide both a positive and negative part-phase for each of the three phases.

In some embodiments, the system comprises four inputs, each input configured to receive one of: a first and second source having a positive controllable voltage profile, a third and fourth source having a negative controllable voltage profile; and the controller is configured to: selectively operate the switching circuit to connect the four inputs to the three electrical lines to thereby provide a three-phase voltage output such that: the first and second sources are respectively connected to electrical lines to provide a positive voltage part-phase for each of the three phases, and the third and fourth sources are respectively connected to electrical lines to provide a negative voltage part-phase for each of the three phases.

In some embodiments, the controller is configured to: determine a desired three phase voltage profile, determine voltage profile information of three sources suitable to collectively provide a three phase voltage output, and operate the switching circuit based to: connect the three sources to three electrical lines based on the determined desired voltage profile, and the determined voltage profile of each of the three sources.

In some embodiments, there are at least two energy sources, and wherein if the controller determines the maximum desired voltage for a load to be larger than the maximum voltage of one energy source, the controller selectively connects the at least two sources in series with one-another to thereby increase the combined voltage output and provide power to the load.

In some embodiments, at least one of the energy sources is a DC source, at least one of the energy sources is a controllable and variable voltage source outputting a part or a whole of a substantially sine-wave voltage waveform; and the controller is configured to: change the state of the switching circuit to connect the DC source in series with the controllable and variable voltage source so that an AC output is produced by the electrical system.

In some embodiments, at least one of the DC sources is a DC Solar source providing an output voltage that is substantially a direct current (DC); at least one energy source is a controllable and variable voltage source acting as a DC source outputting substantially a direct current (DC); at least one of the energy sources is a second controllable and variable voltage source outputting a part or a whole of a substantially sine-wave voltage waveform; and the controller is configured to: change the state of the switching circuit to connect the DC Solar source in parallel with the first controllable and variable voltage source, and to connect the first controllable and variable voltage source in series with the second controllable and variable voltage source; so that an AC output is produced by the electrical system.

In some embodiments, the controller is configured to: determine the maximum desired voltage for at least one load; determine the AC source has a maximum voltage below a desired maximum voltage, and selectively connect the at least one DC source in series with the AC source to thereby increase the combined voltage output.

In some embodiments, the controller is configured to: determine the maximum desired voltage for at least two loads; determine the AC source has a maximum voltage below a desired maximum voltage of one load, and above a second load, and selectively connect the AC source to the second load.

In some embodiments, at least one of the energy sources is one or more of: a DC (supply) source providing a voltage output that is substantially a direct current (DC) voltage output, for example from DC output, a DC (supply) Solar source providing a voltage output that is substantially a direct current (DC) voltage output, a DC EV charger (supply or demand) source receiving or providing a voltage input that is substantially a direct current (DC) voltage input, a capacitor, a rotating machine, a grid (supply or demand) source receiving or providing a voltage profile that is substantially an AC voltage input that is substantially an AC voltage input, an AC (supply or demand) source providing a voltage output that is substantially an alternating current (AC) voltage output, a rectified-AC (supply or demand) source providing a voltage output that is substantially a rectified alternating current (rectified-AC) voltage output, a supply source comprising one or more of a solar power module, a mains/grid supply, an EV charger and/or a battery pack, a demand source comprising one or more of a mains/grid supply (configured to receive back-feed power), an EV charger and/or a rechargeable battery pack, and a supply and demand source comprising a controllable and variable voltage source comprising a switching assembly operable to cause the controllable and variable voltage source to provide a controllable and variable voltage profile.

In some embodiments, at least one of the sets of the electrical lines is configured to connect to the grid to either provide energy to the circuit module or to receive energy from the circuit module.

In some embodiments, the controller is further configured to: determine one or more sources connected to at least one input are rechargeable sources which require charging (demand sources), determine a one or more sources connected to another input are suitable for supplying charging current (supply sources), and operate the switching circuit to connect the supply sources and the demand sources to a common set of electrical lines.

In some embodiments, the controller determines information indicative of anticipated/predicted unit price of electricity and/or the actual present unit price of electricity, determines that it is optimal to sell electricity, and then manipulates the states of the switching circuit and/or the states of the switching assembly so that the voltage from the source(s) are higher than that of the grid so that the connected source(s) supply power to the grid.

In some embodiments, the controller is configured to operate the switching circuit to: connect sources to charge from the grid in one state of the switching circuit, and discharge from the sources to DC EV charger sources in another state of the switching circuit.

In some embodiments, the controller is configured to: determine or receive an optimum DC EV charger input voltage, and operate one or more of switching circuit states and switching assembly states to provide the DC EV charger input voltage.

In some embodiments, the controller is configured to connect sources to charge from one or more of: a DC source, a DC Solar source, or a DC EV charger source in one state of the switching circuit, and connect sources to discharge into the grid in another state of the switching circuit.

In some embodiments, at least one DC source is a Solar source, and the controller is configured to: determine or receive an optimum DC voltage for a controllable and variable voltage source to interface with a DC Solar source so that a Maximum Power Point current is drawn from the controllable and variable voltage source, and operate one or more of: switching circuit states and switching assembly states, to substantially match the optimum DC voltage.

In some embodiments, the maximum voltage observed across electrical lines exceeds 2000V, 5000V, 10 kV, 20 kV, 50 kV or 100 kV, or more.

In some embodiments, the second source is operable to provide a positive or negative voltage by: operation of an H-Bridge connected to the output of the second source; operation of cell polarity configuration switches configured as part of the second source.

In some embodiments, the first and second sources are connected to each of the electrical lines to each provide a positive voltage part-phase for every other phase, and the third and fourth sources are connected to each of the electrical lines to each provide a negative voltage part-phase for every other phase.

In some embodiments, the circuit module further comprises a third input configured to connect to a third energy source; wherein the three or more outputs comprise connections with a third set of electrical lines comprising the second and a third electrical lines; and wherein the first state of the switching circuit further comprises: the second input connected to the second set of electrical lines, and the third input connected to the third set of electrical lines.

In some embodiments, the electrical system further comprises a fourth input configured to connect to a fourth energy source; wherein for the first state of the switching circuit: the fourth input is connected to the first set of electrical lines; wherein the states of the switching circuit further comprise a third state wherein the fourth input is disconnected.

In some embodiments, the first input comprises two terminals, a first terminal connected, via switchable connections of the switching circuit, to the second or third line, and the second terminal is connected to the first electrical line; the second input comprises two terminals, a first terminal connected, via switchable connections of the switching circuit, to the first or third line, and the second terminal is connected to the second electrical line; and wherein the circuit controller is configured to operate the switchable connections of the first and second terminals to provide power supply to the electrical lines.

In some embodiments, the circuit module further comprises a third input comprising two terminals, a first terminal connected, via switchable connections of the switching circuit, to the first or second line, and the second terminal is connected to the output connected with the third electrical line; and wherein the circuit controller is configured to operate the switchable connections of the first and second terminals to provide a three-phase delta power supply to the electrical lines.

In some embodiments, the second terminal of each input is connected to the respective electrical lines via a switch of the switching circuit.

In some embodiments, the circuit module further comprises at least (0 to n) additional inputs and at least three outputs configured to connect with at least three lines; and each input comprises two terminals; a first of the two terminals of each input is connected to a line which is different from the other inputs, and the second of the two terminals is connected to each of the lines not connected to by the first input, via switchable connections of the switching circuit; and wherein the circuit controller is configured to operate the switchable connections of the first and second terminals to provide a three-phase delta power supply to the electrical lines.

In some embodiments, the first and second inputs comprise two terminals, and one of the two terminals of each input is connected, via the switching circuit, to a combination of two electrical lines which is different from the combination of two outputs configured to connect with electrical lines of the first terminal of the other sources via a switched connection; the other of the two terminals of each input is connected, via the switching circuit to a combination of two electrical lines which is different from the combination of two outputs configured to connect with electrical lines of the second terminal of the other sources via a switched connection; and wherein the first and second terminals of each input share one connection to an output configured to connect with one of the electrical lines which is the same as the shared connection of the other inputs.

In some embodiments, the first and second energy sources comprises a charge storage device, and the circuit module further comprises: a third input configured to connect to a third charge storage device, a fourth input configured to connect to a fourth charge storage device; each charge storage device connected to an input; a third set of electrical lines comprising the first electrical line and a fourth electrical line; wherein the switching circuit further comprises states where: the second input is connected to the second set of electrical lines, and the third input is connected to the third set of electrical lines; and wherein the inputs configured to connect with the first, second and third energy charge storage devices collectively facilitate a three-phase power supply; and the controller is configured to: selectively operate the switching circuit to connect three sources to three sets of electrical lines; determine one or more measures of each charge storage device, including measures indicative of performance; based on the determined measures, determine which charge storage device has the weakest performance; then connect the fourth charge storage device either in place of, or in parallel connection with, or in series with the charge storage device with the determined to have the weakest performance.

In some embodiments, the first and second energy sources comprises a charge storage device, and the circuit module further comprises: a third input configured to connect to a third charge storage device, each charge storage device connected to an input; a third set of electrical lines comprising the first electrical line and a fourth electrical line; wherein the switching circuit further comprises states where: the second input is connected to the second set of electrical lines, and the third input is connected to the third set of electrical lines; and wherein the inputs configured to connect with the first, second and third energy charge storage devices collectively facilitate a three-phase power supply; and the controller is configured to: selectively operate the switching circuit to connect three sources to three sets of electrical lines; determine one or more measures of each charge storage device, including measures indicative of performance; based on the determined measures, determine which of the three charge storage device has the weakest performance; then swap the sets of connected electrical lines of the determined charge storage device with the weakest performance with one other charge storage device.

In some embodiments, the first and second energy sources comprises a charge storage device, and the circuit module further comprises: a third input configured to connect to a third charge storage device, a fourth input configured to connect to a fourth charge storage device; each charge storage device connected to an input; wherein the three or more outputs comprise connections with a third set of electrical lines comprising the second and a third electrical lines; and wherein the first state of the switching circuit further comprises: the second input connected to outputs to the second set of electrical lines, and the third input connected to outputs to the third set of electrical lines; and wherein the inputs configured to connect with the first, second and third charge storage device collectively facilitate a three-phase delta power supply; and the controller is configured to: selectively operate the switching circuit to connect three charge storage devices to three sets of electrical lines; determine one or more measures of each charge storage device, including measures indicative of performance; based on the determined measures, determine which charge storage device has the weakest performance; then connect the fourth charge storage device either in place of, or in parallel connection with, or in series with the charge storage device with the determined to have the weakest performance.

In some embodiments, the first and second energy sources comprises a charge storage device, and the circuit module further comprises: a third input configured to connect to a third charge storage device, each charge storage device connected to an input; a third set of electrical lines comprising the first electrical line and a fourth electrical line; wherein the three or more outputs comprise connections with a third set of electrical lines comprising the second and a third electrical lines; and wherein the first state of the switching circuit further comprises: the second input connected to outputs to the second set of electrical lines, and the third input connected to outputs to the third set of electrical lines; and wherein the inputs configured to connect with the first, second and third charge storage device collectively facilitate a three-phase delta power supply; and the controller is configured to: selectively operate the switching circuit to connect three sources to three sets of electrical lines; determine one or more measures of each charge storage device, including measures indicative of performance; based on the determined measures, determine which of the three charge storage device has the weakest performance; then swap the sets of connected electrical lines of the determined charge storage device with the weakest performance with one other charge storage device.

In some embodiments, the inputs further comprise: a third input configured to connect to a third charge storage source, wherein each input comprises a first and a second terminal;
each charge storage device connected to an input; at least four outputs configured to connect with four or more electrical lines, the outputs: a switching circuit configured to selectively operate in states comprising at least: a delta state in which:
the first terminal of the first input is connected to third output,
the second terminal of the first input is connected to fourth output,
the first terminal of the second input is connected to the second output,
the second terminal of the second input is connected to third output,
the first terminal of the third input is connected to second output,
the second terminal of the third input is connected to fourth output;
a star state in which:
the first terminal of the first input is connected to first output,
the second terminal of the first input is connected to second output,
the first terminal of the second input is connected to the first output,
the second terminal of the second input is connected to third output,
the first terminal of the third input is connected to first output,
the second terminal of the third input is connected to fourth output;
the controller is configured to control operation of the switching circuit between the delta and star states.

In some embodiments, the controller is configured to determine the charge storage device with the weakest performance based on a determination of the device with the lowest measure of charge.

In some embodiments, the measure of charge is the state of charge (SoC).

In some embodiments, the weakest performance comprises a SoC of one source being at least 1%, 5%, 10%, 20%, 30%, or 40% lower than the SoC of another source.

In some embodiments, the controller is configured to: predict a depletion time for at least two charge storage devices in a load connected state, determine the charge storage device with the weakest performance based on the predicted depletion time.

In some embodiments, the controller is configured to: predict a depletion time for each of the charge storage devices in a load connected state, based on the prediction, operate the switching circuit to swap the sets of connected electrical lines of the determined charge storage device with the fastest predicted depletion time with one other charge storage device, such that the depletion time is substantially equalised for each of the charge storage devices.

In some embodiments, the system further comprises a third and fourth energy source, each source configured to provide a controllable voltage profile of a rectified-AC voltage output; wherein each energy source is configured to provide a half-sine-wave voltage output of any polarity; and the controller is further configured to control the switching circuit to connect each energy source to an output such that: the first and second sources are connected to electrical lines to each provide a positive voltage part-phase for every other phase, and the third and fourth sources are connected to each of the electrical lines to each provide a negative voltage part-phase for every other phase.

In some embodiments, there are at least two energy sources and at least two loads, and wherein the controller is configured to: determine or receive data indicative of the maximum desired voltage for each of the at least two loads, identify the maximum voltage of an energy source is less than the maximum desired voltage of a first load, but more than a second load, and selectively connect the identified energy source to the output to the first load.

Any one or more of the above embodiments may be used in combination with any one or more other embodiments.

In order that the invention may be more readily understood and put into practice, one or more preferred embodiments thereof will now be described, by way of example only, with reference to the accompanying drawings. It is noted that the specific embodiments described herein are not intended to be limiting. Such embodiments are presented herein for illustrative purposes only. Additional embodiments will be apparent to persons skilled in the relevant art(s) based on the teachings contained herein.

### BRIEF DESCRIPTION OF ACCOMPANYING DRAWINGS

The detailed description is described with reference to the accompanying figures. Same numbers are used throughout the drawings to reference equivalent features and modules.

FIG. 1 illustrates a circuit module 100 used to connect to three energy sources i.e. Source 1, Source 2 and Source 3, according to an embodiment of the present invention.

FIG. 2 illustrates a circuit module 200 used to connect energy sources i.e. Source 1, Source 2 and Source 3, and an optional Source 4 in star configuration, according to an embodiment of the present invention.

FIG. 3 depicts a voltage output profile generated from an electrical system illustrated in FIG. 2, according to an embodiment of the present invention.

FIGS. 4A-C depict a voltage output profile generated from the electrical system illustrated in FIG. 2, according to some embodiments of the present invention. The depicted embodiments showcase some of the flexibility achievable by various combinations of states of the switching circuit.

FIG. 5 illustrates a circuit module 500 used to connect to two energy sources i.e. Source 1 and Source 2, according to an embodiment of the present invention.

FIG. 6 depicts a voltage output profile generated from an electrical system illustrated in FIG. 5, according to an embodiment of the present invention.

FIG. 7 illustrates a circuit module 700 used to connect three energy sources i.e. Source 1, Source 2, Source 3 and a series DC source with an H-bridge circuit, according to an embodiment of the present invention.

FIG. 8 depicts a voltage output profile generated from an electrical system illustrated in FIG. 7, according to an embodiment of the present invention.

FIG. 9 illustrates a circuit module 700 used to connect three energy sources i.e. Source 1, Source 2, Source 3 and a series DC source, according to an embodiment of the present invention.

FIG. 10 depicts a voltage output profile generated from an electrical system illustrated in FIG. 9, according to an embodiment of the present invention.

FIG. 11 illustrates a circuit module 1100 used to connect three energy sources i.e. Source 1, Source 2, Source 3, a positive series DC source and a negative series DC source, according to an embodiment of the present invention.

FIG. 12 depicts a voltage output profile generated from an electrical system illustrated in FIG. 11, according to an embodiment of the present invention.

FIG. 13 illustrates a generic extendable electrical system 1300 (n, K, L M . . . , N, P) of the electrical systems as disclosed in FIG. 1 (100) and FIG. 2 (200), according to an embodiment of the present invention.

FIG. 14(A) illustrates voltage-current relationships of a battery at different charge levels.

FIG. 14(B) is a graph illustrating the 1-phase output voltage overtime, compared to a target voltage, of an electrical system according to one example embodiment of the invention.

FIGS. 15(A), 15(B), 15(C), 15(D), 15(E), 15(F), 15(G), 15(H), 15(l) and 15(J) depict examples of sources that are rechargeable energy storage units, specifically battery storage units, and each comprising a plurality of energy storage cell units, specifically battery cell units, that are connected in series.

FIG. 16 illustrates a circuit module 1600 used to connect seven energy sources i.e. Sources 1-7, according to an embodiment of the present invention.

FIG. 17 illustrates a circuit module 1700 used to connect three or more energy sources i.e. Source 1, Source 2, Source 3 and one or more optional sources, according to an embodiment of the present invention.

FIGS. 18 and 18A illustrates a circuit module 1800 used to connect two or three energy sources i.e. Source 1, Source 2 and an optional Source 3, according to an embodiment of the present invention.

FIG. 19 illustrates a circuit module 1900 used to connect three or more energy sources i.e. Source 1, Source 2, Source 3 and one or more optional sources i.e. 4 to N in delta configuration, according to an embodiment of the present invention.

FIG. 20 illustrates a circuit module 2000 used to connect two or three energy sources i.e. Source 1, Source 2 and an optional Source 3, according to an embodiment of the present invention.

FIG. 21 illustrates a circuit module 2100 used to connect three or more energy sources i.e. Source 1, Source 2, Source 3 and one or more optional sources i.e. 4 to n in delta configuration, according to an embodiment of the present invention.

FIG. 22A illustrates a circuit module 2200 used to connect two energy sources i.e. Source 1, Source 2, a first electric vehicle charger, an optional second electric vehicle charger and a grid, according to an embodiment of the present invention.

FIG. 22B illustrates a circuit module 2200 variation of the example of FIG. 22A where two sources and the switching assembly are located onboard an electric vehicle.

FIG. 23 illustrates a circuit module 2300 used to connect two energy sources i.e. Source 1, Source 2, solar supply 1, solar supply 2 and a grid, according to an embodiment of the present invention.

FIG. 23A illustrates an embodiment of an electrical system which connects Solar 1 and Source 1 in parallel and then in series with Source 2 to connect with the Grid.

FIG. 23B is an alternative diagram showing the same connections of FIG. 23A.

FIG. 23C depicts exemplary voltage profiles over time (left) of Source 1 and Source 2, as well as an exemplary AC output voltage profile over time (right) across L0 and L1 for the embodiment of FIGS. 23A and 23B.

FIG. 24 depicts a sign wave voltage output profile (output signal) generated from an electrical system illustrated in FIG. 23 in an embodiment of the invention. The Figure also depicts two different input DC signals that are used to charge the sources.

FIG. 25 illustrates a circuit module used to connect three sources i.e. Source 1, Source 2 and Source 3, and a solar grid for charging the sources, according to an embodiment of the present invention.

FIG. 26 illustrates 3-phase sine wave voltage profile as generated by an electrical system of FIG. 25 and a DC voltage output received from the solar grid, according to an embodiment of the present invention.

FIG. 27 illustrates a conventional solution with solar sources and a battery system that uses a maximum power point tracker (MPPT) and an inverter, to generate electrical energy to supply to various loads.

FIG. 28 illustrates a battery system without using MPPT and inverter, according to an embodiment of the present invention.

FIG. 29 (A-E) illustrates circuit modules to connect a source in five different configurations, including a star configuration, a star/delta configuration and a delta configuration.

FIG. 30 illustrates an exemplary block diagram which can be configured to generate a controllable voltage profile (output), according to an embodiment of the present invention.

FIG. 31 is a flow diagram illustrating a method of generating a controllable voltage profile according to an embodiment of the present invention.

FIG. 32 is a flow diagram illustrating a method of generating a controllable voltage profile according to another embodiment of the present invention.

It should be appreciated by those skilled in the art that any block diagrams herein represent conceptual views of illustrative systems embodying the principles of the present invention. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

References in the present disclosure to “one embodiment” or “an embodiment” mean that a particular feature, structure, characteristic, or function described in connection with the embodiment is included in at least one embodiment of the invention. The appearances of the phrase “in one embodiment” in various places in the specification are not necessarily all referring to the same embodiment. The exemplary embodiments presented in this specification relate to an electrical system comprising a switching circuit for achieving various states of connections between energy source(s) and load(s) and a method of operating the electrical system to achieve controlled outcomes.

Embodiments which are set forth may be incorporated into a number of systems. However, the systems and methods are not limited to the specific embodiments described herein. Furthermore, structures and devices shown in the figures are illustrative of exemplary embodiments.

The embodiments in this specification present exemplary circuits for an electrical system which are configured to connect power sources and power sinks. The terms “load line”, “electrical line” and “supply line” are used within this specification to refer to circuit connections between power sources and loads.

Some exemplary embodiments described herein require that one or more of the power sources is a battery system. The term “battery system” can refer to a battery pack architecture with controllable series-module or series-cell-unit connectivity such that it will provide AC and/or rectified AC voltage outputs directly at the battery pack terminals by changing the number of series connected cell units over time. Some of these battery pack architectures can alternatively also provide substantially DC voltage outputs by fixing the number of series connected cell units over time. For interpretation of the specification, such a battery pack architecture is also described as a “controllable and variable voltage source”.

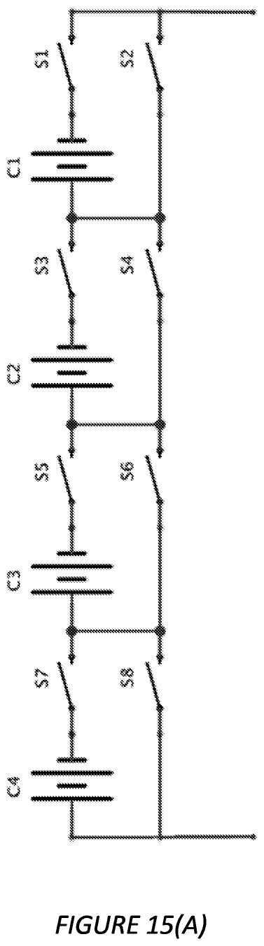

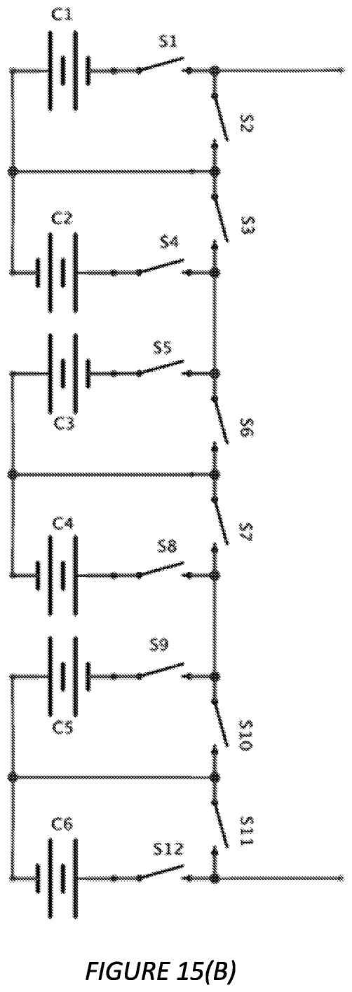

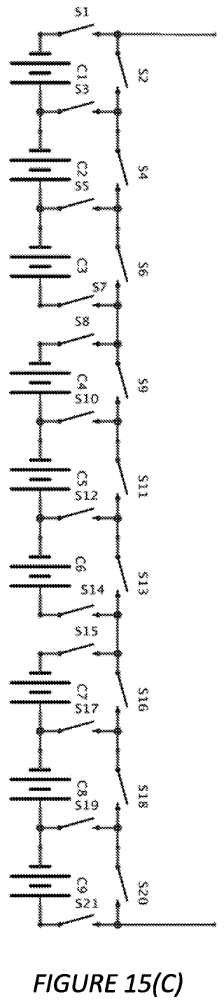

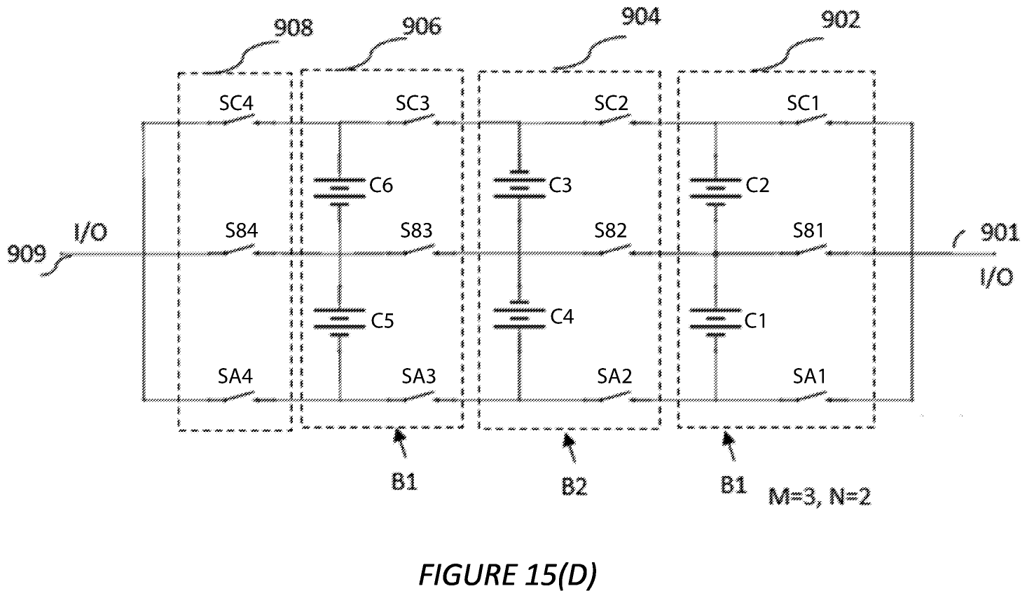

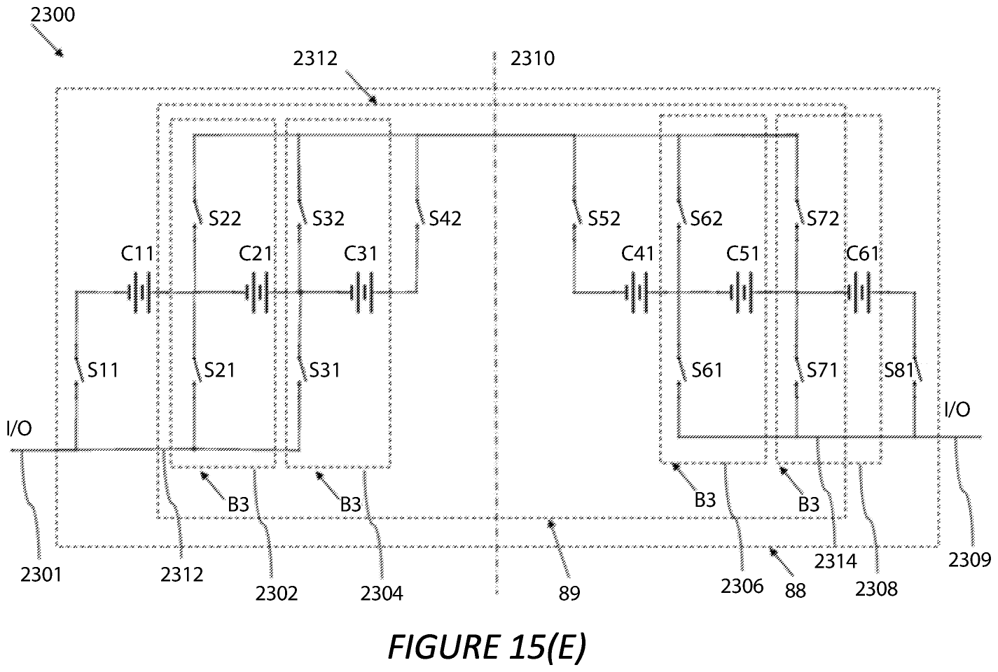

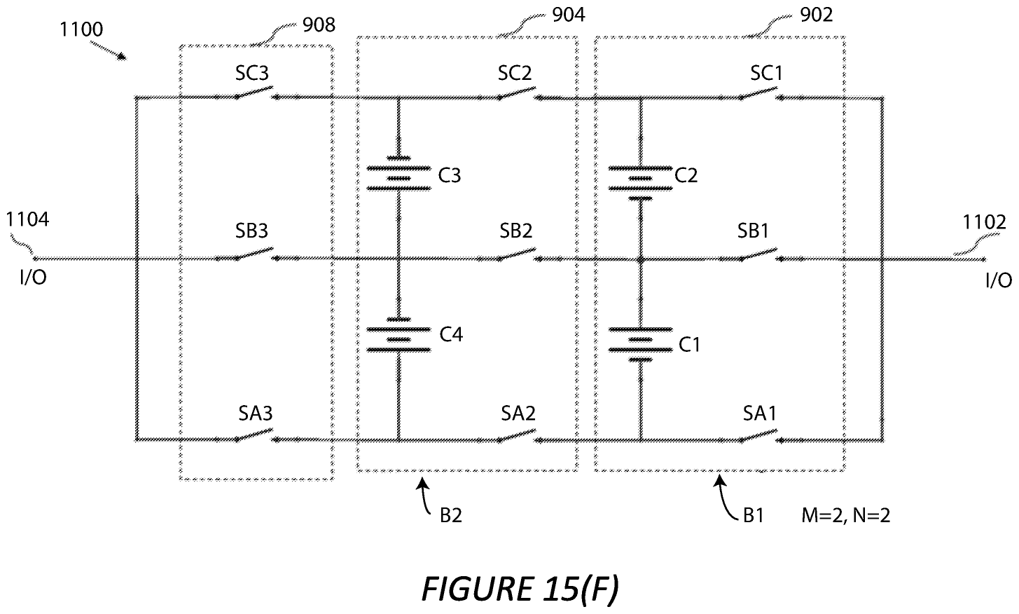

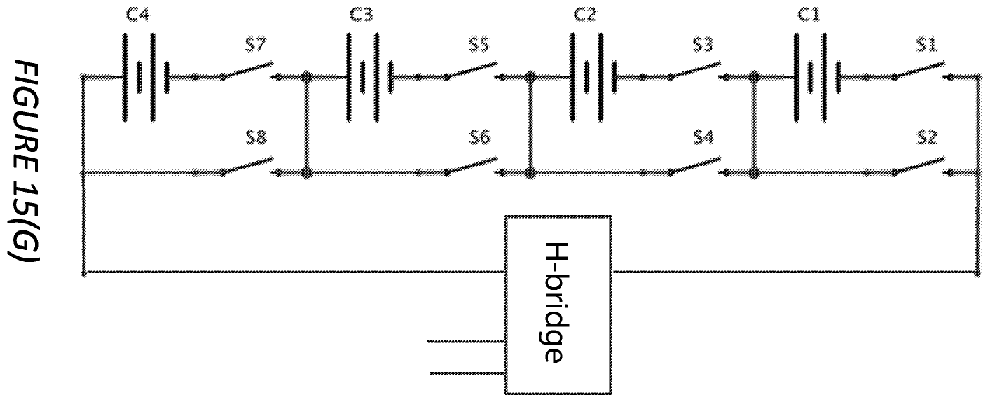

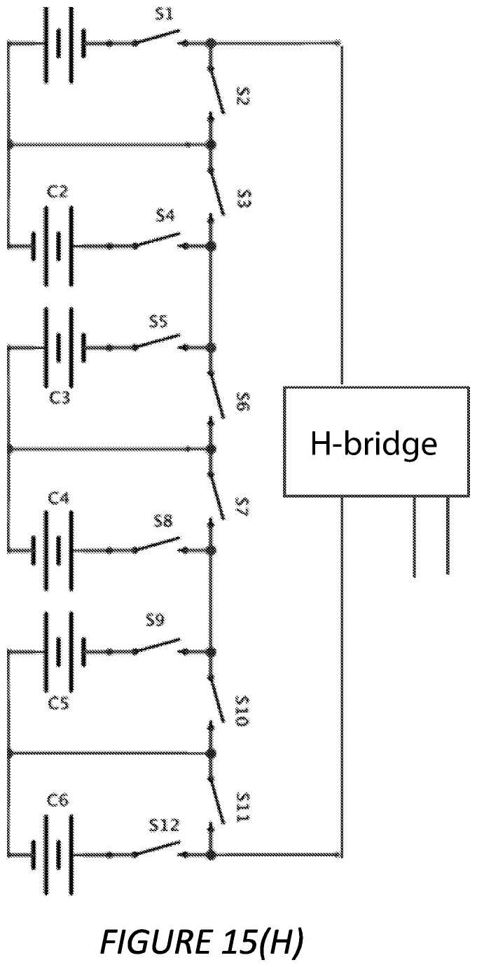

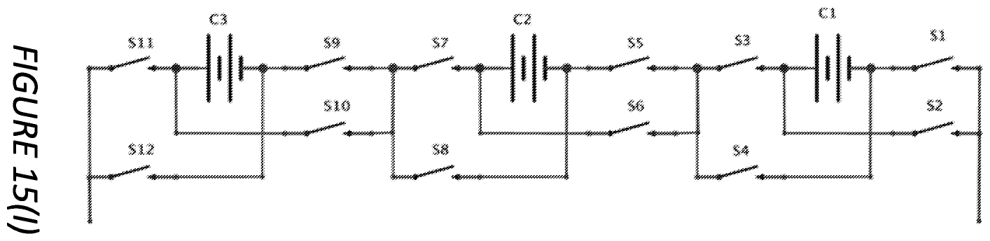

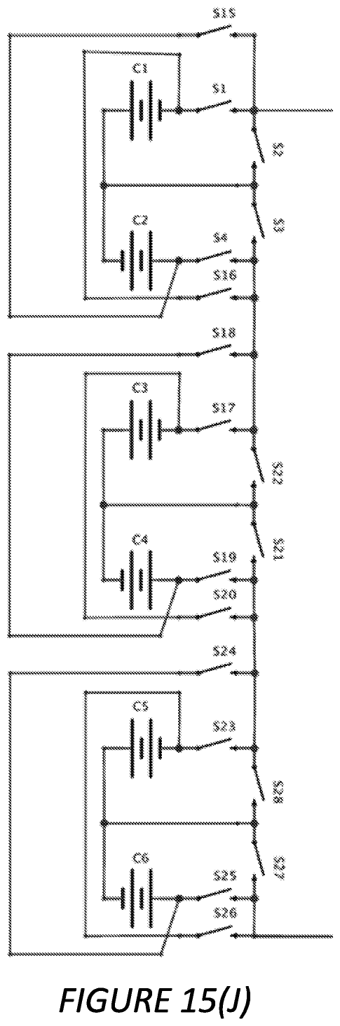

Further, the exemplary embodiments described herein present circuits configured to connect the controllable power sources with any number of regular power sources (such as for battery charging purposes) or power sinks/loads (such as for receiving current). For example, AC and/or rectified AC voltage outputs are typically provided as a two-line output, i.e. forming a single phase. Examples of such battery pack architectures are described in U.S. Ser. No. 10/910,606B2, U.S. Ser. No. 11/264,812B2, and is also shown in FIG. 15. A battery pack of the examples can be operated to vary the number of series connected cell units to replicate a mains AC voltage, for example. A replicated mains voltage may be used to power any number of conventional devices such as an appliance.

In some exemplary examples disclosed herein, there is a circuit configured to connect multiple battery packs with multiple current sinks in a multiple phase power supply arrangement (an electrical system). When multiple battery packs are in use and discharging, it is often desirable for such packs to reach depletion at about the same time so that all phases are supplied with energy from the multiple battery packs for the maximum possible time before the batteries are depleted. However, a common occurrence is unequal current demand on any phase causes a battery connected with that phase to be depleted before others. Similarly, it may be desirable to supply multiple phases or power from batteries with an unequal state of charge, or unequal capacity which may exacerbate a scenario where one phase may no longer be provided when the first battery is discharged before any others.

Accordingly, some exemplary embodiments described herein relate to circuits configured to provide control of the connection between any one of multiple battery packs and any one of multiple load phases. Circuit structure and methods of control for going at least some way toward equalising battery discharge will be discussed below with reference to exemplary embodiments. The term “switching circuit” is used within this specification to refer, at least in part, to such circuits configured to control the connection of sources with loads.

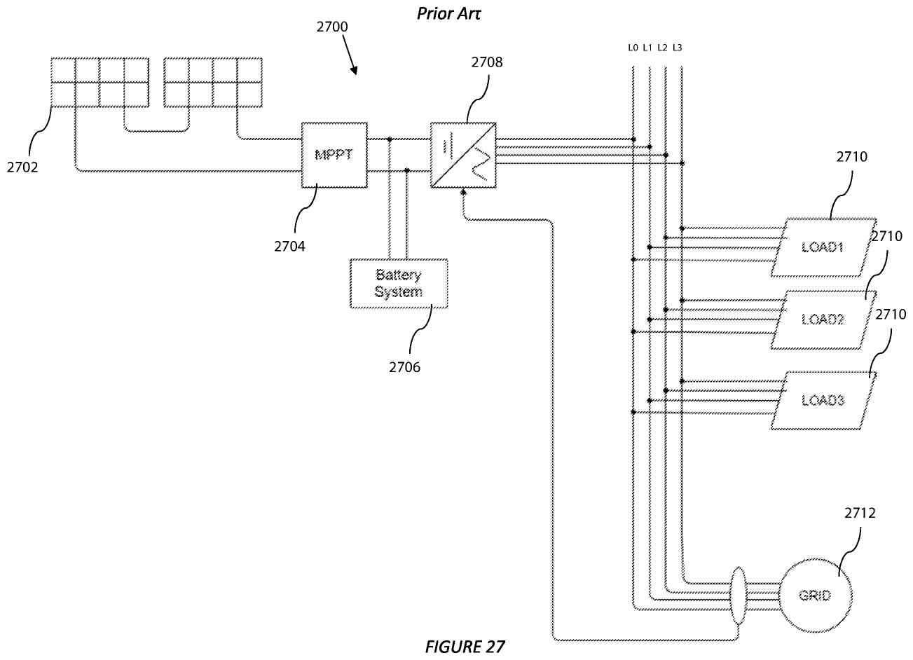

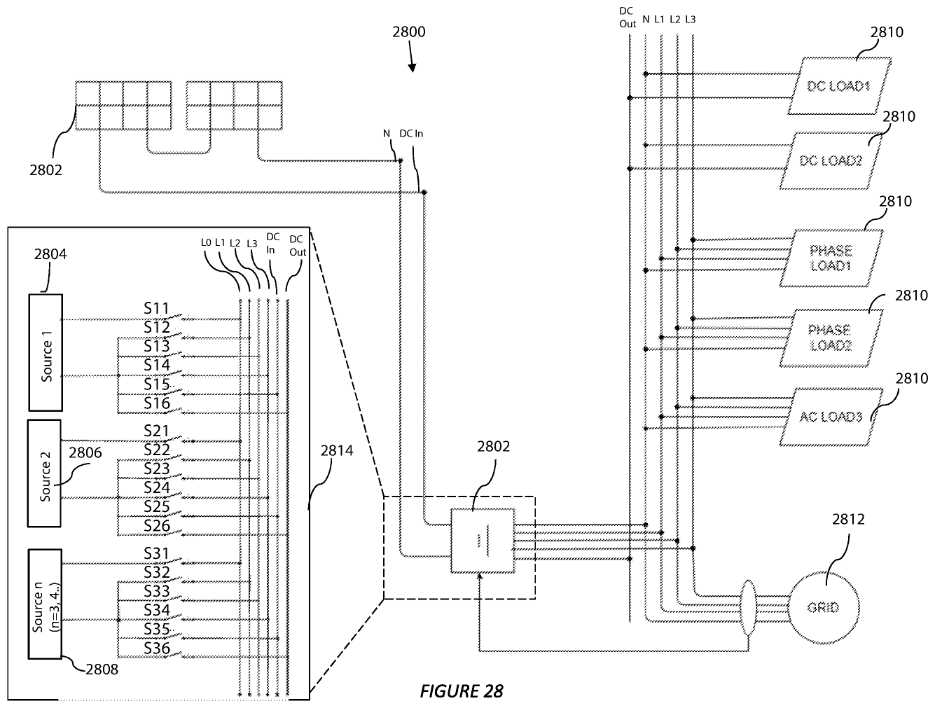

In some embodiments, the switching circuit has states of configuration (“states”) which manipulate connections of one or more of the battery packs to one or more of the phases, which do not require any of the battery packs to switch polarity, for the system to generate a 2 phase (split-phase) or a 3 phase AC output. The states of the switching circuit therefore allow sources to be connected to the resultant power supply system without the use of an H-bridge or an inverter. A prior art use of inverters in power supply systems is depicted in FIG. 27, and can be compared with an embodiment of the invention depicted in FIG. 28.

In the on-grid scenario, in which the system is connected to a grid, the sources simply need to match the voltage waveform of whichever phase the source is connected to. This may involve at least controllers inside the sources (source controller(s) 3012). In the off-grid scenario, to provide 3 phase power supply from the sources, a centralised controller may be instantiated in order to define the frequency and phase of the three phases, and then nominate one source as the leading phase. The other sources are controlled so that the phase angles of the sources are 120° apart. This may involve at least a controller outside the sources (circuit controller 3006). Alternatively, in the off-grid scenario, the system may be controlled in a distributed manner amongst the controllers inside the sources (source controllers 3012), with no need for a central controller (circuit controller 3006). The determination of when to activate each switching device of the switching circuit 3004 may be distributed amongst the source controllers 3012, in order to provide 3 phase power supply from the sources.

In some embodiments, the switching circuit is configured to switch power sources to load lines based on the phase angle of a rectified or non-rectified AC voltage supply and based on the voltage output capability of a DC source. In such embodiments, the DC source can be connected in series with the source that supplies the AC voltage. In some embodiments the DC source can be substantially steady sources or voltages, but can include slow-changing sources or voltages such as used for maximum power point tracking (MPPT) of solar generation, or charging or discharging of batteries such as in electric vehicle DC chargers. A DC source could be any DC source including non-exhaustively a rechargeable battery DC source, a Solar DC source or an EV charger DC source. In some parts of the specification, listing a DC source, a Solar DC source and/or an EV charger DC source separately should not be interpreted as that a DC source is mutually exclusive with a Solar DC source or an EV charger DC source.

In some embodiments, the switching circuit is configured to switch power sources to load lines connected to electrical loads, Electrical Vehicle chargers, a grid, and/or any other devices/systems capable of receiving charge so as to discharge into them. In some embodiments, the switching circuit can also be configured to switch power sources to load lines connected to external power sources including a grid, a solar panel or any other devices/systems capable of providing charge so as to receive charge from them. Power sources can therefore either be charged or discharged via the operation states of the circuit and to this end, in some embodiments the controller is configured to determine a source for receiving charge current as a source with a lower voltage potential than another source, which would be the supply source. Rechargeable power sources such as battery sources charge if the connected supply is trying to output a voltage which is greater than the battery sources. In sources that are capable of providing controllable voltage profiles, since the output voltage of sources are controllable, the system can change between charging a source and discharging a source upon determination by the controller. In some embodiments, two power sources can be connected in series to discharge into an electrical load, a grid, an EV charger, or any other devices/systems capable of receiving charge. Two power sources can also be connected in series to receive charge from an electrical load, a grid, a solar panel, or any other devices/systems capable of providing charge.

In some embodiments, the switching circuit is configured to connect a DC source such as one or more solar to the electrical system without the use of a DC/DC voltage converter or maximum power point tracker (MPPT), and/or to provide AC power directly and without the use of a DC-to-AC inverter. For example, an energy storage unit may at one time be controlled to charge from a DC source at a charging voltage to maximise the power provided by the DC source, and at a different time be controlled so that the energy storage unit discharges to an AC output, line or load. This may at least in part be achieved by controlling the voltage across the energy storage unit and/or a number of series connected energy storage units by controlling a combination of: a switching assembly inside an energy storage unit, and the states of the switching circuit to manipulate connections of one or more energy storage units to one or more of the phases of the power supply system. A prior art use of MPPT in power supply systems is depicted in FIG. 27, and can be compared with an exemplary embodiment depicted in FIG. 28. Such benefits also apply to other variable and renewable sources such as wind turbine, as an MPPT is typically used for these other types of energy generation sources too.

Similarly, in some embodiments, the circuit module including a switching circuit allows a DC load such as one or more EV chargers to be connected to an electrical system without the use of a DC/DC voltage converter and/or to provide AC power without the use of a DC-to-AC inverter. For example, an energy storage unit may at one time be controlled to provide power to a DC load at a discharging voltage to match the power requirement of the DC load, and at a different time be controlled so that the energy storage unit recharges from an AC input, line or supply. This may at least in part be achieved by controlling the voltage across the energy storage unit and/or a number of series connected energy storage units by controlling a combination of: the switching assembly inside an energy storage unit, and the states of the switching circuit to manipulate connections of one or more energy storage units to one or more of the phases of the power supply system.

In some embodiments, the switching circuit is configured to make and break connections using semiconductor based switching devices such as a MOSFET. Such devices are desirable for fast switching performance. However, where only low speed switching performance is required, mechanical switching devices such as a relay may also be operated. In preferred embodiments, the switching operation is controlled by a controller such as a microprocessor.

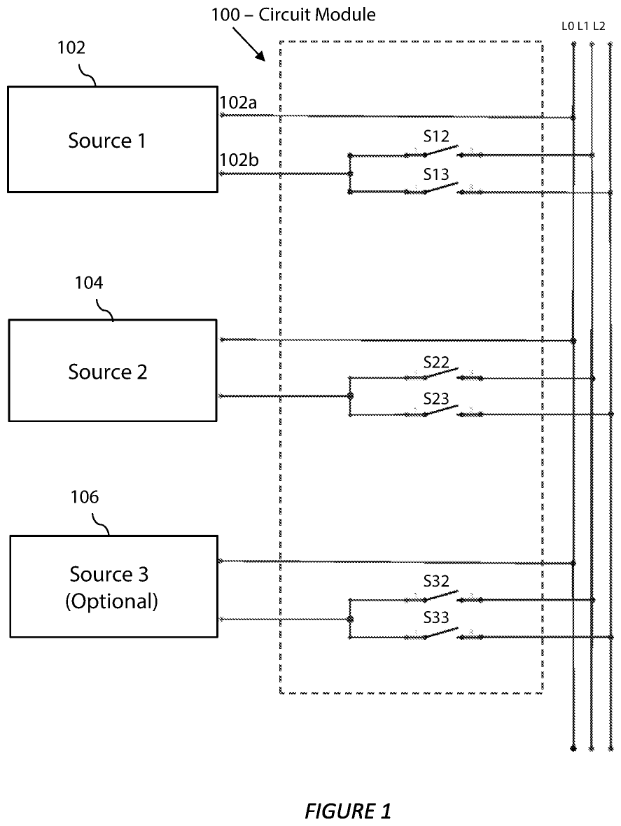

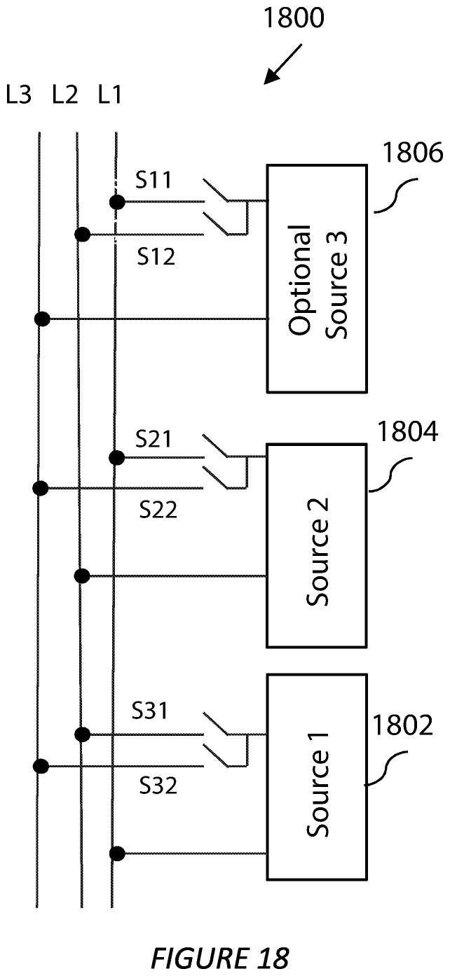

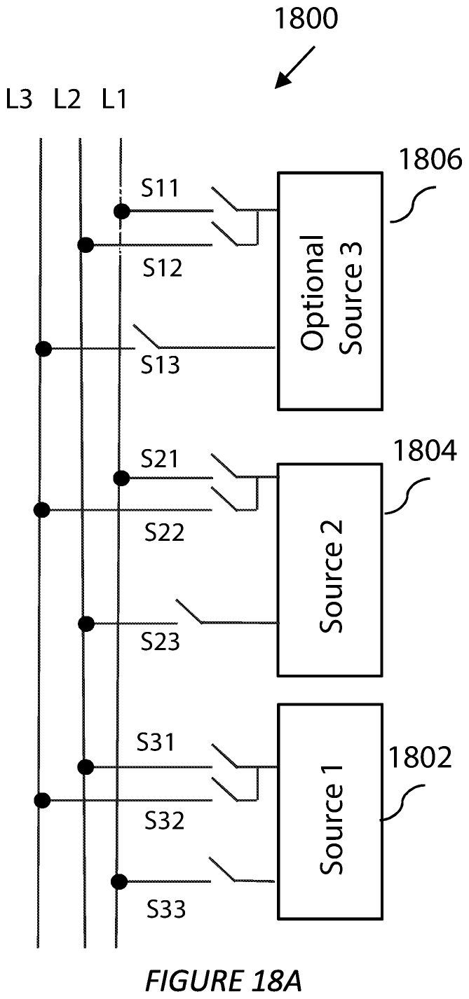

In the examples depicted, FIGS. 1-17 show star circuit examples of a switching circuit where a common or neutral line exists in a multiple phase supply. FIGS. 18-21 show delta circuit examples of a switching circuit configured to connect any source with any load line. In each of the examples, it shall be understood that other electronic components such as resistors, inductors, capacitors etc. can also be coupled to the circuit module described in earlier embodiments.

In this specification, the term controller should be understood to be one or more of: the controller inside a power source that control the switching of cell units within, defined as “source controller” in the specification; and the controller outside of power sources that is configured to control connections of a switching circuit which connect one or more sources to one or more phases of an AC supply, defined as “circuit controller” in the specification. It should also be understood that a plurality of controllers can perform the same functions of a single controller, and thus “a controller” should be understood to include possibly a plurality of controllers.

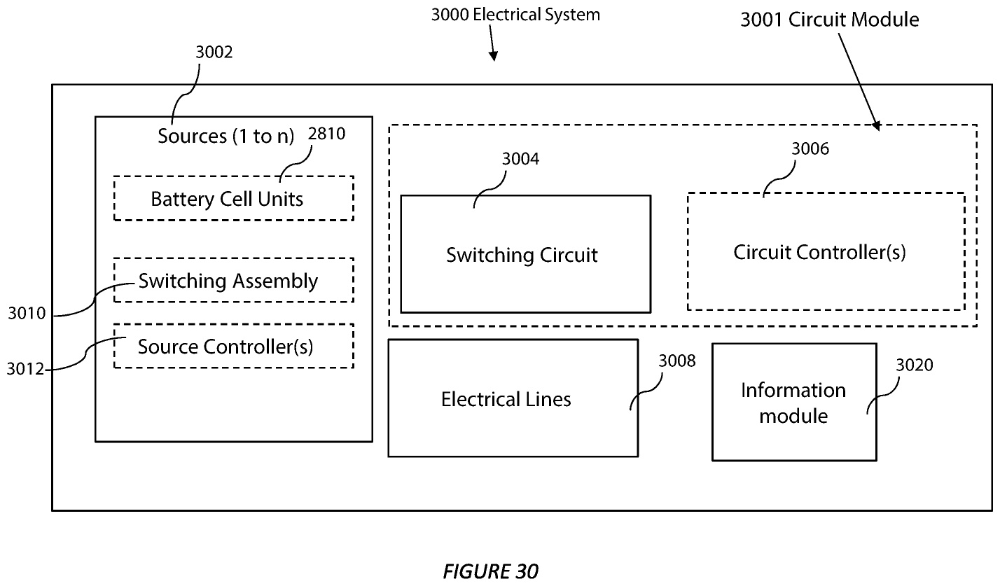

FIG. 30 shows a diagram of an electrical system 3000 containing exemplary components configured to operate the exemplary circuits of the invention. The electrical system includes a plurality of sources 3002, a controller 3006 for controlling the operation of the switching circuit 3004 (herein referred to as a circuit controller) and electrical lines 3008 to supply energy to one or more loads or receive energy from one or more power supplies. The circuit module 3001 comprises the circuit controller 3006 and the switching circuit 3004 and is configured to be connected to electrical lines 3008. The electrical lines 3008 are conductive material-based wires that allow current flow. When used to supply power, the output voltage profile may be determined based on a user input, or an external input/signal, or the voltage requirements of a device or appliance to be powered by the electrical system 3000.

In some embodiments, the energy sources comprise rechargeable energy storage units such as battery packs or cell units configured to selectively receive power via the circuit module. In some embodiments, the energy Source 3002 is not rechargeable. In some embodiments, the energy Source 3002 is a combination of a rechargeable energy storage unit and non-rechargeable sources.

The circuit controller 3006 is configured to determine or receive one or more control parameters operable to base control determinations used to operate the switching circuits 3004. The control parameters determine when the switching circuit 3004 operates at any given point in time and what switch configuration should be engaged.

The control parameters may be determined by the controller, or may be received by the controller from other information sources. For example, in some embodiments the controller is configured to measure information from one or more lines by sampling the voltage on that line. Phase information may also be derived from changes in the voltage over time. Current information may be determined by the controller by sampling a current sensor or equivalent device, such as voltage drop over precision resistors, measurement of electric field strength or similar. In other examples, the controller is configured to receive information such as from one or more other information sources. For example, a controller of a cell switching assembly may output information about a source such as voltage and phase profile information.

In other examples, the information determined or received by the controller includes maximum charged voltage, minimum discharge voltage for each Source 3002, voltage values for the overall electrical system 3000, external signals/inputs, and user inputs may also be communicated to the controller.

In other examples, the information determined or received by the controller includes one or more of voltages, currents, temperatures, states of charge (SOCs), states of health (SOHs), capacities, cycle lives, historical measurement data, depletion rates and other information related to the sources or components thereof.

In other examples, the information determined or received by the controller includes measurements relating to external lines to load(s), grid(s) and/or other source(s), comprise one or more of: measured currents, voltages, frequencies, phase timings, phase angles, power factors, including any instantaneous or averaged differences of any of such metrics between multiple lines or phases.

Other exemplary information determined or received by the controller includes other external signals/inputs, comprising one or more of: predicted/anticipated currents or power of loads, predicted/anticipated currents or power of supplies, unit prices of electricity, predicted/anticipated prices of electricity, user inputs or any input or output requests from other external devices.

Other exemplary information determined or received by the controller includes measurements relating to external lines to load(s), grid(s) and/or other source(s) information which could include other external signals/inputs.

To facilitate some operational functions of the controller, in some embodiments, the system further comprises an information module 3020 which is, connected to, or configured within the controller and configured to store some or all information received or determined by the controller. The information module 3020 may comprise local or remote storage as may be appropriate for any given implementation. For example, the information may be stored long term in a database, or held in a register for short term use. Any storage device or combination of storage devices may be used. Further the information module may comprise software, hardware, or a combination of software and hardware.

In some embodiments, the controller is configured to control the state of the switching circuit based on information stored in the information module 3020. In some embodiments, the controller is configured to control the state of the switching circuit based on a combination, or weighted combination, of such information.

In some embodiments, where there are at least 4 sources, the controller is configured to determine that one of the sources connected to a phase has a substantially lower SoC than any of the other two sources connected to their respective phases of a 3 phase power supply, operate the switching circuit to replace the one of the sources with another source with a higher SoC, OR operate the switching circuit to connect the one of the sources in parallel with another source with a higher SoC; such that the 3 phase power supply is uninterrupted by the depletion (SoC=0%) of the one of the sources. “Substantially lower” SoC may mean that the SoC is at least 1%, 5%, 10%, 20%, 30% or 40% lower than any of the other two sources connected to their respective phases of a 3 phase power supply. This operation helps to extract more charge from the sources than possible without the circuit module and at least 4 sources.

In some embodiments, the controller is configured to determine a depletion time for each of multiple power sources, each supplying power to one or more loads or receiving power from one or more sources. The depletion time could be based on indicative information such as, for example, voltage drop over time, source current delivery rates, source storage capacity information (where the source comprises an energy storage device), and/or other information related to the source, one or more loads and/or any other connected components or systems which are indicative of power demands over time.

In some embodiments, the controller is configured to determine that the depletion time is outside of a threshold or range indicative of a substantially matched depletion time. This determination may be used, in some circumstances, to switch or supplement one source for, or with, another. The threshold is typically based on the capacity of a particular energy storage in use, and other factors such as the health of the storage device. However, the threshold is typically indicative of up to 20%, or up to 0.1, 1, 2, 5, 10 or 20% additional depletion time remaining in one source compared to another.

Subsequent to a determination that the depletion time may not be matched, the controller is configured to control the switching assembly to thereby target the substantially matched depletion time. In some embodiments, the controller is configured to reconfigure the load connected to at least one source with a low or the lowest remaining depletion time with at least one source with a higher or the highest capacity. In this way, sources reach depletion at about the same time so that all phase loads are supplied with energy from the rechargeable energy sources for the maximum possible time before any one source is depleted substantially before another.

In some embodiments, the controller is configured to determine or receive information indicative of a measure of source performance, and use the performance determination as a basis for switching or supplementing one source with, or for, another. Source performance could be one or more of charge-discharge cycles of a rechargeable battery, battery capacity, battery temperature, battery discharge current ability, battery voltage magnitude and others. Further information is discussed elsewhere in the specification. For example, source performance could be based on information indicative of the number of charge-discharge cycles a battery source has endured, and control the switching circuit to minimise use of higher cycle time sources, and maximise use of lower cycle time sources. In this way, energy from available energy sources are optimised before the sources reach end of cycle lives. An alternative measurement that serves the same purposes is SoH (State of Health).

Such balancing between sources as described above can apply to any of the embodiments in the full specification where there are more sources available than the minimum number of sources required for operation of any particular embodiment. Balancing of sources can help increase the operational time of the system, help reduce downtime of the system and/or help reduce the maintenance interval to replace or service sources. For balancing, determination of which source to connect to is not limited to: connecting that source in place of an existing and currently active source, connecting that source in parallel with an existing and currently active source, or connecting that source in series with an existing and currently active source.

In some embodiments, the controller is configured to operate the switching circuit to manipulate connections to switch power sources, such as rechargeable batteries, to load/supply lines based on the phase angle of a rectified or non-rectified AC voltage supply/load. The connected lines could (1) provide energy to the battery, ie. be a supply to the battery, or (2) receive energy from the battery, ie. be a load to the battery. Accordingly, the controller is configured to determine or receive voltage profile information, which may include the voltage amplitude and phase information of one or more particular AC supplies/loads and operate the switching circuit based on the phase angle. To provide an uninterrupted voltage profile to a load, the switching must occur at the time when the voltage and phase profile of the current (incumbent) source and replacement source must match.

In some embodiments, the determination to charge the battery or to discharge the battery is made in an external EMS (energy management system) module, and changing between charging and discharging a battery does not require a physical change in the states of the switching circuit. The battery source controller fulfils the requests of the EMS by controlling the battery source to produce the suitable voltage profile suitable for charging or discharging. In some embodiments, where multiple battery sources are required to achieve the desired voltage or the desired current, the circuit controller may determine that a physical change of state of the switching circuit is required to connect multiple battery sources in series or parallel.

In some embodiments, the controller is further configured to operate the switching circuit to connect a source with a rechargeable source which requires charging (a demand source). Accordingly, the controller is configured to determine or receive information indicative of one or more demand sources, determine one or more sources disconnected or connected to a different set of lines are suitable for supplying charging current (a supply source), and operate the switching circuit to connect the supply source(s) and the demand source(s) to a common set of electrical lines.

In some embodiments, the sources comprise source controller 3012 and switching assembly 3012. The source controller and switching assembly are configured to facilitate controllable voltage profile generation from a source. In such scenario, the rechargeable energy storage unit comprises: a plurality of energy storage cell units connected in series and one or more cell switching assemblies configured to: disconnect any one or more of the energy storage cell units from being connected with any other energy storage cell units, and connect in series any one of the energy storage cell units with any other energy storage cell unit; one or more source controllers configured to selectively control the one or more switching assemblies.

In some embodiments, the source controller and the circuit controller do not communicate and control the switching assembly and the switching circuit, respectively. For example, one or more of the source controller and circuit controller may be configured to output signals operable to define the state of the switching circuit to achieve a desired connection between power sources and sinks at any time. For example, each controller may share a control signal line configured to receive signals at any time operable to define a state of the switching circuit. In some embodiments, one or more of the source controller and circuit controller are configured to read the state of the switching circuit before outputting a control signal. The reading of the circuit state may in some cases inform the controller whether a control output is required to achieve a particular state.

In some embodiments, each battery cell unit or pack includes a cell microcontroller for communicating with the circuit controller 3006. Any suitable communication protocol may be used. In one embodiment, the circuit controller communicates with the cell microcontrollers on each of the battery cell unit or pack or source using I2C protocol.

In some embodiments, there is a controller (source controller) configured to control the series connection of cell units in a battery pack and therefore the output voltage of the battery pack, and control the switching devices of the switching assembly based on a controlled state of the battery pack cell unit connection. In some embodiments, the controller (source controller) that controls the series connection of cell units in a battery pack may or may not be the same controller that controls (circuit controller) the switching devices of the switching circuit configured to provide control of the connection between any one of multiple battery packs and any one of multiple phases.

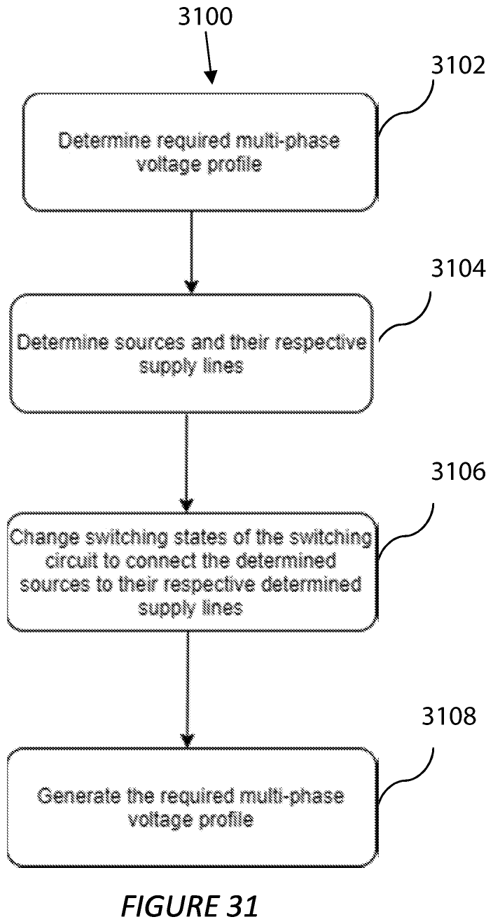

FIG. 31 describes a method 3100 of controlling the switching circuit to generate a multi-phase voltage profile. At step 3102, a required multi-phase voltage profile that is to be generated is determined.

At step 3104, available sources and their charging and discharging information of the sources is determined. For example, supplied voltage and/or current, and/or historical measurement data, sensor readings etc. is used to determine the same. Faulty, discharged or unavailable sources are ignored during determining a new state. In some embodiments, the controller is configured to rank the capacity of each available source and determines the most preferred sources for connection. In some cases, the controller determines sources connectable to each line and identifies one or more preferred sources for connection. The controller may refer to, for example, the information module which is configured with a lookup table which identifies all the connectable sources to a particular line and information of those sources which may be used to determine the preference.

At step 3106, the controller determines or receives an operational directive to change the state of the switching circuit. After determining the requirement, the controller sends control instruction to the switching devices of the switching circuit, upon which the switching devices changes their status i.e. ON/OFF. The switching takes a fraction of a second and thereby uninterrupted multi-phase voltage profile is generated at step 3108.

The method is repeated every time there is a requirement to change the state of the circuit module.

The above mentioned steps for FIG. 31 are for the circuit controller to control the switching circuit to achieve step 3108. The steps above assume that switching assemblies inside sources are controlled by separate source controllers. It is assumed that source controllers control the switching assemblies inside sources to generate controllable voltage profiles from the sources. To achieve an uninterrupted multi-phase voltage profile at step 3108, the sources need to each generate an uninterrupted single-phase voltage profile and this is achieved by the source controllers' configuration of the switching assemblies inside the sources.

In some cases, both categories of controllers (source controllers and the circuit controller) contribute to overall output from the electrical system.

For interpretation of the term “controller”, it should be understood that, unless the terms “source controllers” or “circuit controller” are specifically used, “the controller” or “controller” should be understood to comprise one or more of: the circuit controller, and the source controller(s); and the controller determines one or more of: the switching requirements of the switching circuit, and the switching requirements of the switching assembly(s). In the cases of sources that can generate controllable voltage profiles, each switching assembly in each source is controlled by the controller to configure the switching devices of the switching assembly to connect/disconnect/bypass cell units in series or parallel in order to achieve an output voltage profile from each source that connects to the circuit module so that the uninterrupted multi-phase voltage profile is achieved at step 3108.

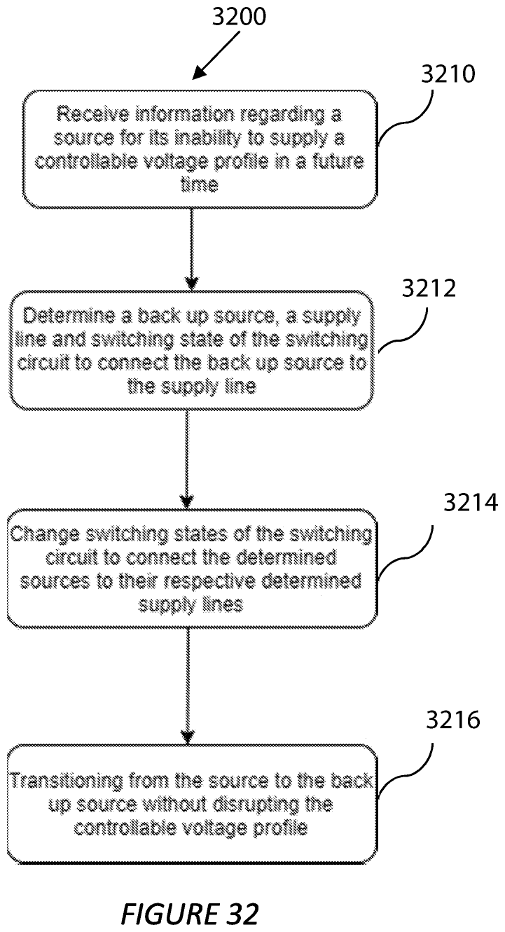

FIG. 32 describes a method 3200 of controlling the switching circuit to generate a required multi-phase voltage profile.

At step 3202, a source sends control information to the controller that includes indication that the source is unable to supply a controllable voltage profile (typically in future time).

At step 3204, the controller determines a backup source(s). In some cases, the controller determines connectable sources to the line the source is connected to and identifies one or more preferred sources for connection. The controller may refer to its memory containing a lookup table to identify all the connectable sources to a particular line.

At step 3206, the controller identifies the switching state and sends control information to the switching devices to change their status (i.e. ON/OFF).

At step 3208, the switching devices change their status and the source(s) are coupled to the lines in a different arrangement, such that no voltage disruption occurs at the supply lines.

In accordance with one embodiment of the invention, one or more sources out of a plurality of sources supply voltage to the supply lines and rest of the source are disconnected from the supply lines. In alternative embodiments, all sources supply voltage to the supply lines. In some embodiments, the source includes a battery system including a plurality of battery cell units connected by a switching assembly.

In some embodiments, the circuit module is operated in operation states that include states when two or more sources are connected in parallel. In some embodiments, the circuit module is operated in operation states when two or more sources are never connected in parallel. In some embodiments, the circuit module is operated in operation states when two or more sources are connected in series.

An advantage of some of the embodiments in which 3 phase voltage supply is generated is that any phase can carry a higher amount of current than the current limit of a 3 phase inverter. A 3 phase inverter is not required in these embodiments but generally required in many prior art 3 phase power supply systems. This is because multiple sources can be connected to a single phase without having to go through one or more transistors of a three phase inverter. For example, if three sources are connected in parallel to the same phase and each source is rated for a 50 A current limit, the total maximum current on the phase is 150 A. This limit is increased further if more sources are connected to the same phase.

The following embodiments are exemplary circuits, some of which are configured for operation by the controller. The exemplary circuits have various ‘states’ which may be static, or dynamically adjusted. In some embodiments, the states may be changed based on particular control criteria which may be relevant to the exemplary circuit. However, it should be understood that any control criteria described as operating the states of one particular circuit, may be equally applied to the control of states of another circuit presented in any other embodiment. Those skilled in the art will readily determine from the examples set forth in this specification which control criteria are applicable to what circuits.

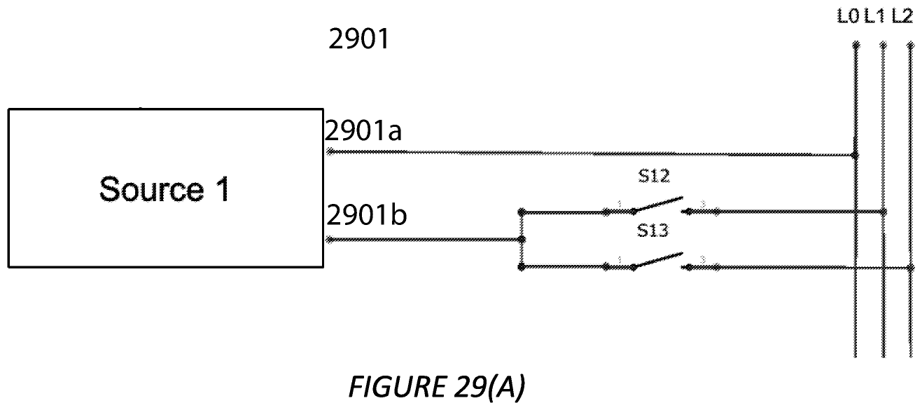

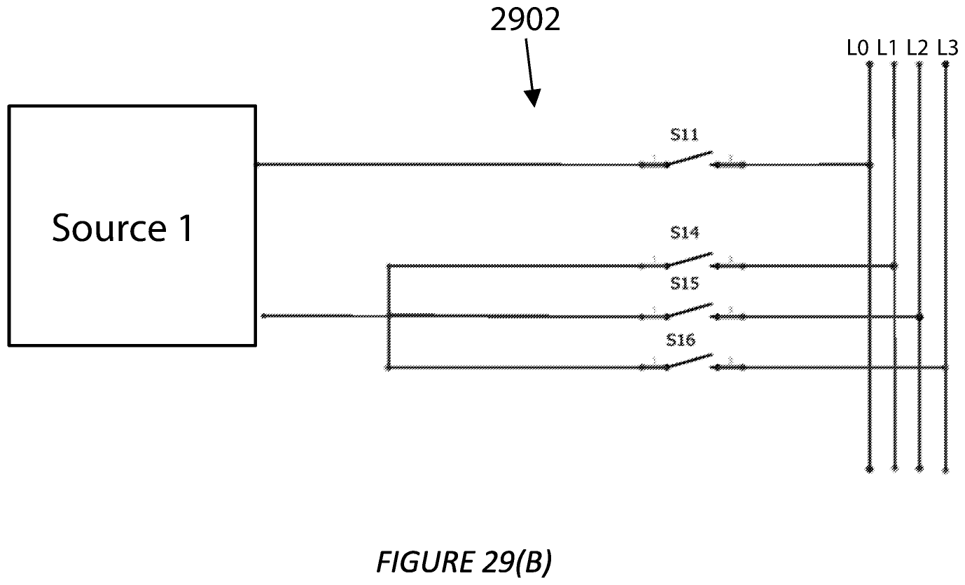

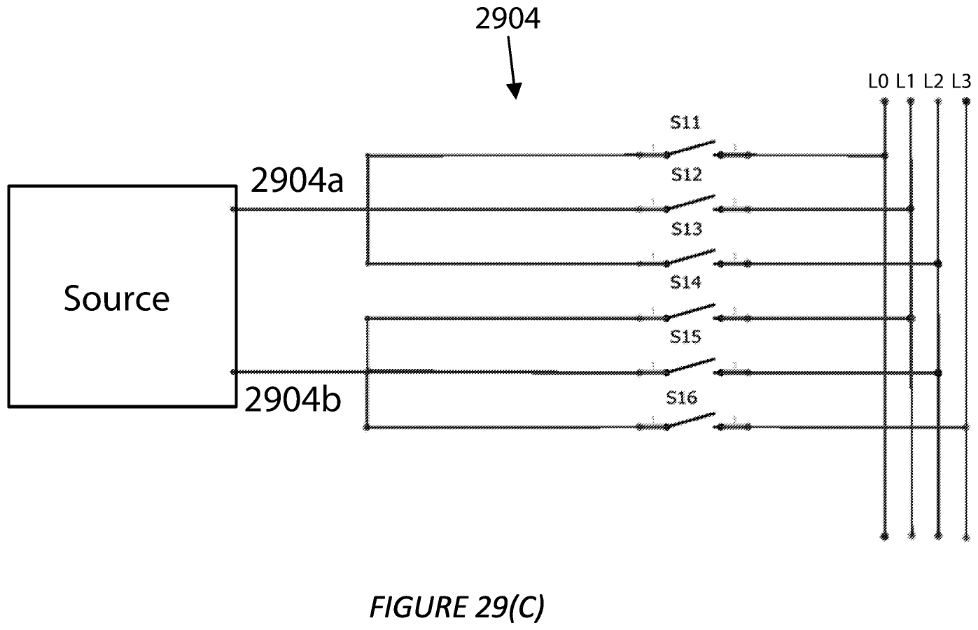

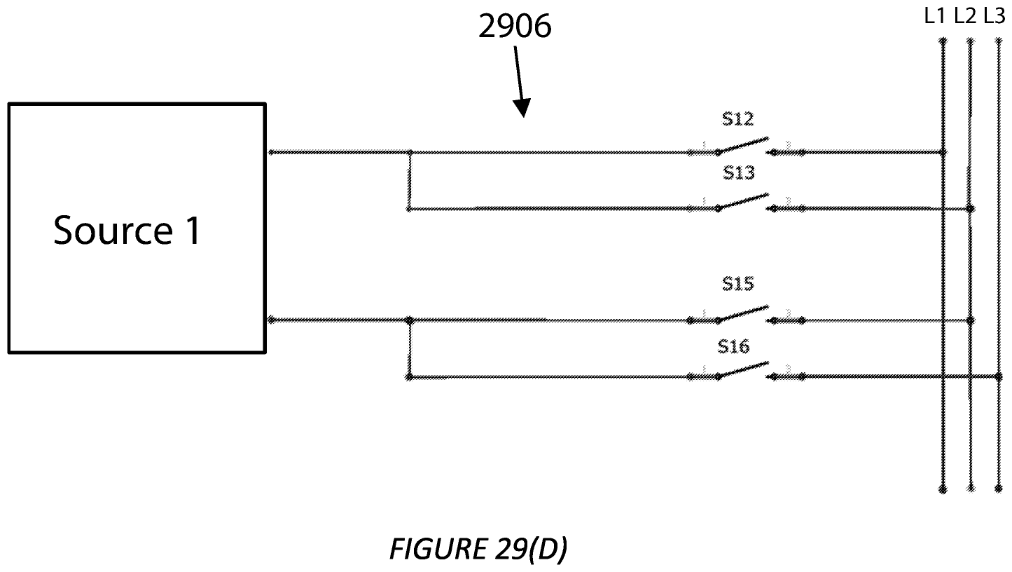

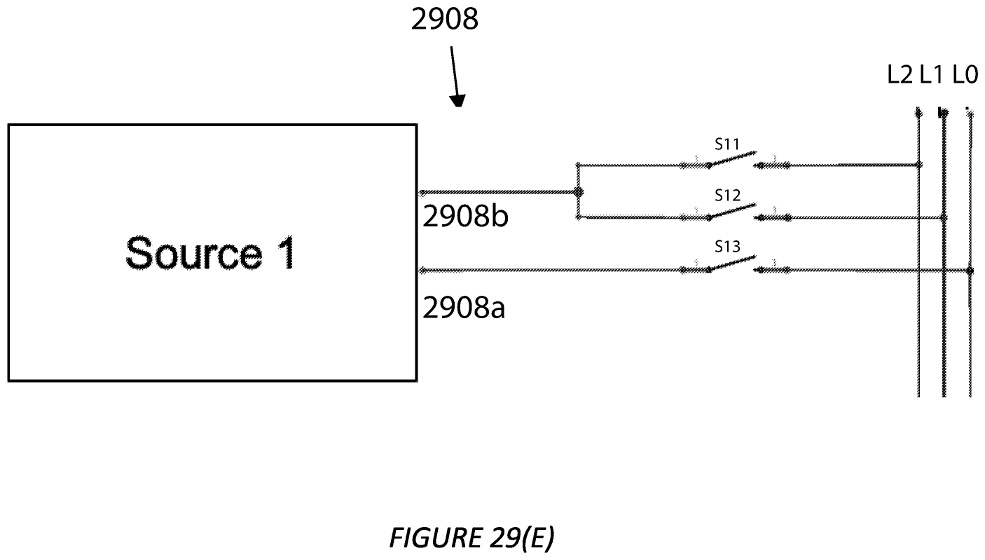

FIGS. 29(A), 29(B), and 29(C), 29(D), and 29(E) show exemplary circuit module blocks including circuit module 2901, a circuit module 2902, a circuit module 2904, and a circuit module 2906, and a circuit module 2908, respectively. Each circuit module forms a building block which is used, in combination with other circuit modules in illustrative embodiments discussed in this specification, to form a more complex switching circuit which may be applicable for some particular purpose. Examples of such more complex circuits and applications therefore are discussed further below.

The circuit module 2901 of FIG. 29(A) includes an input which is connected to lines L0-L2 via 4 switches S12, S13. The input is thus connected to L1 or L2 depending on which switch is conductive. This is an embodiment of a basic building block of the circuit module, in which an input configured to be connected to a source is able to be connected to two different sets of electrical lines. This allows states of the switching circuit to selectively connect to one of two sets of lines, set 1 being line 0 (L0) and line 1 (L1), set 2 being line 0 (L0) and line 2 (L2). These lines are electrical lines configured to be connected to electrical loads and/or external power sources. If both switches are open, the source is disconnected.

The circuit module 2908 in FIG. 29(E) includes an input which is connected to lines L0-L2 via 3 switches S11, S12, S13. Switch S13 is on the neutral path connecting the reference terminal 2908a to line 0 (L0). This allows for states of the switching circuit in which a source is disconnected completely. For example, when the source is a battery system, it allows the battery system to be disconnected completely for maintenance, certification or any other purposes.

In some embodiments, in place of any one of the switches described above, two series connected switches can be used to perform the same functionality of a single switch with the added benefit of providing redundancy. This redundancy is needed when, for example, one of the switches fails. This is also sometimes a certification requirement for an electrical system.

The circuit module 2902 of FIG. 29(B) includes an input which is connected to lines L0-L3 via 4 switches S11, S12, S13 and S14. In a similar arrangement that is depicted in this figure, a greater number of switches can be coupled to the lines L0-L3 in a similar pattern to provide (include) further inputs, where additional sources can be connected. The resultant module can be used to achieve states of the switching circuit to implement a star configuration based 3-phase supply, when at least 3 or more sources are connected to the inputs of the circuit module.

Similarly, the circuit module 2906 of FIG. 29(C) includes an input which is connected to lines L0-L3 via 6 switches S11, S12, S13, S14, S15 and S16. In a similar arrangement that is depicted, a greater number of switches can be coupled to the lines L0-L3 to provide (include) further inputs, where additional sources can be connected. The resultant module can be used to achieve states of the switching circuit to implement a delta or star configuration based 3 phase supply, when at least 3 or more number of sources are connected to the inputs of the circuit module. Having switches on all paths connected to the reference terminal 2904a is preferred to allow a functioning 3-phase AC electrical supply system (with at least 3 sources) to switch between a star configuration and a delta configuration. One of the advantages of this capability is for creating/certifying one electrical system which can then satisfy both (Star and Delta) requirements without redesign/recertification. In some embodiments, having switches on all paths connected to the reference terminal allows more flexibility on how sources can be connected, including how and which sources can be connected in series.

Similarly, the circuit module 2904 of FIG. 29(D) includes an input which is connected to lines L1-L3 via 4 switches S12, S13, S15 and S16. In a similar arrangement that is depicted, a greater number of switches can be coupled to the lines L1-L3 to provide (include) further inputs, where additional sources can be connected. The resultant module can be used to achieve states of the switching circuit to implement a delta configuration based 3-phase supply, when at least 3 or more sources are connected to the inputs of the circuit module. Whenever there are alternate paths to a terminal a switch is required on each and every path to the terminal to allow for path selection.

Referring now to FIG. 1, a first exemplary embodiment of a system which includes a circuit module 100 including an exemplary circuit assembly is shown. The exemplary circuit module 100 is constructed from the combination of two or three circuit module blocks 2901 as shown in FIG. 29(A). The circuit module 100 is connected to at least two sources i.e. Source 1 (102) and Source 2 (104) providing electrical energy to an external load (not shown) or receiving electrical energy from an external supply (not shown) via a switching circuit that includes switches S12, S13, S22, S23 from supply lines that are neural line (L0), Line 1 (L1) and Line 2 (L2). Optionally, the embodiment further has an additional Source 3 (106) alongside switches S32 and S33. The circuit module includes a first input comprising the two connections that directly connect to Source 1, a second input comprising the two connections that directly connect to Source 2, and an optional third input comprising the two connections that directly connect to Source 3. A first terminal (reference terminal) 102a of the first input is coupled to a first terminal (reference terminal 102a) of Source 1 and a second terminal of the first input is coupled to a second terminal 102b of Source 1. Similarly, the terminals of the second and third sources are coupled to the terminals of the second and the third input. The entire arrangement in FIG. 1 is referred to as an electrical system.

FIG. 1 depicts that Source 1 (102), Source 2 (104), Source 3 (106) are connected to the neural line (L0) without any switches i.e. directly. However in a varied embodiment, each source is connected through additional switches S11, S21 and/or S31 (not shown), respectively. Source 1 (102), Source 2 (104), Source 3 (106) are also connected to the line 1 (L1) via switches S12, S22 and S32, respectively. Similarly, Source 1 (102), Source 2 (104), Source 3 (106) are connected to the line 2 (L2) via switches S13, S23 and S33, respectively.

In one embodiment, the electrical system is used to generate a controllable voltage profile including two voltage outputs for providing electrical energy to an external load. One voltage output is generated between line 0 (L0) and line 1 (L1), whereas another is generated between line 0 and line 2. Each voltage output on these two combinations of lines (L0-L1 and L0-L2) can be a substantially steady voltage output over time (such as direct current, or DC) or can be a varying voltage output over time (such as sinusoidal (AC), rectified AC, triangular etc). The sources (Source 1, Source 2 and Source 3) can be a battery system or can be a generation source of any kind.

In another embodiment, the electrical system is used to connect two sources in series to generate a voltage profile between line 1 (L1) and line 2 (L2).

In another embodiment, the electrical system is used to receive electrical energy from an external supply. One voltage input is received between line 0 and line 1, whereas another voltage input is received between line 0 and line 2. Each voltage output on these two combinations of lines (L0-L1 and L0-L2) can be a substantially steady voltage output over time (such as DC) or can be a varying voltage output over time (such as sinusoidal (AC), triangular etc) for receiving the electrical energy. The sources (Source 1, Source 2 and Source 3) can be a battery system or any other means that can store energy in other forms based on the electrical energy received.

In some embodiments, L0 L1 and L2 are connected to any one or combination of DC loads, DC supplier, a DC grid, AC loads, AC supplies and an AC grid.

The switching circuit (S12, S13, S22, S23, S32, S33) is configured to be controlled using a controller or a device(s) with equivalent functions. The selective control of the switching circuit helps in achieving two or more operation states from all possible operation states which are listed in the table below:

| | | Conductive |
|---|---|---|
| Connection Status | State | Switches |
| Source 1 Connected to L0, L1 & L2; | ST1 | S12, S13 |
| Source 2 & Source 3 Disconnected | | |
| Source 1 Connected to L0 & L1; | ST2 | S12 |
| Source 2 & Source 3 Disconnected | | |
| Source 1 Connected to L0 & L2; | ST3 | S13 |
| Source 2 & Source 3 Disconnected | | |
| Source 2 Connected to L0, L1 & L2; | ST4 | S22, S23 |
| Source 1, Source 3 Disconnected | | |
| Source 2 Connected to L0 & L1; | ST5 | S22 |
| Source 1 & Source 3 Disconnected | | |
| Source 2 Connected to L0 & L2; | ST6 | S23 |
| Source 1 & Source 3 Disconnected | | |
| Source 3 Connected to L0, L1 & L2; | ST7 | S32, S33 |
| Source 1, Source 2 Disconnected | | |
| Source 3 Connected to L0 & L1; | ST8 | S32 |
| Source 1 & Source 2 Disconnected | | |
| Source 3 Connected to L0 & L2; | ST9 | S33 |
| Source 1 & Source 2 Disconnected | | |
| Both Source 1, Source 2 Connected | ST10 | S12, S13, |
| to L0, L1 & L2; Source 3 Disconnected | | S22, S23 |
| Both Source 1 and Source 2 Connected | ST11 | S12, S22 |
| to L0 & L1; Source 3 Disconnected | | |
| Both Source 1 and Source 2 Connected | ST12 | S13, S23 |
| to L0 & L2; Source 3 Disconnected | | |
| Source 1 Connected to L0 & L1, | ST13 | S12, S23 |
| Source 2 Connected to L0 & L2; | | |
| Source 3 Disconnected | | |
| Source 1 Connected to L0 & L2, | ST14 | S13, S22 |
| Source 2 Connected to L0 & L1; | | |
| Source 3 Disconnected | | |
| Both Source 1 and Source 3 | ST15 | S12, S13, |
| Connected to L0, L1 & L2; | | S32, S33 |
| Source 2 Disconnected | | |
| Both Source 1 and Source 3 | ST16 | S12, S32 |
| Connected to L0 & L1; | | |
| Source 2 Disconnected | | |
| Both Source 1 and Source 3 | ST17 | S13, S33 |
| Connected to L0 & L2; | | |
| Source 2 Disconnected | | |
| Source 1 Connected to L0 & L1, | ST18 | S12, S33 |
| Source 3 Connected to L0 & L2; | | |
| Source 2 Disconnected | | |
| Source 1 Connected to L0 & L2, | ST19 | S13, S32 |
| Source 3 Connected to L0 & L1; | | |
| Source 2 Disconnected | | |
| Both Source 2, Source 3 | ST20 | S22, S23, |
| Connected to L0, L1 & L2; | | S32, S33 |
| Source 1 Disconnected | | |
| Both Source 2 and Source 3 | ST21 | S22, S32 |
| Connected to L0 & L1; | | |
| Source 1 Disconnected | | |
| Both Source 2 and Source 3 | ST22 | S23, S33 |
| Connected to L0 & L2; | | |
| Source 1 Disconnected | | |
| Source 2 Connected to L0 & L1, | ST23 | S22, S33 |
| Source 3 Connected to L0 & L2; | | |
| Source 1 Disconnected | | |
| Source 2 Connected to L0 & L2, | ST24 | S23, S32 |
| Source 3 Connected to L0 & L1; | | |
| Source 1 Disconnected | | |
| All Sources i.e. Source 1, | ST25 | S12, S13, |
| Source 2 and Source 3 | | S22, S23, |
| Connected to L0, L1 & L2 | | S32, S33 |
| All Sources i.e. Source 1, | ST26 | S12, S22, |
| Source 2 and Source 3 | | S32 |
| Connected to L0 & L1 | | |
| All Sources i.e. Source 1, | ST27 | S13, S23, |
| Source 2 and Source 3 | | S33 |
| Connected to L0 & L2 | | |
| Source 1 and source 2 | ST28 | S12, S22, |
| Connected to L0 & L1, Source 3 | | S33 |
| Connected to L0 & L2 | | |
| Source 1 and Source 3 Connected | ST29 | S12, S23, |
| to L0 & L1, Source 2 | | S32 |
| Connected to L0 & L2 | | |
| Source 1 Connected to L0 & L1, | ST30 | S12, S23, |
| Source 2 and Source 3 | | S33 |
| Connected to L0 & L2 | | |
| Source 3 Connected to L0 & L1, | ST31 | S13, S22, |
| Source 1 and Source 2 | | S32 |
| Connected to L0 & L2 | | |
| Source 1 and Source 3 Connected | ST32 | S13, S22, |
| to L0 & L1, Source 2 | | S33 |
| Connected to L0 & L2 | | |
| Source 1 and Source 3 Connected | ST33 | S13, S23, |
| to L0 & L1, Source 2 | | S32 |
| Connected to L0 & L2 | | |
| All Sources i.e. Source 1, | ST34 | — |
| Source 2, Source 3 Disconnected | | |

It shall be noted that operation states such as ST11, ST12, ST21 and ST27 are the states when two or more sources are connected in parallel, whereas operation states such as ST13, ST14 and ST19 are the states when no two or more sources are connected in parallel. States such as ST13, ST14 and ST19 are also the states when two sources are connected in series, if the output is observed between line 1 (L1) and line 2 (L2). More than two sources can be connected in series if more sources and electrical lines are added.

In one embodiment and method of operations, the layout shown in FIG. 1 has two sources Source 1 and Source 2. For a first period of time, Source 1 supplies energy to a first set of lines L0 and L1, and at same time Source 2 supplies energy to a second set of lines L0 and L2. Then, based on determination or receipt of information on measures such as source power, source capacity, source depletion time or the current to/from other sources or loads including grid connections connected to one or more of the sets of lines, the system transitions to a different state for a second period of time, where Source 1 supplies energy to the second set of lines L0 and L2, and at same time Source 2 supplies energy to the first set of lines L0 and L1.

In one embodiment and method of operations, Source 1 and Source 2 are connected to the same set of lines so that they both supply energy to the same set of lines, in a parallel connection of Source 1 and Source 2.

For example, each source may be capable of providing an AC voltage output in order to provide a two phase AC output across the first and second set of lines.

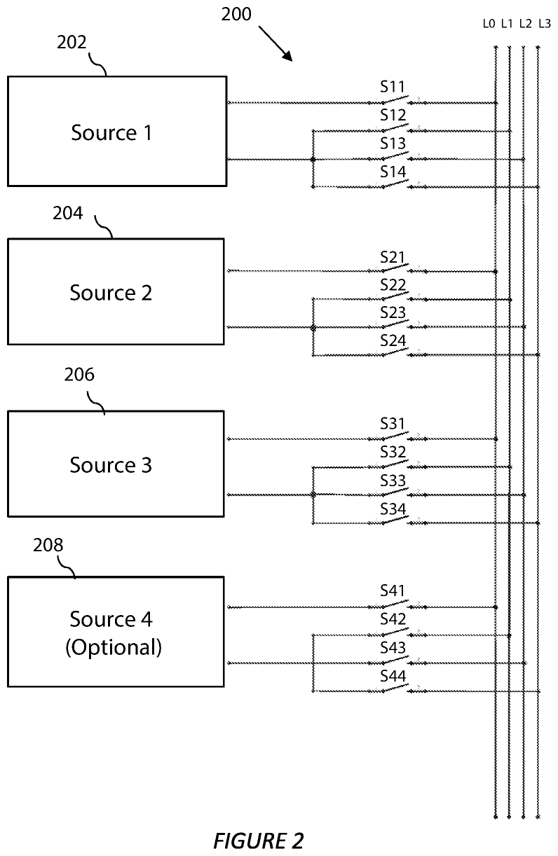

Now referring to FIG. 2, a circuit module 200 according to another embodiment of the invention is shown. The circuit module 200 is connected to sources i.e. Source 1 (202), Source 2 (204) and Source 3 (206) and an optional Source 4 (208) for providing electrical energy to an external load (not shown) or receiving electrical energy from an external supply (not shown) via a switching circuit that includes switches S11, S12, S13, S14, S21, S22, S23, S24, S31, S32, S33, S34, S41, S42, S43 and S44 from supply lines that are line 0 (L0), Line 1 (L1), Line 3 (L3) and Line 4 (L4). As can be seen in FIG. 2, Source 1 (202), source (204), Source 3 (206) and Source 4 (208) are connected to the neural line (L0) via switches S11, S21, S31 and S41, respectively. Furthermore, Source 1 (202), Source 2 (204), Source 3 (206) and Source 4 (208) are connected to the line 1 (L1) via switches S12, S22, S32 and S42, respectively. Similarly, Source 1 (202), source (204), Source 3 (206) and source 4 (208) are connected to the line 2 (L2) via switches S13, S23, S33 and S43, respectively, whereas Source 1 (202), Source 2 (204), Source 3 (206) and Source 4 (208) are connected to the line 4 (L4) via switches S14, S24, S34 and S44.

In one embodiment, the circuit module 200 is used to generate a controllable voltage profile including three voltage outputs. One voltage output is generated between line 0 and line 1, second output voltage is generated between line 0 and line 2 and third output voltage is generated between line 0 and line 3. The voltage output on these three combinations of lines (L0-L1, L0-L2 and L0-L3) can be a substantially steady voltage output over time (such as a DC voltage) or can be a varying voltage output over time (such as sinusoidal (AC), triangular etc). The sources (Source 1, Source 2, Source 3 and Source 4) can be a battery system or can be a generator.

In another embodiment, the circuit module 100 is used to receive electrical energy from an external supply. A first voltage input is received between line 0 and line 1, a second voltage input is received between line 0 and line 2 and a third voltage input is received between line 0 and line 3. The voltage inputs on these three combinations of lines (L0-L1, L0-L2 and L0-L3) can be a substantially steady voltage output over time (such as DC) or can be a varying voltage output over time (such as sinusoidal (AC), triangular etc) for receiving the electrical energy. The sources (Source 1, Source 2 and Source 3) can be a battery system or any other means that can store energy in other forms based on the electrical energy received.

The switching circuit (S11, S12, S13, S14, S21, S22, S23, S24, S31, S32, S33, S34, S41, S42, S43, S44) is configured to be controlled using a controller or a device(s) with equivalent functions. The selective control of the switching circuit helps in achieving various operation states, some of the achievable states are listed in the table below:

| | | |
|---|---|---|
| Source 1 Connected to L0 & L1 | ST35 | S11 S12 |
| Source 2 Connected to L0 & L2 | | S21 S23 |
| Source 3 Connected to L0 & L3 | | S31 S34 |
| Source 4 Disconnected | | — |
| Source 1 Disconnected | ST36 | — |
| Source 2 Connected to L0 & L2 | | S21 S23 |
| Source 3 Connected to L0 & L3 | | S31 S34 |
| Source 4 Connected to L0 & L1 | | S41 S42 |
| Source 1 Connected to L0 & L2 | ST37 | S11 S13 |
| Source 2 Connected to L0 & L1 | | S21 S22 |
| Source 3 Connected to L0 & L3 | | S31 S34 |
| Source 4 Disconnected | | — |
| Source 1 Connected to L0 & L3 | ST38 | S11 S14 |
| Source 2 Connected to L0 & L1 | | S21 S23 |
| Source 3 Connected to L0 & L2 | | S31 S33 |
| Source 4 Disconnected | | — |
| Source 1 Connected to L0 & L3 | ST39 | S11 S14 |
| Source 2 Connected to L0 & L2 | | S21 S23 |
| Source 3 Connected to L0 & L1 | | S31 S32 |
| Source 4 Disconnected | | — |
| Source 1 Disconnected | ST40 | — |
| Source 2 Connected to L0 & L2 | | S21 S23 |
| Source 3 Connected to L0 & L1 | | S31 S32 |
| Source 4 Connected to L0 & L3 | | S41 S44 |
| Source 1 Connected to L0 & L1 & L2 | ST41 | S11 S12 S13 |
| Source 2 Disconnected | | |
| Source 3 Disconnected | | — |
| Source 4 Disconnected | | — |
| | | — |
| Source 1 Disconnected | ST42 | — |
| Source 2 Connected to L0 & L1 & L2 | | S21 S22 S23 |
| Source 3 Disconnected | | |
| Source 4 Disconnected | | — |
| | | — |
| Source 1 Connected to L0 & L1 & L2 & L3 | ST43 | S11 S12 S13 S14 |
| Source 2 Disconnected | | |
| Source 3 Disconnected | | — |
| Source 4 Disconnected | | — |
| | | — |
| Source 1 Disconnected | ST44 | — |
| Source 2 Connected to L0 & L1 & L2 & L3 | | S21 S22 S23 S24 |
| Source 3 Disconnected | | |
| Source 4 Disconnected | | — |
| | | — |

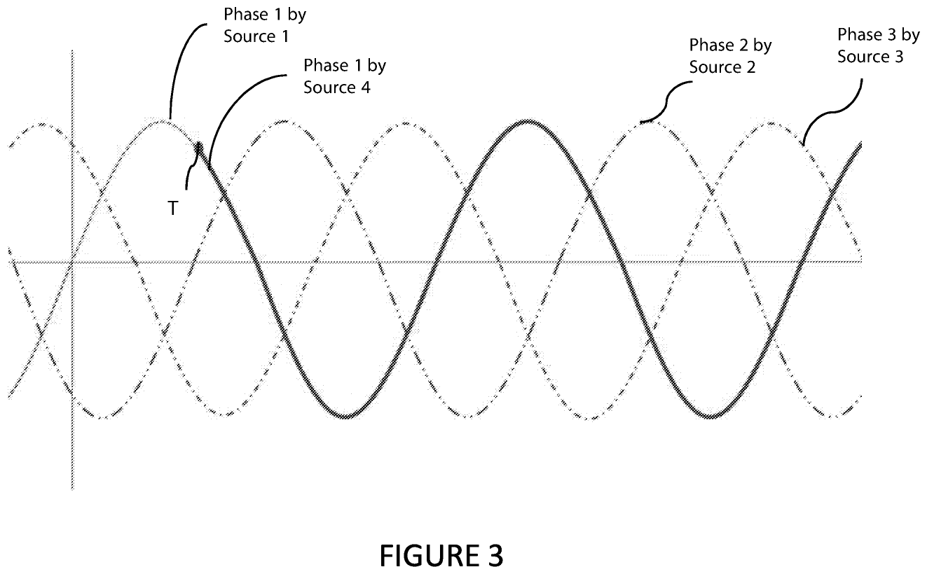

FIG. 3 illustrates a 3-phase voltage profile generated by the electrical system depicted in FIG. 2, where each source is able to provide the voltage profile of an AC output. The illustrated generated voltage profile includes three voltage signals appropriately phased and generated by the sources.

As can be seen, Sources 1-3 provide the voltage signals before time T, and Sources 2-4 provide the voltage signals after time T. In this case, each sinusoidal voltage signal is provided by only one source and the state of the circuit module is changed, for example from ST35 to ST36; after detecting Source 1 is no longer able to provide the required voltage signal. As can be seen, during the state change there is no obstruction in the overall voltage profile being delivered to one or more loads connected to the electrical system.

This timing of the change of states can be determined based on a number of factors including the relative depletion rates of the sources, relative SOCs (States of Charge) of the sources, relative SOHs (States of Health), cycle life of the sources, relative capacities of the sources, phase timings, phase angles and other information about the sources. In some embodiments, the voltage values for the overall electrical system, user inputs, and/or external signals/inputs are further factors. In some embodiments, user inputs and/or external signals/inputs are the only factors.

In some embodiments, state changes are made to control the relative balance of the discharge rate of sources. In other embodiments, state changes are made when a source is outside of a predetermined operating range, such as the source supply voltage. For example, the voltage values for the overall electrical system, user inputs, and/or external signals are further factors. In some embodiments, sources depleting faster than others could have reduced operational time connected to a load. In some embodiments, sources that are newer in terms of cycle life or having higher capacities or having higher SOCs could have additional operational time.

The circuit of FIG. 2 further comprises an optional fourth source which is able to be connected so that one of the three sources can be taken offline for reasons such as maintenance and inspection without disrupting the 3 phase power supply. In some embodiments, the fourth source is connected in place of, or to supplement (such as connection in series or parallel) one or more other sources. Such a determination to replace or supplement a source may be based on source performance, and a determination that the performance is below a predetermined performance threshold (such as maximum voltage output or similar). In some embodiments, a weighted combination of two or more of these factors can be used to make the determination. In some embodiments, factors and considerations are balanced against one another to achieve an optimal outcome for the overall electrical system. The controller is configured to connect the fourth source in place of one of the other sources 1-3 when a particular control criteria is met. The control criteria may comprise, for example, one or more of user inputs or external signals/inputs that one or more of the sources needs to be taken offline based on one or more of: voltage, current, temperature, historical measurement data, phase timings, phase angles, state of charge, capacity, cycle life of the battery, depletion rate and other information related to the battery packs; and changes the states of the switching circuit to disconnect that one or more sources. In some embodiments, the controller also determines the backup source(s) that need to be connected to the appropriate lines to ensure that power supply is uninterrupted based on single, 2, or 3 phase AC profiles; the controller also determines the timing of the connection switching.

States ST41 to ST44 allow one source to be connected to multiple sets of lines. These states are not meant to be limiting and are illustrative of the flexibility achieved by some embodiments of the invention.

At the time of the controller operating to change the state of the switching circuit, in most circumstances it is preferable that the voltage profile of the source is substantially matched by the replacement source. Accordingly, the controller is configured to operate the switching circuit based on a substantially uninterrupted voltage profiles. The voltage profile may be substantially matched by ensuring the voltage amplitude of a first source is substantially matched by the replacement source. Further, where the source is providing a time varying voltage such as an AC waveform, then the replacement source is operated such that the replacement source also substantially matches the voltage and time varying characteristics. In some embodiments, the controller is configured to control the source such that a substantially matched voltage profile is delivered at the time of switching, or the controller may signal another controller configured to operate the source. In some embodiments, the controller is configured to control a switch event at the time when an AC waveform is making a zero-crossing.

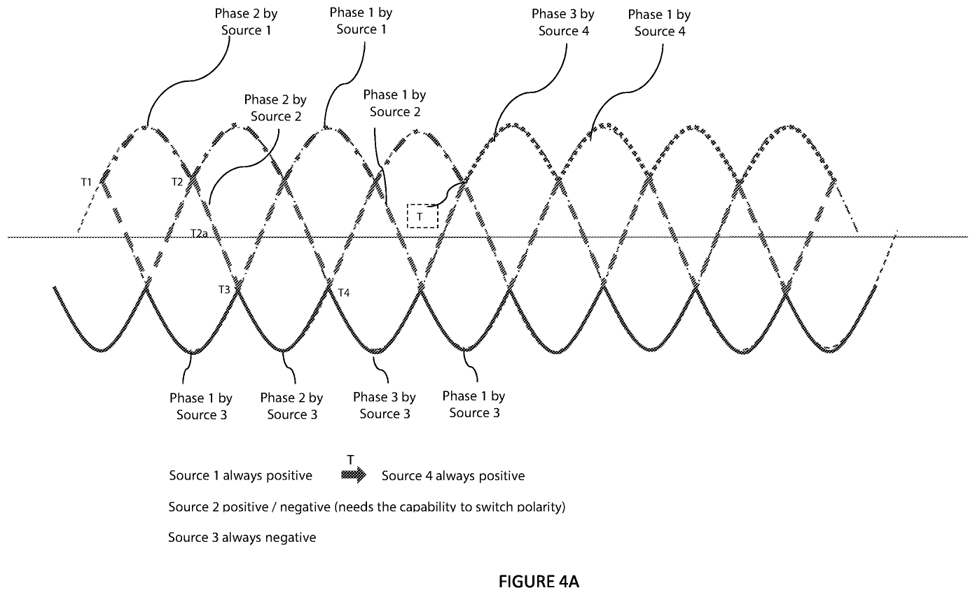

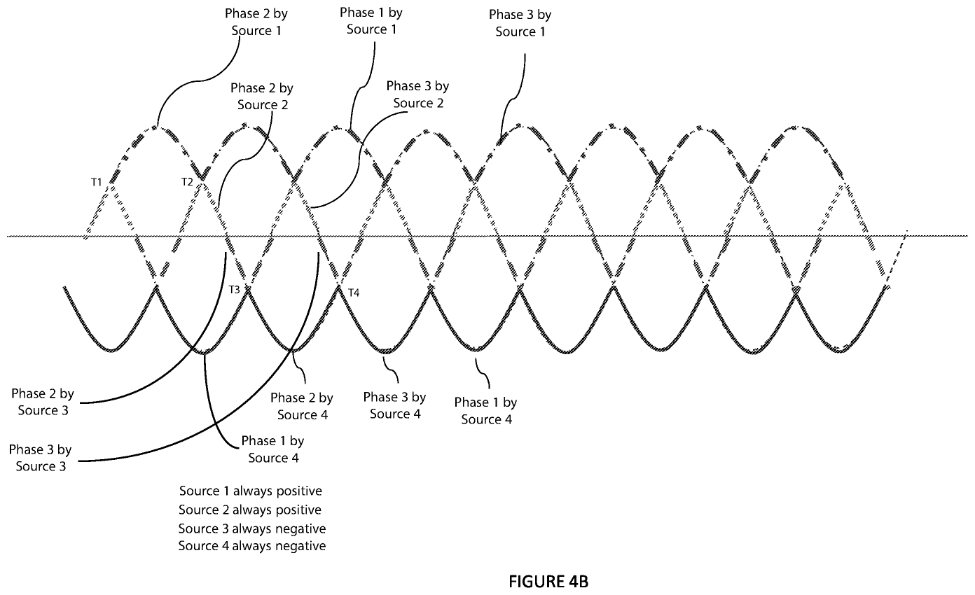

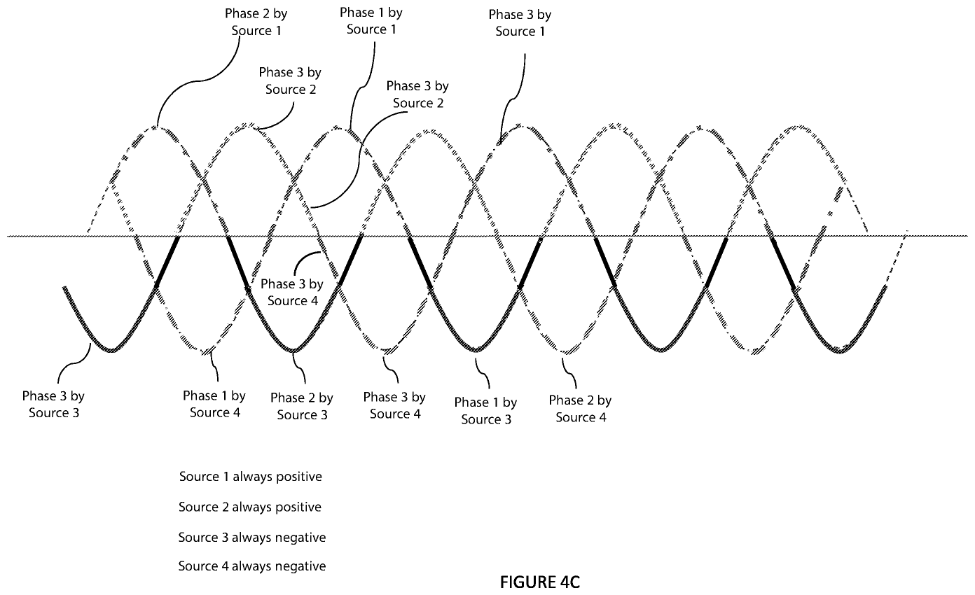

FIGS. 4A, 4B and 4C illustrate 3 exemplary embodiments to achieve a 3-phase voltage profile generated by the electrical system depicted in FIG. 2. These exemplary arrangements demonstrate the flexibility of the embodiment depicted in FIG. 2, and are not meant to be exhaustive or limiting.

In FIG. 4A, Source 1 is able to provide a positive rectified AC output (positive half-sine-wave voltage output) that is offset from neutral, Source 3 is able to provide a negative rectified AC output that is offset from neutral, and Source 2 provides a time varying output having positive and negative components compared to neutral. The optional Source 4 takes over from Source 1 at point T in time, for example, when Source 1 is depleted. The illustrated generated voltage profile includes three voltage signals appropriately phased and generated by the sources. As can be seen, Sources 1-3 provide the voltage signals before time T, and Sources 2-4 provide the voltage signals after time T. The switching circuit is controlled such that Source 2, Source 1 and Source 3 are connected to phase 2 at T1-T2, T2-T3 and T3-T4 time intervals, respectively, with relevant output. Like the previous example, the state of the circuit module changes at time T2 when Source 1 is switched from phase 2 to phase 3 (the electrical lines corresponding to the respective phases). Likewise, Source 2 is switched from phase 3 to phase 2 at time T2. Note in particular that at time T2a Source 2 switches polarity from positive to negative, which is achieved, for example, by Source 2's internal polarity switching capability of a built-in H-bridge, such as that illustrated in FIG. 15(G) and FIG. 15(H) and disclosed in U.S. Ser. No. 10/910,606B2 (Battery System). Alternatively, Source 2 could have internal polarity switching capability without the use of an H-bridge such as that illustrated in FIGS. 15(D), 15(E), 15(l), 15(J), 15(F), and disclosed in U.S. Ser. No. 11/264,812B2 (Battery System). At time T Source 4 takes over from Source 1 to continue to provide the top third of the 3 phase voltage outputs in FIG. 4A without any obstruction in the overall voltage profile being delivered to load(s) connected to the electrical system.

In FIG. 4B, Sources 1 and 2 are used to generate the positive waveforms of all 3 phases, with Source 1 generating a positive rectified AC output (positive half-sine-wave voltage output) that is offset from neutral, and Source 2 generating a time varying output that is always positive. Sources 3 and 4 are used to generate the negative waveforms of all 3 phases, with Source 4 generating a negative rectified AC output (negative half-sine-wave voltage output) that is offset from neutral, and Source 3 generating a time varying output that is always negative. One advantage of this embodiment is that no polarity switching capability is required from any source. Most battery systems do not have polarity switching capabilities. And battery systems using an H-bridge have substantial limitations on the maximum achievable voltage output, as transistors (such as power mosfets) in an H-bridge are typically rated for up to a certain voltage only (˜1500V). Embodiments that do not require polarity switching from any source are therefore substantially advantageous. For example, without an H-bridge, each battery source can achieve voltage outputs over 2000V. In some embodiments, a series connection of sources can achieve even higher voltages, for example, 5000V, 10 kV, 20 kV, 50 kV or 100 kV, or more.

In FIG. 4C, Source 1 provides positive rectified AC output (positive half-sine-wave voltage output) for every other phase. For example, as can be seen in the figure, it provides the positive voltage profile of phase 2, followed by phase 1, followed by phase 3, etc. Likewise, Source 2 provides positive rectified AC output (positive half-sine-wave voltage output) for every other phase. Source 3 and Source 4 mirror the behaviours of Source 1 and Source 2 in negative polarity. As with FIG. 4B's embodiment, this embodiment also achieves 3 phase AC without requiring polarity switching from any source. A further advantage of this embodiment is that less switching (switching sources to connect to different sets of electrical lines of the 3 phases) is necessary than previous earlier embodiments.

In some embodiments, more than 3 sources are connected for the purposes of providing balancing between battery packs as explained under FIG. 3. In some embodiments, additional sources are connected so that one or more sources can be taken offline for reasons such as maintenance and inspection without disrupting the 3 phase power supply. Embodiments under FIGS. 31, 32 and 3 in terms of the controller determinations and logics to configure states of the circuit module also apply here.

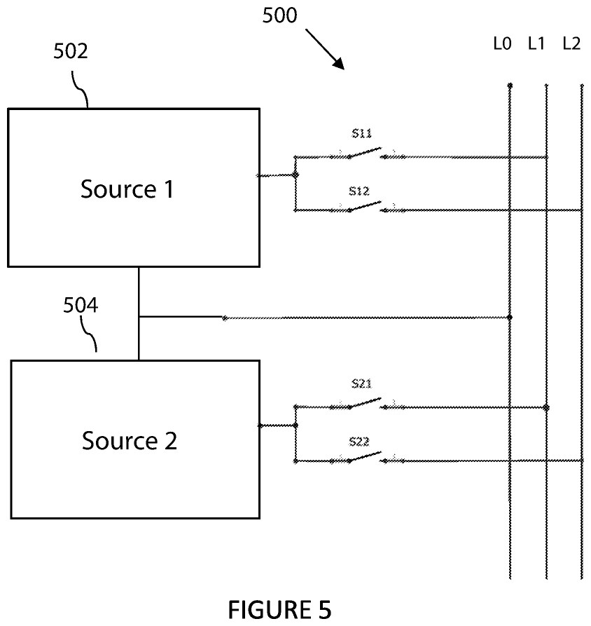

One terminal of the sources in embodiments shown can be connected together and be connected to a line 0. An example is shown in FIG. 5, where neutral terminals of Source 1 (502) and Source 2 (504) are connected jointly to a line 0 (L0).

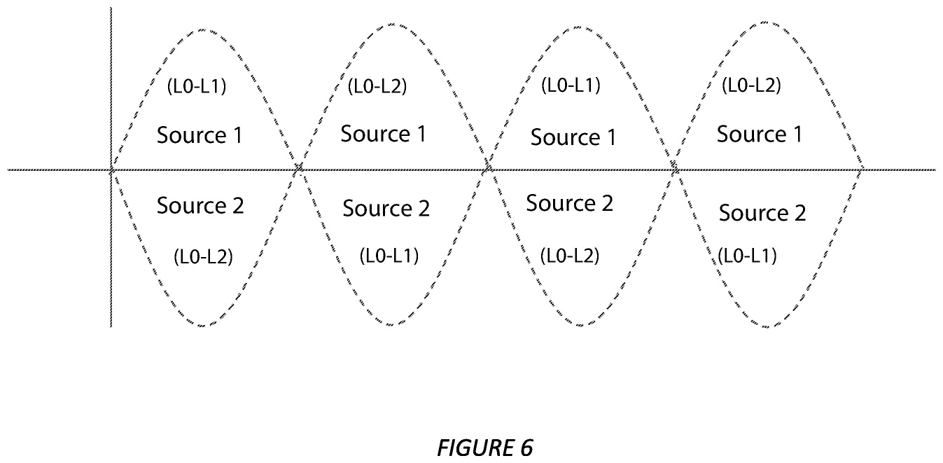

In some embodiments, a part of a voltage signal is generated by one source and another part of the signal is generated by another source. In some embodiments, the positive side of signals are generated by one source and negative side of the signals are generated by another source. For example, as FIG. 6 illustrates for the embodiment of the circuit module shown in FIG. 5, where Source 1 is able to provide a rectified-AC voltage output and Source 2 able to provide a rectified-AC voltage output, and Source 1 is configured to provide a rectified AC voltage output that is approximately in phase with, but of opposite polarity to, the rectified AC voltage output of Source 2. In a state of the switching circuit in which the input connecting to Source 1 is connected to a first set of electrical lines L0 and L1 by having switch S11 in the conducting state and switch S12 in the non-conducting state, Source 1 provides a half-sine-wave voltage output between lines L0 and L1. In a subsequent state of the switching circuit in which the input connecting to Source 1 is connected to a second set of electrical lines L0 and L2 by having switch S12 in the conducting state and switch S11 in the non-conducting state, Source 1 provides a subsequent half-sine-wave voltage output between lines L0 and L2. Source 1 can thus provide the positive side of each of the two voltage signals. At the same time and in an equivalent manner, the negative side of the signals are generated by Source 2. This achieves a split-phase (i.e. two-phase est. 180 degree separated) AC output from two sources that each provide a rectified AC output.

In an alternative embodiment, both Sources in FIG. 6 can provide rectified-AC voltage output selectively in the positive or negative direction. For a first period of time, Source 1 can provide the positive side of each of the two voltage signals, and at the same time and in an equivalent manner, the negative side of the signals are generated by Source 2. Then, based on determination or receipt of information on certain measures, the system transitions to a different state for a second period of time, where Source 2 can provide the positive side of each of the two voltage signals and the same time and in an equivalent manner, the negative side of the signals are generated by Source 1. Here the positive side of each of the two voltage signals should be understood to mean the same thing as the positive half-sine-wave voltage of each of the two voltage signals.

In an alternative embodiment, both Sources in FIG. 6 can selectively provide rectified-AC voltage or AC voltage. For a first period of time, Source 1 can provide the positive side of each of the two voltage signals, and at the same time and in an equivalent manner, the negative side of the signals are generated by Source 2. Then, based on determination or receipt of information on certain measures, the system transitions to a different state for a second period of time, where Source 1 supplies AC energy to the second set of lines L0 and L1, and at same time Source 2 supplies AC energy to the first set of lines L0 and L2. In this way, the system has the ability to switch between providing split-phase as positive vs negative and providing split-phase as phase 1 vs phase 2.

In some embodiments, the controller determines timing of the switching of states based on the phase angles of the sources. The first and second sources' connections are switched to connect to alternate sets of lines (L0&L1, L0&L2) at substantially the same time intervals according to the phase angle information.

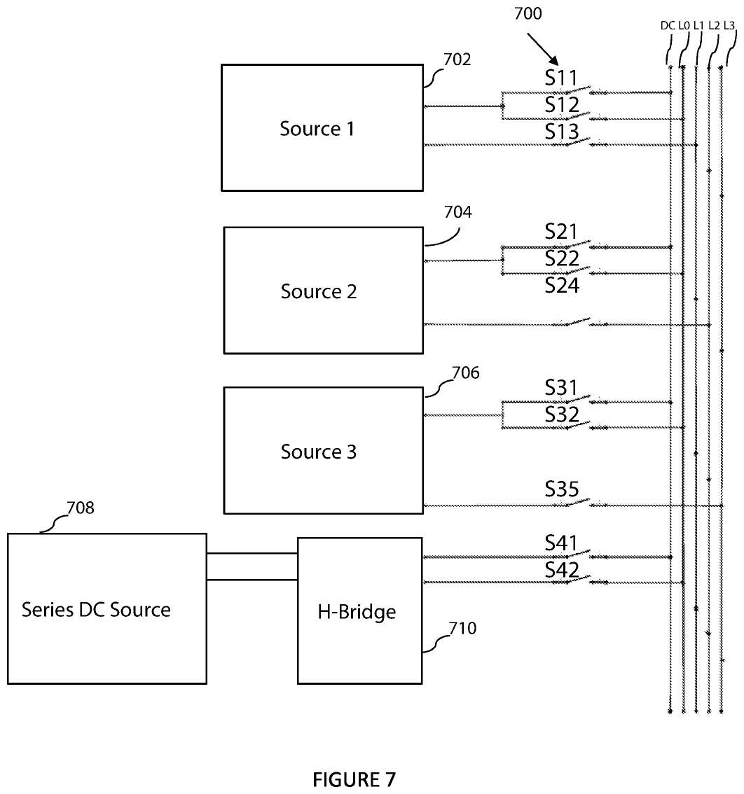

FIG. 7 illustrates a circuit module 700 according to another embodiment of the invention. The circuit module 700 is connected to sources i.e. Source 1 (702), Source 2 (704) and Source 3 (706), and a series DC source (708) through an H-bridge or other converting circuit (710) for providing electrical energy to an external load (not shown) or receiving electrical energy from an external supply (not shown) via a switching circuit that includes switches S11, S12, S13, S21, S22, S24, S31, S32, S35, S41 and S42 from supply lines that are neural (L0), Line 1 (L1), Line 2 (L2), Line 2 (L3) and a substantially DC line (DC). The DC source provides a substantially steady (e.g. DC) voltage profile, whereas Sources 1, 2 and 3 can each provide at least a substantially time-varying output that can achieve positive and negative polarity compared to neutral (such as an AC output). The entire assembly depicted in the Figure is referred to as an electrical system. Advantageously, the electrical system uses a series DC source that can be connected in series with any of the Sources 1-3 if needed, e.g. in case, a particular source is not fully charged and/or may be unable to sustain required voltage in future. Other embodiments can comprise two or more Series DC sources that are each connected via an H-bridge or other converting circuit. A further embodiment can comprise only Source 1, the Series DC Source with H-bridge, switches S11-13, S41 and S42, and lines DC, L0 and L1, with these components in the same arrangement as shown in FIG. 7, and be capable of providing a single-phase AC output between lines L0 and L1.

Having a switch on each of the two paths to the reference terminal (top terminal in the figure) of each source allows each source to selectively be connected in series with the Series DC Source (708).

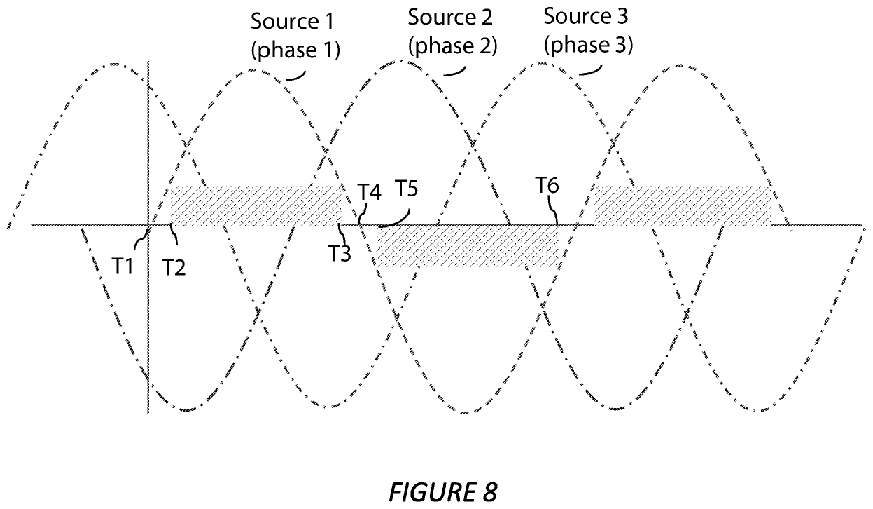

In some embodiments, the electrical system has at least one energy source that is a DC source providing an output voltage that is substantially a direct current (DC), and at least one energy source that is a controllable and variable voltage source outputting a part or a whole of a substantially sine-wave voltage waveform; and the controller is configured to change the state of the switching circuit to connect the DC source in series with the controllable and variable voltage source so that an AC output is produced by the electrical system. This substantially sine-wave voltage waveform may not be exactly sine-wave, and may be offset from the X-axis of FIG. 8, such that the end AC output is an AC waveform.

For example, FIG. 8 illustrates a scenario where the switching circuit in FIG. 7 is controlled such that the series DC source is connected in series with Source 1 from time interval T2 to T3, providing a positive part of the sinusoidal signal. The switching circuit is configured to operate in a state where switches S11, S13, S41 and S42 are conductive (in addition to S22, S24, S32, S35). A current travels from L1 to Source 1 via switch S13, out of Source 1 into Line DC via switch S11, along Line DC to the Series DC Source via S41, then out of Series DC Source via S42 into Line L0; while any loads are connected across L0 and L1, where current outputs are measured and observed as depicted in FIG. 8. During time interval T3-T5, the state of the circuit module changes, as the switches S12 and S13 are conductive (in addition to S22, S24, S32, S35, to supply phases 2 and 3), while switches S41 and S42 are non-conductive. During subsequent time interval T5-T6, the switches take an identical state to T2 to T3, however the series DC source 708 and H-bridge circuit 710 in combination is configured to provide a negative DC voltage. Similar to the earlier embodiments, the circuit module can be operated in various states by selectively controlling the switches depicted.

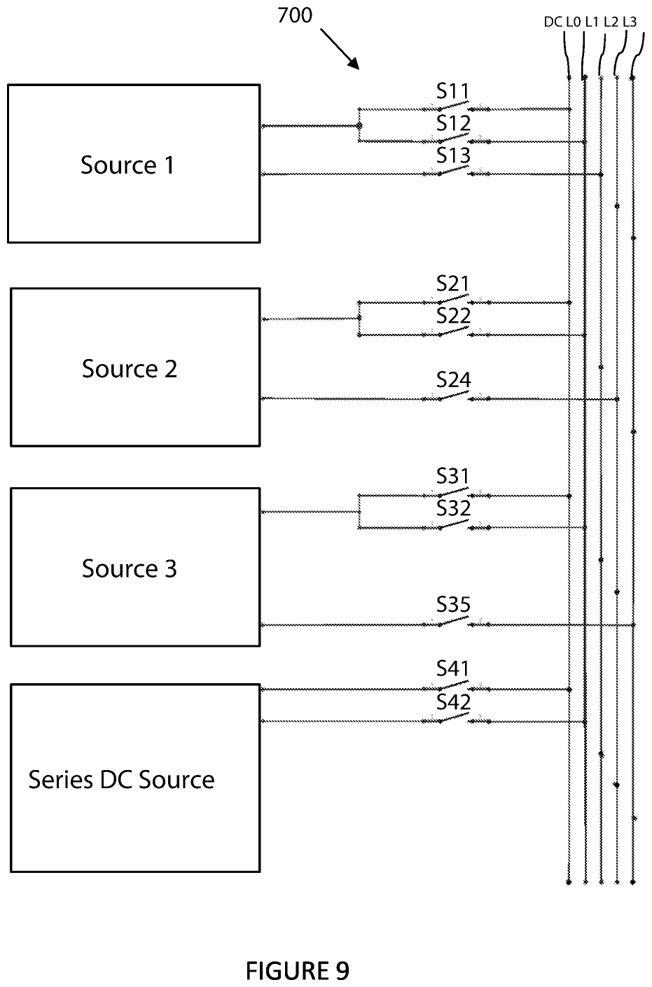

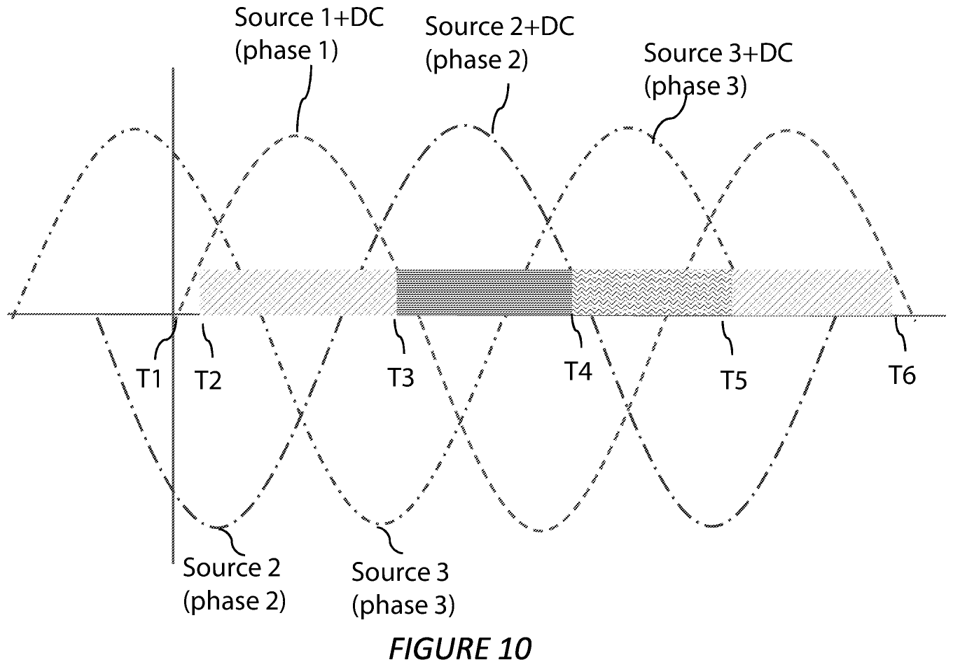

FIG. 9 illustrates an electrical system that uses the circuit module shown in FIG. 7. It is different from the electrical system illustrated in FIG. 7 primarily in that it does not include an H-bridge circuit coupled with the series DC source. As such, the series DC source provides a single polarity output and can only be connected with any one of the Source 1-3 in either positive or negative part of the signal, not both. For example, FIG. 10 illustrates that the series DC source is connected in series with Source 1, Source 2, Source 3 and Source 1 for time intervals T2-T3, T3-T4, T4-T5 and T5-T6 respectively, with the respective series connection of both sources providing substantially a sine-wave for the positive half-sine-wave. The states of the circuit module can be changed by controlling the switching circuit. For example, at time interval T2-T3, switches S11, S13, S41 and S42 are conducting (in addition to S21, S23, S31, S32). At time interval T3-T4, switches S21, S24, S41, S42 (in addition to S12, S13, S22, S24) are conducting. During T3-T4, the Series DC Source is connected in series with Source 2 (Phase 2) instead. The timing of a state change at T3 could actually be anywhere between when the next phase reaches threshold, and previous phase drops below threshold.

The timing of source connection can be determined based on a number of factors including the relative depletion rates of the sources, relative SOHs (States of Health), relative SOCs (States of Charge) of the sources, cycle life of the sources, relative capacities of the sources, phase timings, phase angles and other information of the sources. In some embodiments, the voltage values for the overall electrical system, user inputs, and/or external signals/inputs are further factors. In some embodiments, user inputs and/or external signals/inputs are the only factors.

In some embodiments, sources depleting faster than others could have additional time with the series DC source. In some embodiments, sources that are older in terms of cycle life or lesser SOH or having lower capacities or having lower SOHs could have additional time with the switching circuit configured to connect the series DC source. As mentioned, it can be desirable for battery packs to reach end of cycle life at approximately the same time so that all phases are operational for the maximum possible time before the batteries have reached end of cycle life. In some embodiments, the factors include one or more of all the information which may be contained in the information module. In some embodiments, a weighted combination of two or more of these factors can be used to make the determination. In some embodiments, factors and considerations are balanced against one another to achieve an optimal outcome for the overall electrical system.

Other embodiments can comprise two or more Series DC Sources, four or more non-DC Sources and/or have non-DC Sources with the ability to further change between selectively connecting at least one source connection between several of the lines L1-L3. A further embodiment can comprise only Source 1, the Series DC Source, switches S11-13, S41 and S42, and lines DD, L0 and L1, with these components in the same arrangement as shown in FIG. 9, and be capable of providing a single-phase AC output between lines L0 and L1.

In some embodiments, the series DC source may be one or more solar panels connected with a voltage or current converter.

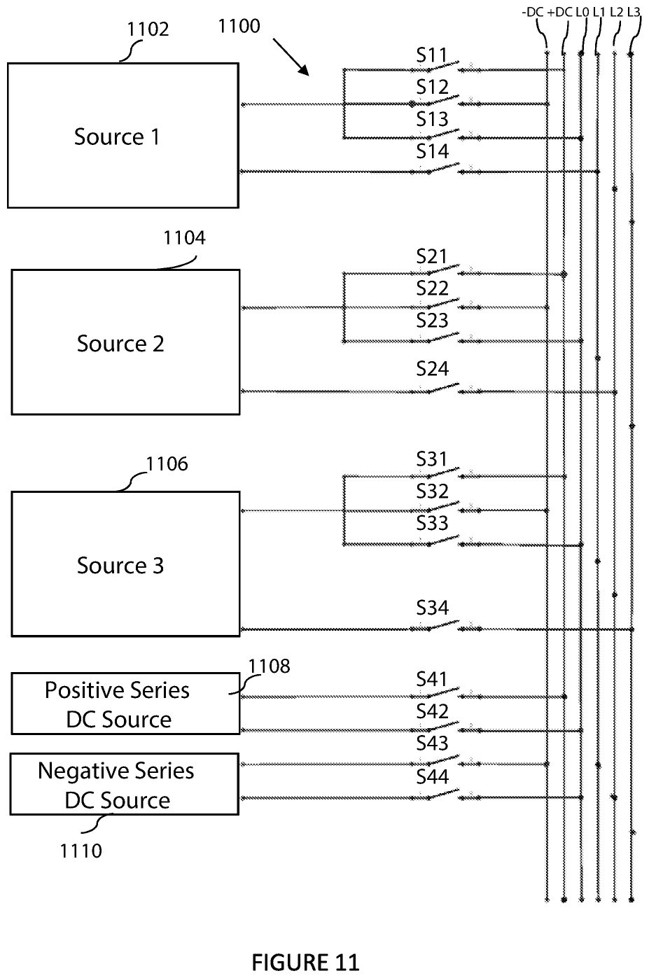

FIG. 11 illustrates a circuit module 1100 according to another embodiment of the invention. The circuit module 1100 is connected to sources i.e. Source 1 (1102), Source 2 (1104) and Source 3 (1106), a positive series DC source (1108) and a negative series DC source (1110) for providing electrical energy to one or more external loads (not shown) or receiving electrical energy from one or more external supplies (not shown) via a switching circuit that includes switches S11, S12, S13, S14, S21, S22, S23, S24, S31, S32, S33, S34, S41, S42, S43 and S44 from supply lines that are line 0 (L0), Line 1 (L1), Line 2 (L2), Line 2 (L3), a positive DC line (+DC) and a negative DC line (−DC). The DC sources provide substantially steady voltage profiles, whereas Sources 1, 2 and 3 can each provide at least a substantially time-varying output that can achieve positive and negative polarity compared to neutral (such as an AC output). The entire assembly depicted in the Figure is referred to as an electrical system. Advantageously, the series DC sources can be used in series with any of the Sources 1-3 in certain states of the circuit module, in particular, when a source is not fully charged, unable to provide required voltage itself.

In some embodiments, there are more DC sources than shown in FIGS. 7-11. In some embodiments, to allow for more DC sources to be added to the electrical system and be selectively connected in series with an AC source more lines/switches may need to be added. In some embodiments, there can be more sources capable of providing AC voltage than are shown in the figures. Advantageously, any one or more of the series DC sources can be used in series with any one or more of the AC capable sources in certain states of the circuit module, in particular, when a source is not fully charged, unable to provide required voltage amplitude by itself.

In some embodiments, the electrical system shown in FIGS. 7 to 11 include at least one DC source providing a voltage output that is substantially a direct current (DC) voltage output selectively connected with at least one set of electrical lines; and at least one of the energy sources is a AC voltage source. In some embodiments, the controller is configured to determine voltage and phase information of the at least one AC voltage source, and operate the switching circuit to selectively connect the DC source in series with the AC source when the controller determines that the DC source voltage exceeds the AC source voltage for at least a half-phase of the AC source. In some embodiments, the controller operates the switching circuit to selectively connect one or more of the DC sources in series with one or more of the AC capable sources based on any information which may be contained by the data module.

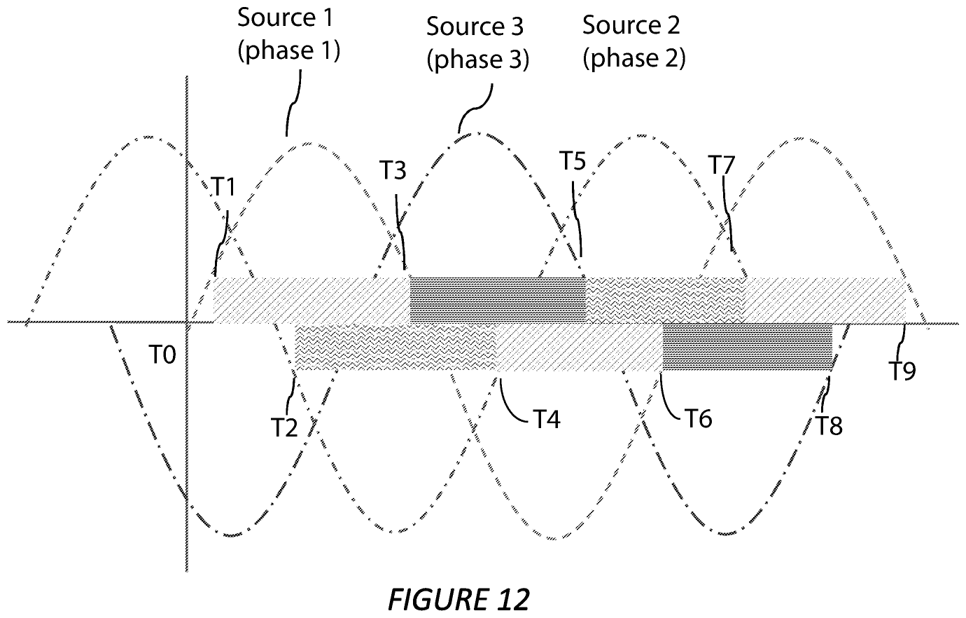

FIG. 12 depicts an embodiment where the switching circuit 1100 is controlled such that the positive series DC source is connected in series with Source 1 during time interval T1-T3, with Source 2 during time interval T3-T5, with Source 3 during time interval T5-T7 and with Source 1 during time interval T7-T9. Furthermore, the switching circuit is controlled such that the negative series DC source is connected in series with Source 3 during time interval T2-T4, with Source 1 during time interval T4-T6 and with Source 2 during time interval T6-T8.

The circuit module 1100 is configured to switch from a state to another state. For example, a state when S11, S14, S22, S24, S33, S34, S41, S42, S43, S44 are conducting, to another state when S13, S14, S22, S24, S31, S34, S41, S42, S43, S44 are conducting. This particular state change is represented at time T3 depicted in FIG. 12, when positive DC support is switched to be connected in series to Source 3 from Source 1. Similar to the above embodiment, it is to be understood that other states can also be achieved by selective control of the switching circuit. Other circuit states of the circuit module 1100 are possible.

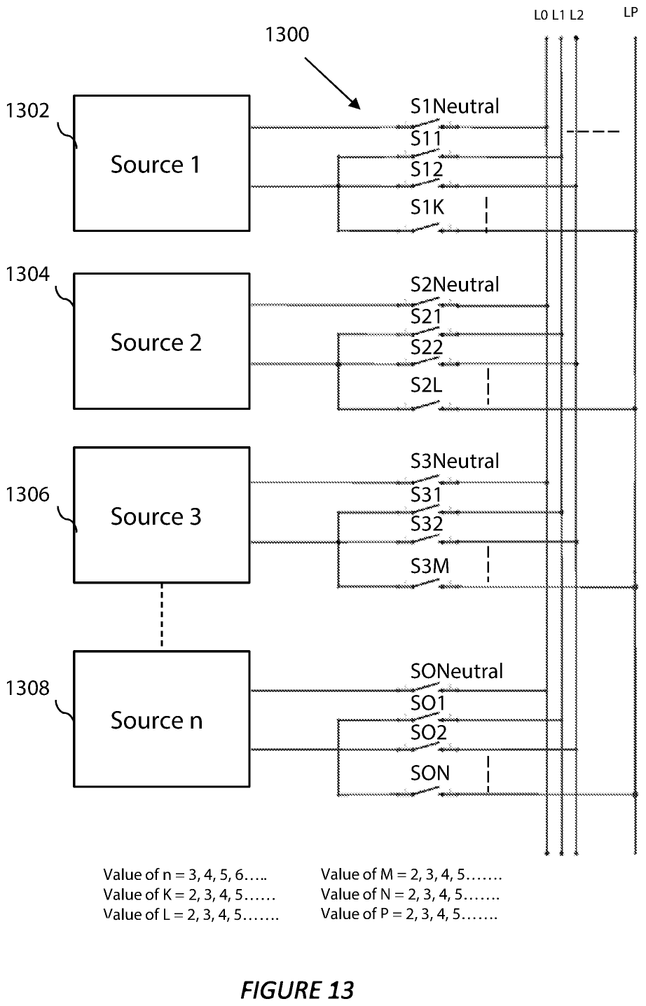

FIG. 13 shows a generic extendable electrical system 1300 (n, K, L M . . . , N, P) of the electrical systems disclosed with FIG. 1 (100) and FIG. 2 (200). As can be seen, value n is the total number of sources present in the system, K is the number of switching devices coupling a first source to one or more lines of the system, L is the number of switching devices coupling a first source to one or more lines of the system, M is the number of switching devices coupling a second source to one or more lines of the system, N is the number of switching devices coupling a nth source to one or more lines of the system, P is the total number of lines that are coupled to one or more number of the sources (1 to n) of the system. The values of parameters n, L, L, M, N and P can be of any combination, until the value meet following criterion: Value of n=3, 4, 5, 6 . . . , Value of K=2, 3, 4, 5 . . . , Value of L=2, 3, 4, 5 . . . , Value of M=2, 3, 4, 5 . . . , Value of N=2, 3, 4, 5 . . . , Value of P=2, 3, 4, 5 . . . .

Preferably, the value of parameters K, L, M, N are equal or less than the value of P. In case there are multiple switching devices used to connect a source to a line, it is considered as one switch in relation to the value of parameters n, K, L, M . . . , N, P parameters described above.

In one embodiment, the electrical system 1300 is used to generate a controllable voltage profile including two voltage outputs for providing electrical energy to an external load, e.g., when value of P is 5, total up to 5 voltage outputs can be generated. Voltage outputs are generated between the lines, same in principles as electrical systems disclosed in FIG. 1 and FIG. 2.

In another embodiment, the electrical system 1300 is used to receive electrical energy from an external supply. The received electrical energy can be in the form of a substantially steady voltage output over time (such as DC) or can be a varying voltage output over time (such as sinusoidal (AC), triangular etc) for receiving the electrical energy. The sources (Source 1, Source 2 and source n) can be a battery system or any other means that can store energy in other forms.

In another embodiment, the generic electric system 1300 may use multiple switching devices to couple a source to a line of the system.

It is to be understood that the electrical system of various sizes can be achieved as depicted in the table above by the proposed embodiment of the invention, by changing values of parameters n, K, L M . . . N and P. It is also to be understood that with the same n, K, L M . . . , N, P parameter values, different configurations of the electrical system can be achieved. A person skilled in the art will appreciate that a variety of example circuits achievable will have varying numbers of total operating states.

In some embodiments, to connect two or more sources in series in a star 3 phase configuration, at least 4+1 electrical lines are needed (thus P≥5).

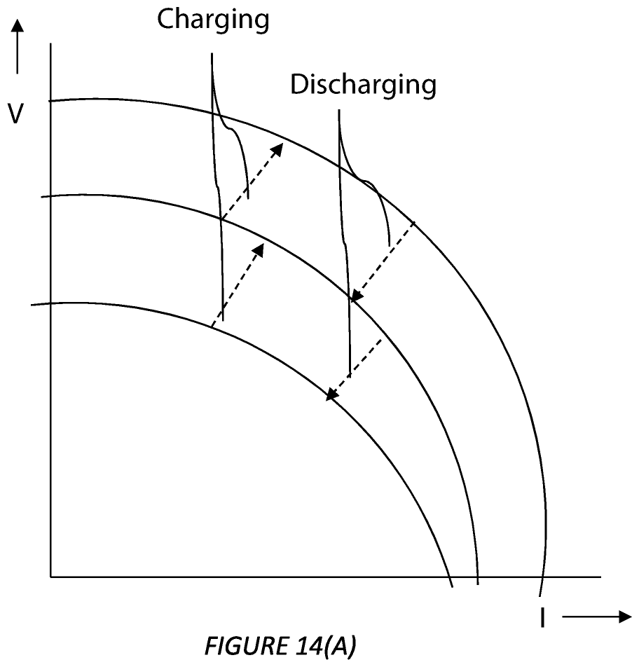

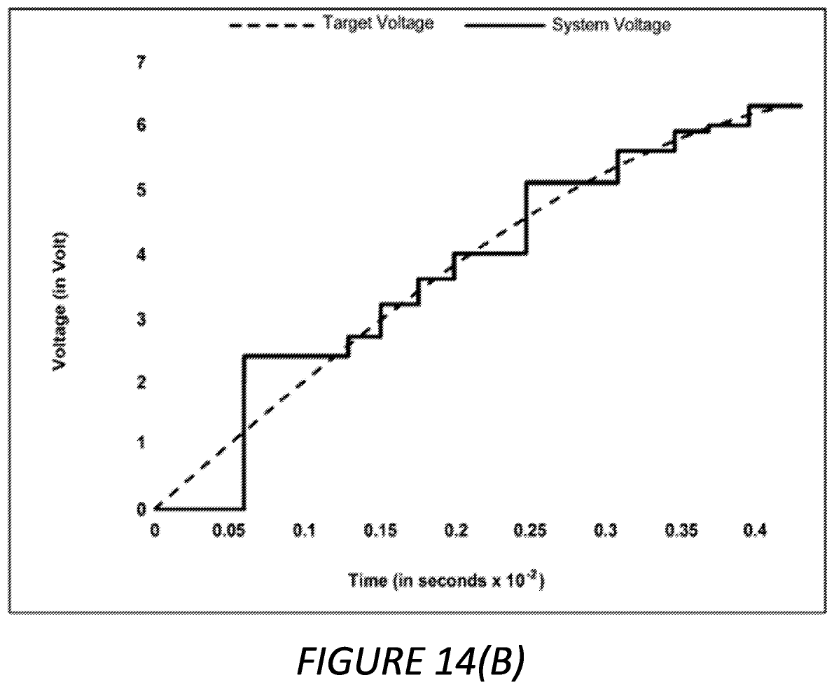

FIG. 14(A) illustrates voltage-current relationships of a battery at different charge levels on varying loads. The Figure depicts that when a battery's charging level reduces, its capability to provide high voltage reduces. One advantage of the disclosed circuit modules with various embodiments of the present invention is that when a source's capability to provide high voltage reduces, the states of the circuit module can be changed. For example, a particular source which is not adequately charged, or has a lower capacity, can be decoupled from a line, changing its coupling to another line that has lower demand or additional source can be coupled in series to the line the source is already coupled to provide assistance in delivering a required voltage. Advantageously, the controller is configured to control the change of states such that the loads receive uninterrupted power supply, such as by timing a switching event with a zero-crossing of an AC waveform or by determining or controlling the instant voltage of one source to substantial matches the instant voltage of a replacement source.

For example, in some embodiments, the controller is configured to determine a source has a voltage outside of a range required to supply a maximum desired voltage, and is thereby configured to operate the states of the circuit module to: decouple the source from a line, changing its coupling to another line that has lower voltage demand; or couple in series, one or more additional sources in series to the line the source is already coupled to increase the voltage output.

In some embodiments, the switching devices used with the embodiments are semiconductor-based switches (e.g. MOSFET etc.), that can switch ON or OFF within a fraction of a second. The circuit module can be controlled such that a DC source provides voltage at a level that achieves a certain current. For example, a rechargeable energy storage unit configured to selectively receive power via the circuit module can be connected with a solar DC source and the voltage between the solar DC source and the rechargeable energy storage unit controlled in such a way that the power provided by the solar DC source is maximised. In some embodiments, the rechargeable energy source is configured to output a DC voltage. In some embodiments, the DC source may be another form of energy source than a solar source.

In some embodiments, one or more sources or all the sources are battery systems. The battery system can be realised by using any state-of-the-art technique. When varying voltage output is to be achieved (e.g. AC voltage), an inverter is used with the battery system to convert a DC voltage output received from the battery system to a varying voltage output (e.g. AC voltage).

In some embodiments, the sources are rechargeable and include a plurality of energy storage cells units connected with a plurality of switching assemblies (switching devices). The plurality of energy storage cell units are connected in series and one or more switching assemblies are selectively controlled by one or more source controllers, to disconnect any one or more of the energy storage cell units from being connected with any other energy storage cell units, and connect in series any one of the energy storage cell units with any other energy storage cell unit. The switching assembly is controlled at a very high frequency to generate a time varying voltage output (e.g. AC signal). FIG. 14(B) illustrates how a targeted varying voltage output can be approximately achieved by rapidly controlling ON and OFF state of the switching assemblies of the source(s). In some embodiments, some or all of such energy storage cell units are battery units.

Alternatively, in some embodiments, a battery system is achieved by using a number of battery cell units with one or more switching assemblies (electronically controllable switches) coupled to them. FIGS. 15(A), 15(B), 15(C), 15(D), 15(E), 15(F), 15(G), 15(H) and 15(l) illustrate example sources that are rechargeable energy storage units, specifically battery storage units, and each comprising a plurality of energy storage cell units, specifically battery cell units, that are connected in series. These sources can be used with the electrical system disclosed in the various embodiments of the invention that comprise (or refer to) one or more sources. These rechargeable energy storage units each include a plurality of energy storage cell units connected in series (e.g. C1, C2, C3 . . . ) and one or more cell switching assemblies (e.g. S1, S2, S3, . . . ) configured to disconnect any one or more of the energy storage cell units from being connected with any other energy storage cell units, and connect in series any one of the energy storage cell units with any other energy storage cell unit.

These one or more switching assemblies can be controlled by one or more source controllers (not shown) configured to selectively control the one or more switching assemblies. Some energy sources, such as those illustrated in 15(A), 15(B) and 15(C), can selectively provide a substantially DC output at one time, and a substantially time-varying output that has a single polarity compared to neutral (such as a rectified AC output) at a different time. Such sources may benefit from a reduced cost, reduced size, reduced weight, increased efficiency or other advantages compared to energy sources that can further provide a substantially time-varying output that can achieve positive and negative polarity compared to neutral (such as an AC output). Optionally, a DC-to-AC converter (such as an H-bridge or an inverter) or rectified-AC-to-AC converter (such as an H-bridge) can be connected between such sources to enable these sources to further at select times provide a substantially time-varying output that can achieve positive and negative polarity compared to neutral (such as an AC output).

Some energy sources, such as those illustrated in 15(D), 15(E), 15(F), 15(G), 15(H) and 15(I), can selectively provide a substantially DC output at one time, a substantially time-varying output that has a single polarity compared to neutral (such as a rectified AC output) at a different time, and a substantially time-varying output that can achieve positive and negative polarity compared to neutral (e.g. an AC output) at a different time yet.

In some embodiments, the switching assembly of these energy sources illustrated with FIGS. 15(A-I) are controlled by the same controller(s) controlling the switching circuits of the electrical systems disclosed in various embodiments of the invention. In alternative embodiments, switching assembly and the switching circuits are controlled by different controllers.

The battery modules can be extended to achieve large battery systems. In these circuitries, switches connected to the battery cell units help in bypassing or connecting one or more battery cell units to generate desired voltage profile or for instance to bypass a faulty battery cell unit, which can advantageously increase the lifetime of such a battery system.

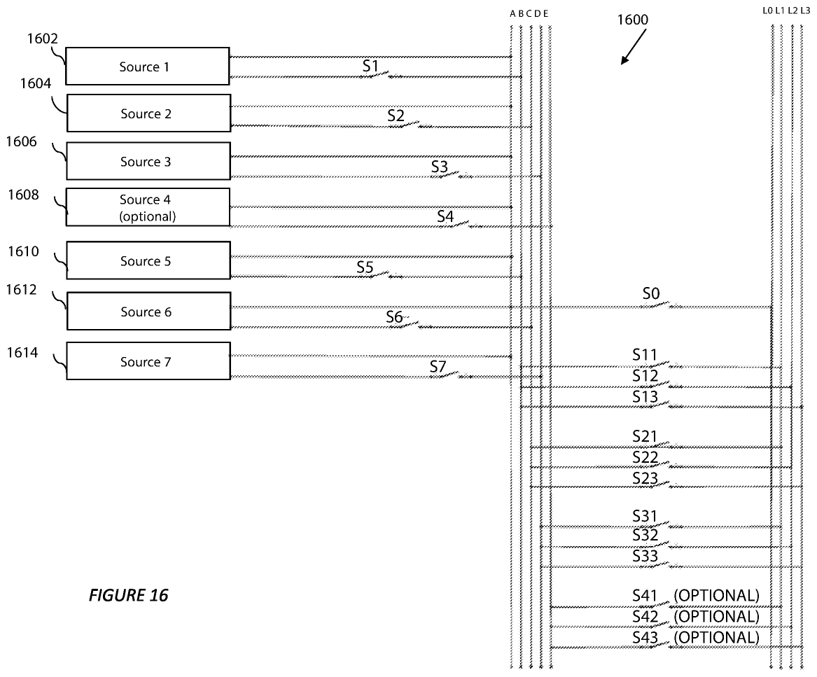

FIG. 16 illustrates a circuit module 1600 which is connected to seven sources i.e. Sources 1-7, according to an embodiment of the present invention.

The circuit module 1600 includes seven sources, i.e. Source 1 (1602), Source 2 (1604), Source 3 (1606), optional Source 4 (1608), Source 5 (1610), Source 6 (1612) and source 7 (1614) for providing electrical energy to an external load (not shown) or receiving electrical energy from an external supply (not shown) via a switching circuit from supply lines i.e. line 0 (L0), line 1 (L1), line 2(L2) and line 3 (L3) through intermediate lines i.e. line A (A), line B (B), line C (C), line D (D) and line E (E). The switching circuit includes switches S1, S2, S3, S4, S5, S6, S7, S0, S11, S12, S13, S21, S22, S23, S31, S32, S33 and optional switches S41, S42, and S43.

As can be seen in the figure, Source 1 (1602) is coupled to Line A, and Line B via switch S1, Source 2 (1604) is coupled to Line A, and Line C via switch S2, Source 3 (1606) is coupled to Line A, and Line D via switches S3, optional Source 4 (1608) is coupled to Line A, and Line E via switch S4, Source 5 (1610) is coupled to Line A, and Line B via switch S5, Source 6 (1612) is coupled to Line A, and Line C via switch S6 and source 8 (1614) is coupled to Line A, and Line D via switch S7. Furthermore, Line A is coupled to Line L0 (neutral) via switch S0, Line B is coupled to Line L1, Line L2 and Line L3 via switches S11, S12 and S13, respectively, Line C is coupled to Line L1, Line L2 and Line L3 via switches S21, S22 and S23, respectively, Line D is coupled to Line L1, Line L2 and Line L3 via switches S31, S32 and S33, respectively and line E is coupled to Line L1, Line L2 and Line L3 via optional switches S41, S42 and S43, respectively.

In one embodiment, the electrical system 1600 is used to generate a controllable voltage profile including three voltage outputs. One voltage output is generated between line 0 and line 1, second output voltage is generated between line 0 and line 2 and third output voltage is generated between line 0 and line 3. The voltage output on these three combinations of lines (L0-L1, L0-L2 and L0-L3) can be a substantially steady voltage output over time (such as a DC voltage) or can be a varying voltage output over time (such as sinusoidal (AC), triangular etc). The sources (Source 1, Source 2, Source 3 and Source 4) can be a battery system or can be a generator. The electrical system can be used to generate a 3-phase supply, when each of these three combinations of lines (L0-L1, L0-L2 and L0-L3) generate sinusoidal signals that are approximately 120-degree phased with another sinusoidal signal generated.

In another embodiment, the electrical system 1600 is used to receive electrical energy from an external supply. A first voltage input is received between line 0 and line 1, a second voltage input is received between line 0 and line 2 and a third voltage input is received between line 0 and line 3. The voltage inputs on these three combinations of lines (L0-L1, L0-L2 and L0-L3) can be a substantially steady voltage output over time (such as DC) or can be a varying voltage output over time (such as sinusoidal (AC), triangular etc) for receiving the electrical energy. The sources (Source 1, Source 2, Source 3 and optional Source 4) can be a battery system or any other means that can store energy in other forms based on the electrical energy received.

In a one embodiment, the switching circuit is configured to be controlled using a controller or a device(s) with equivalent functions.

An advantage of the circuit module disclosed with present embodiment is that one or more additional sources can be connected to the circuit module with just one additional switch added to the circuit module, thereby keeping the cost low of the module and allowing easy alteration to the module. For example, a source 8 can be added to the module with just one additional switch S8 coupled between line A and any one of lines B-E.

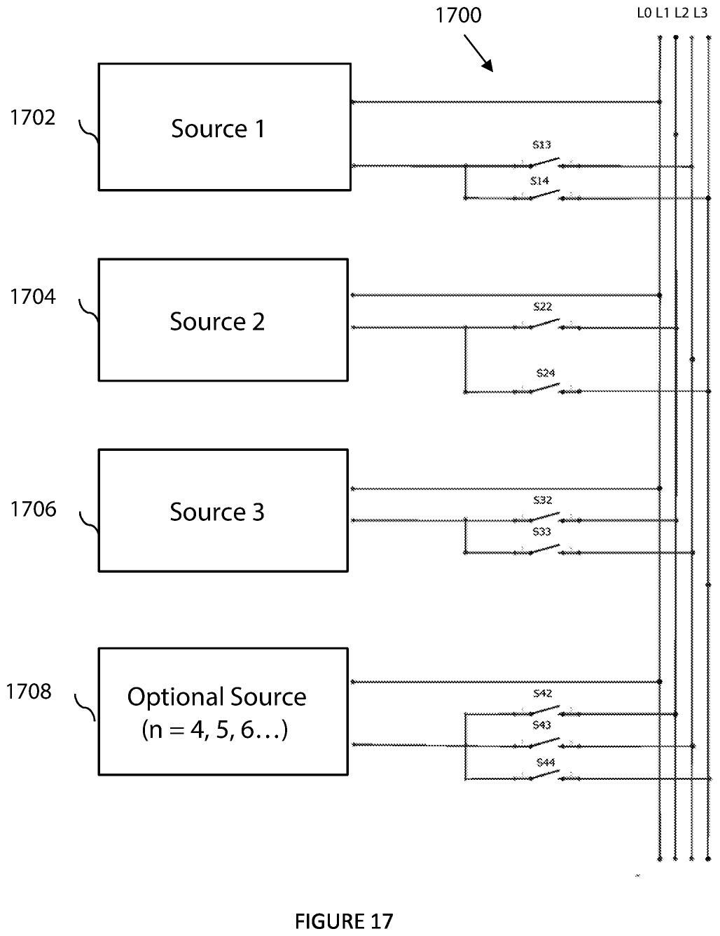

FIG. 17 is an example circuit that can be derived from the generic extendable electrical system 1300 (n, K, L M . . . , N, P) shown in FIG. 13. As can be noted, the values of n, K, L, M and N are n, 2, 2, 2 and 3. The circuit module 1700 is different from circuit module 200 only except that it uses fewer switching devices to connect Sources 1-3 and each source is only connectable to two lines instead of three lines. The use of a smaller number of switches allow less number of operating states compared to the circuit module of 200, however, the circuit module still is useful to—generate multi-phase controllable voltage profile and configured to achieve reconfigurability based on various charge/discharge condition of the sources, thereby facilitating uninterrupted multi-phase supply.

Referring now to FIG. 18, a circuit module 1800 according to another embodiment of the invention is shown. The circuit module 1800 is connected to three sources i.e. Source 1 (1802), Source 2 (1804) and Source 3 (1806) for providing electrical energy to an external load (not shown) or receiving electrical energy from an external supply (not shown) via a switching circuit that includes switches S11, S12, S21, S22, S31 and S32 from supply lines that are line 1 (L1), Line 2 (L2) and Line 3 (L2). The entire arrangement in FIG. 18 is referred to as an electrical system. It is to be noted that whilst the electrical system disclosed in FIG. 1 can be used to provide 3-phase star configuration connections, the electrical system disclosed in FIG. 18 can be used to provide 3-phase delta configuration connections, for which a neutral line is not needed.

In a preferred embodiment, the switching circuit (S11, S12, S21, S22, S31, S32) is configured to be controlled using a controller or a device(s) with equivalent functions. The selective control of the switching circuit helps in achieving various operation states, which are listed in the table below:

| | | Conductive |
|---|---|---|
| Connection Status | State | Switches |
| Source 1 Connected to Lines | ST73 | S31, S32 |
| L1, L2 & L3; Source 2, | | |
| Source 3 Disconnected | | |
| Source 1 Connected to Lines | ST74 | S31 |
| L1 & L2; Source 2, Source 3 | | |
| Disconnected | | |
| Source 1 Connected to Lines | ST75 | S32 |
| L1 & L3; Source 2, Source 3 | | |
| Disconnected | | |
| Source 2 Connected to Lines | ST76 | S21, S22 |
| L1, L2 & L3; Source 1, | | |
| Source 3 Disconnected | | |
| Source 2 Connected to Lines | ST77 | S21 |
| L1 & L2; Source 1, Source 3 | | |
| Disconnected | | |
| Source 2 Connected to Lines | ST78 | S22 |
| L2 & L3; Source 1, Source 3 | | |
| Disconnected | | |
| Source 3 Connected to Lines | ST79 | S11, S12 |
| L1, L2 & L3; Source 2, | | |
| Source 3 Disconnected | | |
| Source 3 Connected to Lines L1 & | ST80 | S11 |
| L3; Source 2, Source 3 Disconnected | | |
| Source 3 Connected to Lines L2 & L3; | ST81 | S12 |
| Source 2, Source 3 Disconnected | | |
| Source 1 Connected to Lines L1, L2 & | ST82 | S31, 21, |
| L3; Source 2 Connected to Lines L1, | | S32, S22 |
| L2 & L3; Source 3 Disconnected | | |
| Source 1 Connected to Lines L1 & L2; | ST83 | S31, S21 |
| Source 2 Connected to Lines L1, | | |
| L2 & L3; Source 3 Disconnected | | |
| Source 1 Connected to Lines L1, L2 & | ST84 | S31, S22 |
| L3; Source 2 Connected to Lines | | |
| L1 & L2; Source 3 Disconnected | | |
| Source 1 Connected to Lines L1 & L3; | ST85 | S32, S22 |
| Source 2 Connected to Lines L2 & L3; | | |
| Source 3 Disconnected | | |
| Source 1 Connected to Lines L1 & L3; | ST86 | S32, S21 |
| Source 2 Connected to Lines L1 & L2; | | |
| Source 3 Disconnected | | |
| Source 1 Connected to Lines L1, L2 & | ST87 | S31, S11, |
| L3; Source 3 Connected to Lines L1, | | S32, S12 |
| L2 & L3; Source 2 Disconnected | | |
| Source 1 Connected to Lines L1 & L2; | ST88 | S31, S11 |
| Source 3 Connected to Lines L1 & L3; | | |
| Source 2 Disconnected | | |
| Source 1 Connected to Lines L1 & L2; | ST89 | S31, S12 |
| Source 3 Connected to Lines L2 & L3; | | |
| Source 2 Disconnected | | |
| Source 1 Connected to Lines L1 & L3; | ST90 | S32, S12 |
| Source 3 Connected to Lines L2 & L3; | | |
| Source 2 Disconnected | | |
| Source 1 Connected to Lines L1 & L3; | ST91 | S32, S11 |
| Source 3 Connected to Lines L1 & L3; | | |
| Source 2 Disconnected | | |
| Source 2 Connected to Lines L1, L2 & L3; | ST92 | S21, S11, |
| Source 3 Connected to Lines L1, L2 & L3; | | S22, S12 |
| Source 1 Disconnected | | |
| Source 2 Connected to Lines L1 & L2; | ST93 | S21, S11 |
| Source 3 Connected to Lines L1 & L3; | | |
| Source 1 Disconnected | | |
| Source 2 Connected to Lines L1 & L2; | ST94 | S21, S12 |
| Source 3 Connected to Lines L2 & L3; | | |
| Source 1 Disconnected | | |
| Source 2 Connected to Lines L2 & L3; | ST95 | S22, S11 |
| Source 3 Connected to Lines L1 & L3; | | |
| Source 1 Disconnected | | |
| Source 2 Connected to Lines L2 & L3; | ST96 | S22, S12 |
| Source 3 Connected to Lines L2 & L3; | | |
| Source 1 Disconnected | | |
| All Sources i.e. Source 1, Source 2, | ST97 | S31, S32, S21, |
| Source 3 Connected to Lines L1, L2 & L3 | | S22, S11, S12 |
| Source 1 Connected to Lines L1 & L2; | ST98 | S31, S21, S11, |
| Source 2 Connected to Lines L1, L2 & L3; | | S22, S12 |
| Source 3 Connected to Lines L1 & L3 | | |
| Source 1 Connected to Lines L1 & L2; | ST99 | S31, S21, S11 |
| Source 2 Connected to Lines L1 & L2; | | |
| Source 3 Connected to Lines L1 & L3 | | |
| Source 1 Connected to Lines L1 & L2; | ST100 | S31, S21, S12 |
| Source 2 Connected to Lines L1 & L2; | | |
| Source 3 Connected to Lines L2 & L3 | | |
| Source 1 Connected to Lines L1 & L2; | ST101 | S31, S22, S11 |
| Source 2 Connected to Lines L2 & L3; | | |
| Source 3 Connected to Lines L1 & L3 | | |
| Source 1 Connected to Lines L1 & L3; | ST102 | S32, S21, S11, |
| Source 2 Connected to Lines L1, L2 & L3; | | S22, S12 |
| Source 3 Connected to Lines L1, L2 & L3 | | |
| Source 1 Connected to Lines L1 & L3; | ST103 | S32, S21, S11 |
| Source 2 Connected to Lines L1 & L2; | | |
| Source 3 Connected to Lines L1 & L3 | | |
| Source 1 Connected to Lines L1 & L3; | ST104 | S32, S21, S12 |
| Source 2 Connected to Lines L1 & L2; | | |
| Source 3 Connected to Lines L2 & L3 | | |
| Source 1 Connected to Lines L1 & L3; | ST105 | S32, S22, S11 |
| Source 2 Connected to Lines L2 & L3; | | |
| Source 3 Connected to Lines L1 & L3 | | |
| Source 1, Source 2, Source 3 Disconnected | ST106 | — |

As can be seen in FIG. 18, Source 1 (1802), Source 2 (1804), Source 3 (1806) are connected to the line 1 (L1) without any switches, however, they may be connected through switches i.e. S33, S23 and/or S13 respectively, as shown in FIG. 18A.

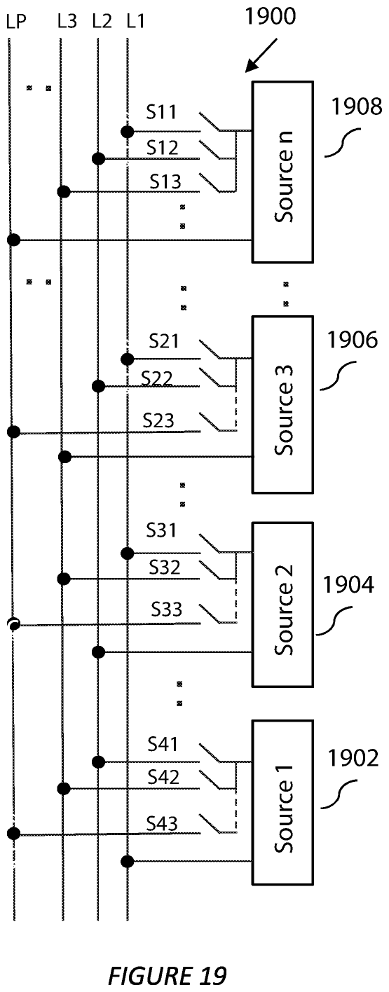

FIG. 19 illustrates a generic extendable electrical system 1900 of the electrical system (n, P) disclosed with FIG. 18 (1800). As can be seen, value n is the total number of sources present in the system and P is the total number of lines that are coupled to one or more numbers of the sources (i to n) of the system. The number switches connected to each of the sources can be in range of 1 to (P−1). For example, when the values of n and P are 3, with 3 switches connected to each source (on a terminal), FIG. 19 will represent the electrical system depicted in FIG. 18. It is to be understood that the circuit module can be used to generate a number of modules by varying the values of n and P.

As with the star configurations in previous embodiments, delta configurations also allow for sources to be connected in series. In some embodiments, to connect two or more sources in series in a 3 phase delta configuration, at least 3+1 electrical lines are needed (thus P≥4).

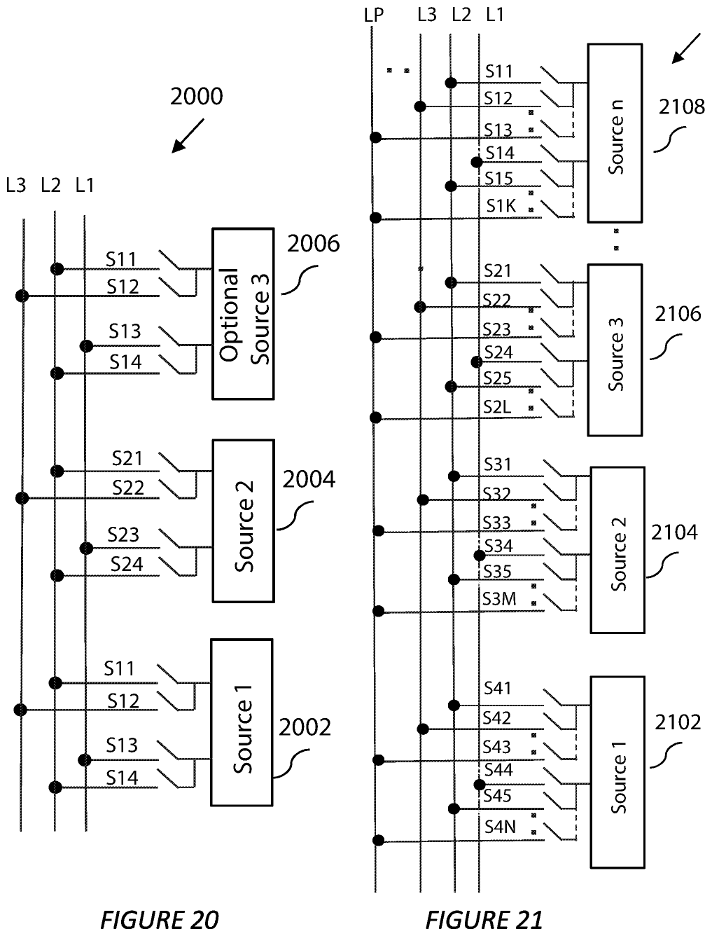

FIG. 20 illustrates a circuit module 2000 according to another embodiment of the invention. The circuit module 2000 is only different from the circuit module 1800 in an aspect that it has more number switches, in particular, the circuit module 2000 allows each terminal of the sources to be connected to two lines, whereas the circuit module 1800 allows only one terminal of the sources to be connected to be two lines. A greater number of switches facilitate the circuit module to be operable in a greater number of states, when compared to the circuit module 1800.

It should be noted that all states achievable based on the circuit module 2000 are not mentioned and other states can be achieved by selectively activating and deactivating various switching devices coupled with the circuit module.

FIG. 21 illustrates a generic extendable electrical system 2100 of the electrical system (n, P) disclosed with FIG. 20 (2000). It is to be understood that the circuit module can be used to generate a number of modules by varying the values of n and P.

In some embodiments, having switches on all paths connected to each terminal is preferred to allow a functioning 3-phase AC electrical supply system (with at least 3 sources) to switch between a star configuration and a delta configuration. One of the advantages of this capability is for creating/certifying one electrical system which can then satisfy both (Star and Delta) requirements without redesign/recertification.

In some embodiments, a controller is configured to receive a user input and/or an external signal/input indicating a desire to switch between delta and star configurations and configure the states of the switching circuit between a delta and a star configuration.

In some embodiments, having switches on all paths connected to the reference terminal allows more flexibility on how sources can be connected, including how and which sources can be connected in series.

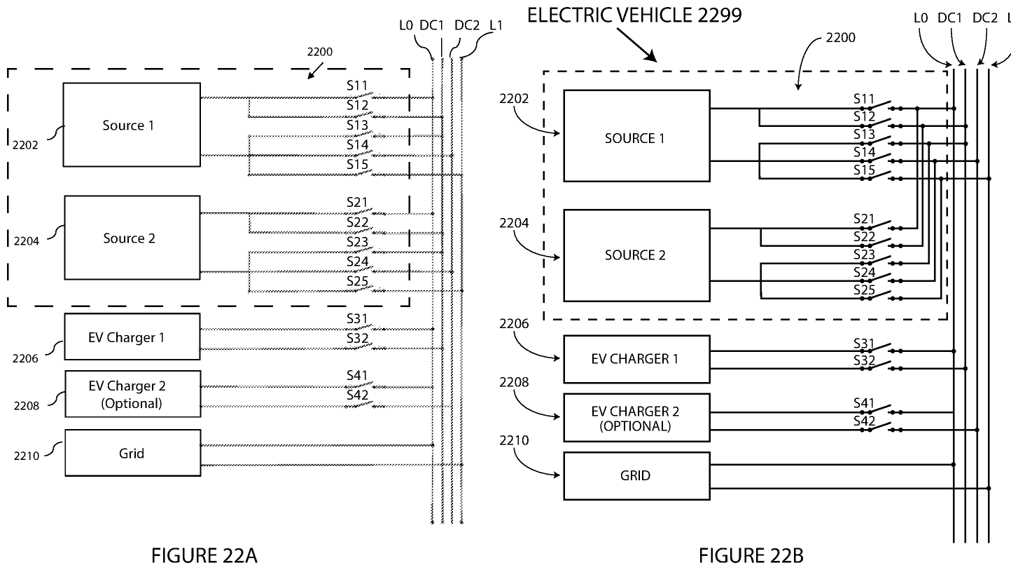

FIG. 22A illustrates an electrical system that includes a circuit module 2200, Source 1 (2202), a Source 2 (2204), a grid (2210), and one or more electrical vehicle chargers i.e. that is EV charger 1 (2206) and an optional EV charger 2 (2208). The EV charger is a power plug that can be connected to a vehicle's charging slot to charge its battery system. The circuit module is used for charging electrical vehicles from the source, and also to charge the sources from the grid. The circuit module includes five inputs (i.e. first input, second input, third input, fourth input and fifth input) connected to four lines (L0, L1, DC1, DC1) via a switching circuit. The switching circuit includes switching devices S11, S12, S13, S14, S15, S21, S22, S23, S24, S25, S31, S32, S41 and S42. The first input is connected to a first source, the second input is connected to the second source, the third input is connected to the grid, and the fourth input is connected to EV charger 1 and the fifth input is connected to EV charger 2. A first terminal (reference terminal) of Source 1 is connected to line L0 and DC line 1 (DC1) via S11 and S12 lines, respectively. A second terminal of Source 1 is connected to line DC1 line, DC2 line and line 1 (L1) via S13, S14 and S15 lines, respectively. A first terminal (reference terminal) of Source 2 is connected to line L0 and DC line 1 (DC1) via S21 and S22 lines, respectively. A second terminal of Source 2 is connected to line DC line 1 (DC1), DC line 2 (DC2) and line 1 (L1) via S23, S24 and S25 lines, respectively. A grid is connected to lines i.e. line 0 (L0) and line 1 (L1). The EV charger 1 is connected to line 0 (L0) and DC line 1 (DC1) via switches S31 and S32, respectively. The EV charger 2 is connected to line 0 (L0) and DC line 2 (DC2) via switches S41 and S42, respectively.

The diagram of FIG. 22 is a simplification of actual implementations, and that in implementation EV Chargers 2006 and 2008 may each include a galvanic isolation element. For example, AC mains typically has an earth conductor. Further, DC systems also share a common conductor, often referred to as a ground or earth. The coupling of the AC and DC ground/earth conductors is undesirable for a range or reasons, including safety related factors. Therefore, the galvanic isolation element is configured to allow connection of AC and DC systems without direct connection of the respective ground conductors. In some embodiments, the switching assembly further comprises a first connection configured to connect with an AC ground, and a second connection configured to connect to a DC ground, and the switching assembly is configured to control the switching assembly to disconnect or substantially isolate the AC and DC grounds whenever said systems are otherwise connected by the switching assembly. AC systems include, for example, mains electrical grid systems including single, two and three phase systems, and DC systems include, for example, battery, EV or solar systems.

Accordingly, in some embodiments, the system is configured to connect with at least one of a solar DC source providing a voltage output that is substantially a direct current (DC) voltage, a DC EV charger load receiving a voltage input that is substantially a DC voltage, and a grid source receiving or providing a voltage profile that is substantially an AC voltage.

In some embodiments where there are at least two energy sources, the controller is configured to determine the maximum desired voltage for a first load (which may be a EV charger), determine the one source has a maximum voltage below a desired maximum voltage, and selectively connect the at least another source in series with the one source to thereby increase the combined voltage output to achieve the maximum desired voltage. Alternatively, the controller can determine the maximum desired voltage for a second load, determine the source has a maximum voltage below the desired maximum voltage of the first load, and above the second load, and selectively connect the one source to the second load. It will be appreciated that where the sources provide AC voltage, the load is ideally an AC load, where the sources provide DC voltage, the load is ideally DC. Where the sources are a mixture of AC and DC, the load could be either AC or DC, even though providing an AC voltage supply to a DC load may not always yield the optimal output.

Any one of the sources can be charged over the grid through L0-L1 lines, when the grid is conducting. For example, Source 1 can be charged when switches S11 and S15 are conducting.

The Sources are also used to provide power. For example, an EV charger 1 and/or EV charger 2 can receive supply from any one of Source 1 or Source 2. For instance, EV charger 2 can receive supply from Source 1 when S11, S14, S41 and S42 switches are conducting. In a different state, Source 1 and Source 2 can be connected in series to connect to and provide power to an EV charger. For example, Source 1 and Source 2 can be connected in series and provide power to EV Charger 2 by controlling switches S11, S13, S22, S24, S41 and S42 to be in a conducting state. This may achieve a higher voltage, higher efficiency and/or higher power output than may be achievable by connecting only a single source to an EV charger. It is to be understood that more than two sources can be connected in series for the same purposes, when there are adequate additional sources, lines and corresponding switches to enable the series connections.

In some embodiments, when the controller determines that it is desirable to produce a higher voltage supply than a voltage that is achievable or optimal for any individual source to produce, the controller configures the switching circuit to change the states of the connections to connect that individual source and another source(s) in series so as to produce that higher voltage supply. This voltage supply may be provided to any load(s) connected to the electrical lines including EV chargers or a grid. In some embodiments, this voltage supply may be provided to any of the rechargeable sources connected to the circuit module, in order to charge any of the connected rechargeable sources.

In some embodiments, the circuit module is used to connect the rechargeable source(s) to receive power from the grid. In an exemplary state, the controller determines that no EV Charger requires AC or DC power supply from the source(s), and connects Source 1 and/or Source 2 to L0 and L1 to receive power from an AC grid. In some embodiments, the circuit module is used to connect the source(s) to provide power to EV chargers or the grid. In an exemplary state, the controller determines the states of charge and capacities of Source 1 and Source 2 and the amount of power required by EV charger 1 and EV charger 2; and manipulates the states of the switching circuit to connect Source 1 between L0 and DC1, and to connect Source 2 between DC1 and DC2 so that both Source 1&2 are controlled to provide DC outputs, e.g. 400V each, and so that one EV can be charged from EV charger 1 providing 400V output for example, while a second EV can be charged from EV charger 2 providing 800V output for example. In another exemplary state, the circuit module is used to connect the source(s) to supply power to the grid. In some embodiments, the controller determines or receives an external input on the anticipated/predicted unit price of electricity and/or the actual present unit price of electricity, determines that it is optimal to sell electricity, and then manipulates the states of the switching circuit and/or the states of the switching assembly so that the voltage from the source(s) are higher than that of the grid. In such states the connected source(s) are configured to supply power to the grid. In some embodiments, the determination is made in an external module or device known as an Energy Management System (EMS), and the decision to charge or discharge the sources are received in the form of an external request to the controller.

Accordingly, in some embodiments the controller is configured to determine or receive information indicative of the anticipated or predicted unit price of electricity and/or the actual present unit price of electricity. Based on this determination, the controller is configured to determine whether it is of benefit to sell any surplus electricity which may be stored in any one or more other sources connected to the system, or is presently being generated by a power generation source currently connected to the system. If so, the controller is configured to change the states of the switching circuit and/or the states of the switching assembly so that the voltage from any source is higher than that of the grid so that the connected source(s) supply power to the grid. In some embodiments, the controller is configured to determine a benefit to sell electricity based on a predicted energy demand of any one or more loads connected to any one or more lines. In some embodiments, the determination is made in an external module or device known as an Energy Management System (EMS, and the decision to charge or discharge the sources are received in the form of an external request to the controller.

The states described above are non limiting as examples of charging vs discharging states and the corresponding controller determination and logic and may apply to many other embodiments set forth in this specification.

By being able to connect sources that can accommodate both AC and DC voltages to charge from an AC grid and discharge to DC EV chargers, the DC chargers can be powered without requiring an AC-DC inverter. The sources, via one or more of: switching circuit configurations and switching assembly configurations, also provide the exact DC voltage needed by the DC EV charger without the need for a DC-DC converter.

Accordingly, in some embodiments the controller is configured to operate the switching circuit states and switching assembly states to connect sources to charge from the grid in one state of the switching circuit, and discharge from the sources to DC EV charger sources in another state of the switching circuit. Where the sources are controllable to a desired voltage output, the DC chargers can be powered without requiring an AC-DC inverter.

Similarly, other states are also achievable by selectively controlling the switching circuit of the circuit module 2200. It should be understood by the person skilled in the art that an EV charger can be an energy source if it is bidirectional and can discharge the vehicle to provide energy.

FIG. 22B shows a variation of the circuit and structure of FIG. 22A. In the embodiment shown, the circuit module 2200 is contained onboard a mobile structure, for example an electric vehicle 2299. The circuit module 2200 of the EV 2299 is housed onboard the EV and has two sources, source 1 2202 and source 2 2024. In an EV embodiment, sources 1 and 2 are rechargeable battery systems. In some embodiments, sources 1 and 2 are reconfigurable battery systems.

The switching circuit has four output connections which are configured to connect to external line sources L0, DC1, DC2, and L1 as shown. The four output connections facilitate the use of a 5-pin charging plug commonly found on EVs and EV charging stations.

Accordingly, in some embodiments the system comprises an electric vehicle having two or more energy sources connected with a switching circuit as described in any other embodiment, and the switching circuit comprises four output lines.

In some embodiments, the controller is configured to determine the availability of power which may be provided on one or more of lines L0, DC1, DC2, and L1. The available power may be AC or DC, and of a variety of voltage. For example, 400V and 800V EV charging networks are common. The controller is further configured to determine the appropriate voltage of the first and second energy sources. Common charging voltages of EV batteries are 400V or 800V. The controller is configured to control the switching assembly such that the charging source voltage is connected with one or more sources having a matching charging voltage. In some embodiments, the controller is configured to connect the sources 2202, 2204 in series, thereby increasing the appropriate charging voltage, when a determined available power supply matches the series-connected sources. Accordingly, the controller is configured to control the switching circuit such that the series connected sources are connected with the appropriate lines having the matched charger power supply.

In some embodiments, the sources and switching assembly are housed within a common enclosure. In some embodiments, one or more of the sources comprise a reconfigurable battery system, and the switching assembly is constructed on the same or a proximate circuit board of at least one reconfigurable battery system.

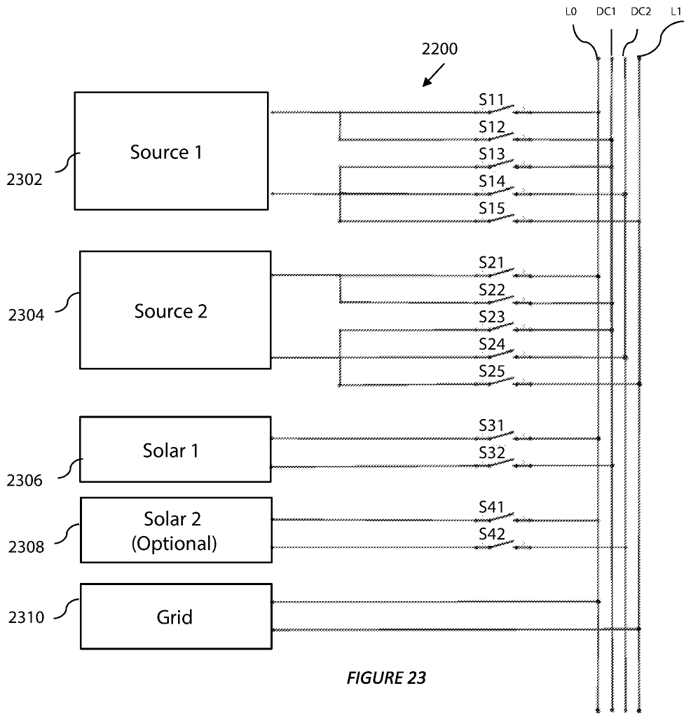

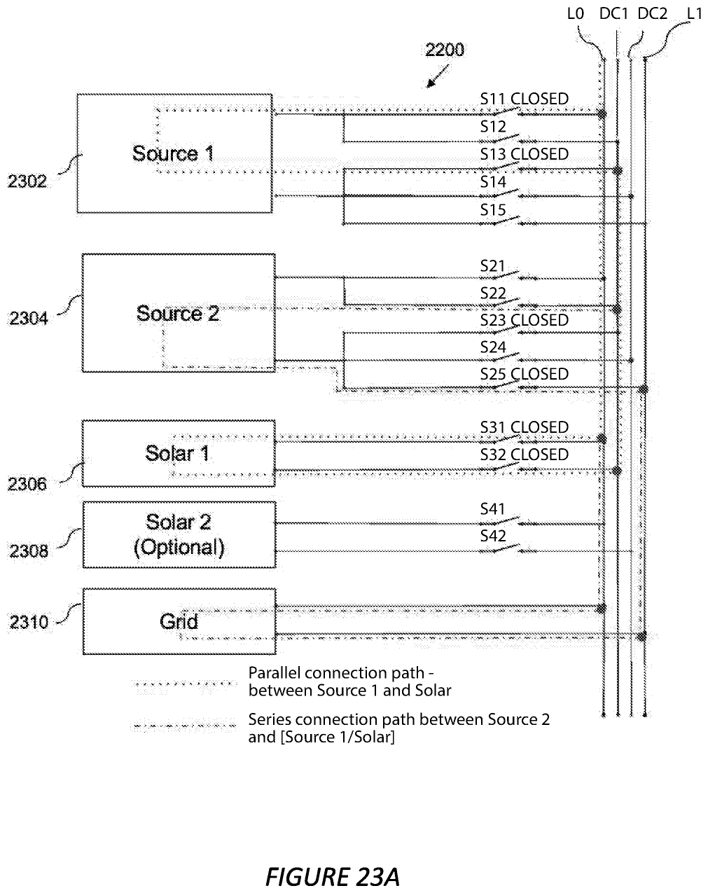

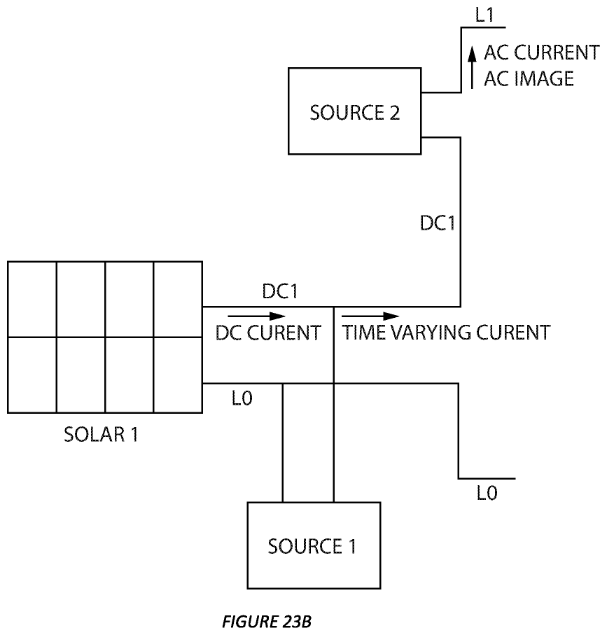

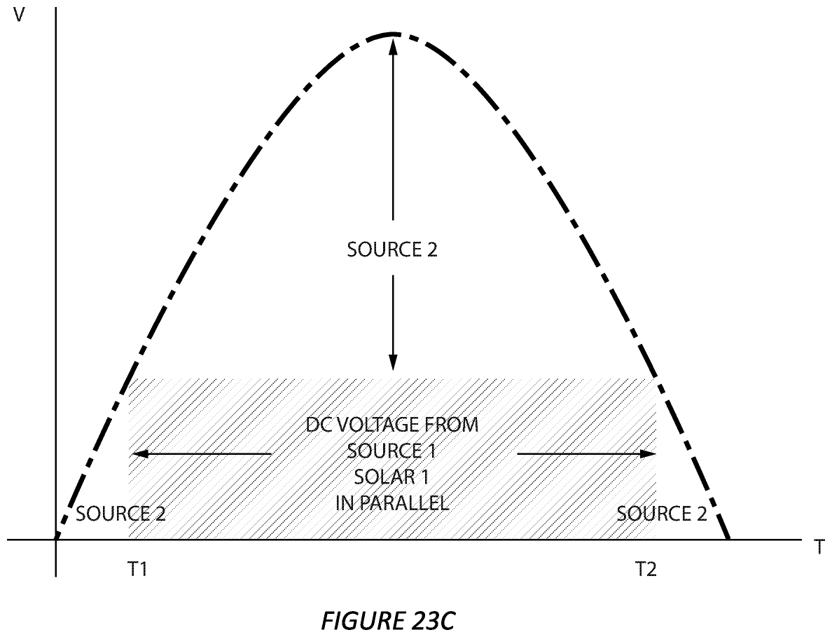

FIG. 23 illustrates use of the circuit module 2200 in accordance with another embodiment of the invention. The circuit module is connected to Source 1 (2302), Source 2 (2304), a grid (2310), a first solar source Solar 1 (2306) and a second solar source Solar 2 (2308). Solar 1 and Solar 2 provide DC voltages that can be used to charge any one of Source 1 or Source 2. For instance, Solar 1 provides voltage profile to Source 2 when S31, S32, S21 and S23 switches are conducting. A grid 2310 is used to charge any one of the sources, or the grid can receive energy from any of the sources. For instance, Source 2 can be charged by the grid or provide energy to the grid when S21 and S25 switches are conducting. In a different state, Source 1 and Source 2 can be connected in series to connect to and receive power from a solar source. For example, Source 1 and Source 2 can be connected in series and receive energy from Solar 2 by controlling switches S11, S14, S22, S24, S41 and S42 to be in a conducting state. This may achieve a higher voltage, higher efficiency and/or higher power output than may be achievable without connecting two sources in series with the solar source. It is to be understood that more than two sources can be connected in series for the same purposes, as long as there are adequate additional lines and corresponding switches to enable the series connections.

In some embodiments, when the controller determines that it is desirable to for one or more sources in combination to receive a higher voltage than a voltage that is achievable or optimal for any other individual source to produce, the controller configures the switching circuit to change the states of the connections to connect that other individual source and another source(s) in series so as to produce that higher voltage. This voltage may be received by any rechargeable source(s) connected to the electrical lines including a rechargeable battery pack. In some embodiments, the voltage may be received by any of the sources capable of receiving charge including a grid. In some embodiments, the source(s) producing the voltage is a solar source.

In some embodiments, the controller of the electrical system is configured to operate the switching circuit to connect sources to charge from an DC solar source in one state of the switching circuit, and connect sources to discharge into the grid in another state of the switching circuit. The DC solar source can therefore supply power to the grid without requiring an AC-DC inverter.

Accordingly, in some embodiments, the controller is configured to operate one or more of: switching circuit states and switching assembly states, to provide the optimal DC voltage desired by the Solar source to maximise efficiency of power transfer without the need for a DC/DC converter or a maximum power point tracker (MPPT).

In some embodiments, the controller is configured to determine or receive an optimum DC voltage for a controllable and variable voltage source to interface with a DC Solar source so that a Maximum Power Point current is drawn from the controllable and variable voltage source, and operate one or more of: switching circuit states and switching assembly states, to substantially match the optimum DC voltage.

By being able to connect sources suitable to accommodate AC and DC voltages to charge from a DC solar source, and then connect sources to discharge AC into the grid, the DC solar source can supply power to the grid without requiring an AC-DC inverter. The sources, via one or more of: switching circuit configurations and switching assembly configurations, also provide the optimal DC voltage desired by the Solar source to maximise efficiency of power transfer without the need for a DC-DC converter and/or a maximum power point tracker (MPPT).

Accordingly, in some embodiments, the controller is configured to operate the switching circuit to connect sources to charge from an DC solar source in one state of the switching circuit, and connect sources to discharge into the grid in another state of the switching circuit. The DC solar source can therefore supply power to the grid without requiring an AC-DC inverter.

Accordingly, in some embodiments, the controller is configured to operate the switching circuit states and switching assembly states, to provide the optimal DC voltage desired by the solar source to maximise efficiency of power transfer without the need for a DC/DC converter or a maximum power point tracker (MPPT). Power efficiency can be maximised by operation based on, for example, a predetermined optimum voltage and current operating magnitude for the solar source.

It is to be understood that additional lines and switches can be present with circuit modules illustrated with FIGS. 22 and 23 for receiving supplies from Source 1 and Source 2. For instance, the illustrated circuit modules can in combination be used with any one of the circuit modules(s) of the embodiments of the invention. Other circuit states are possible by appropriate operation of switching devices.

FIG. 23A illustrates an embodiment of an electrical system which connects Solar 1 and Source 1 in parallel and then in series with Source 2 to connect with the Grid.

In some embodiments, it is beneficial for some sources to be connected in parallel and others in series. For example, by connecting a Solar source in parallel with a source that has a controllable voltage profile and then connecting them in series with another source to connect to a phase of a grid, the Solar source only outputs a DC current while a complete time varying AC voltage and current are produced across the phase.

The two types of dotted lines show the connection path between Source 1, Source 2, Solar 1, and the Grid. Source 1 is connected in parallel with Solar 1 via closed switches S11 S13 S31 and S32. Source 2 is connected in series with Source 1 and the Grid via closed switches S22 and S25.

Source 1 produces a substantially DC voltage and Source 2 produces a substantially AC voltage. Source 1 is directly interfaced with Solar 1 so that Source 1's voltage profile can be controlled in a way to extract a maximum power point voltage and current from Solar 1, and thereby the function of an MPPT device is served.

FIG. 23B is an alternative diagram showing the same connections of FIG. 23A. Source 1 is connected in parallel with Solar 1 to ensure that Solar 1 sees a constant DC current, and to act as MPPT for Solar 1 by adjusting the controllable voltage output of Source 1. The voltage output of Source 1 is controlled in a way to target maximum power transfer efficiency from Solar 1.

Source 2 is connected in series with Solar 1/Source 1 in order to produce an AC voltage profile for connection with the grid. Source 2's voltage output makes up for the difference in voltages between voltage output from Source 1 and the desired target AC voltage waveform required for the grid. Source 2's voltage output is controlled in a way to achieve an AC voltage profile higher or lower in magnitude than the grid in order to discharge to the grid or be charged by the grid.

FIG. 23C depicts exemplary voltage profiles over time (left) of Source 1 and Source 2, as well as an exemplary AC output voltage profile over time (right) across L0 and L1 for the embodiment of FIGS. 23A and 23B.

Source 1 is connected in parallel with Solar 1 and provides a substantially DC voltage profile over time with minor variations to draw the Maximum Power Point current from Solar 1. Source 2 is connected in series with Source 1, Source 2 provides a voltage profile that is a off-set sine-wave such that additively the combined voltage profile observed across L0 and L1 is an AC sine-wave output profile. At all times including t1 and t2, the state of the switching circuit remains unchanged, with the same switches staying open. For the AC profile, only the series source (Source 2) performs switch adjustment to build the AC wave, and this may be done by the source controller in Source 2, or it may be done by any controller that configures the series/parallel connection of cells inside the source. The source (Source1) in parallel with the Solar 1 is substantially at a fixed state also with only some minor variation for DC current control in the solar source. This is because Solar 1's voltage is held substantially constant throughout the AC cycle.

In some embodiments, the state of the switching circuit is changed so that Source 1 and Source 2 are swapped, meaning that Source 2 is connected in parallel with Solar 1 and Source 1 is connected in series with Source 2. In some embodiments, any other available sources can be connected in place of either or both of Source 1 and Source 2, or connected in parallel with either or both of them to provide additional capacity. Alternatively, given additional lines, any other available sources can be connected in series with either or both of Source 1 and Source 2, to provide additional voltage amplitude.

It should be noted that since Source 1 and Source 2 may be used differently in some of the above embodiments, they may charge/discharge and/or age at different rates. The controller may be configured to balance sources by a determination of SoC or SoH or any other relevant measures and change the control parameters to change the state of the switching circuit for balancing purposes.

In some embodiments, the electrical system has at least one energy source that is a DC Solar source providing a output voltage that is substantially a direct current (DC), at least one energy sources that is a first controllable and variable voltage source acting as a DC source outputting substantially a direct current (DC), at least one energy source that is a second controllable and variable voltage source outputting a part or a whole of a substantially sine-wave voltage waveform; and the controller is configured to: change the state of the switching circuit to connect the DC Solar source in parallel with the first controllable and variable voltage source, and to connect the first controllable and variable voltage source in series with the second controllable and variable voltage source; so that an AC output is produced by the electrical system.

The first controllable and variable voltage source outputs a voltage that is substantially DC, but not completely. For example, the voltage output may need to be controlled to be higher or lower based upon a number of factors including: how much current is desired to be drawn from the solar panel, and how much current is demanded or supplied by the connected grid.

The substantially sine-wave voltage waveform may not be exactly sine-wave, and may be offset from the X-axis of FIG. 8, such that the end AC output is an AC waveform.

In another embodiment, Source 1 is a voltage source able to source and sink power whereby energy is captured or released from a storage element which may be a capacitor or rotating machine. In such an embodiment, Source 1 and Source 2 may not be swapped with each other by changing the state of the switching circuit as Source 2 is a battery and Source 1 isn't. Although Source 2 can be swapped with another battery source connected to the electrical system.

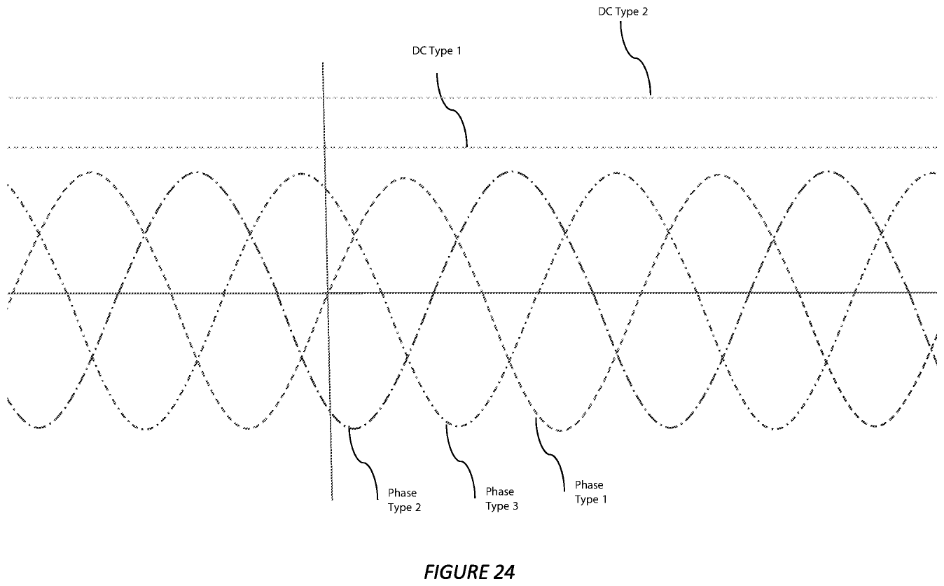

FIG. 24 illustrates various voltage signals that are used to charge sources or the grid. In some embodiments, a single-phase type 1 signal is supplied from the grid to source(s) over lines L0-L1. In other embodiments DC type 1 or DC type 2 is supplied from solar supplies to the sources. In alternative embodiments, L2 and L3 lines are included in the circuit module of 2200 and a 3-phase power supply from the grid is used to charge the sources over L0-L3 lines.

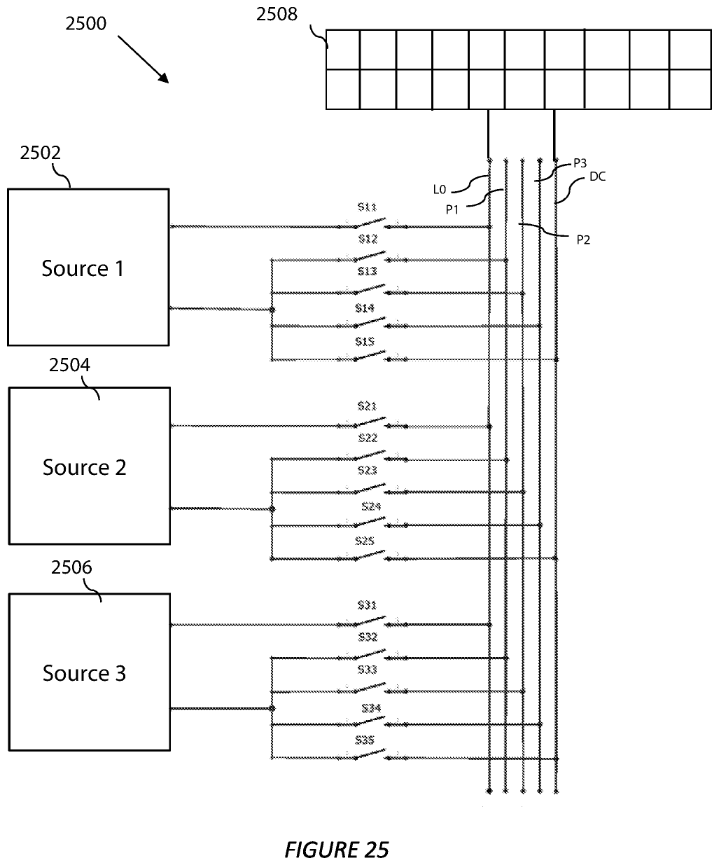

An electrical system 2500 according to another embodiment of the invention is shown in FIG. 25. The electrical system 2500 includes three sources, Source 1 (2502), Source 2 (2504) and Source 3 (2506) for providing electrical energy to an external load (not shown) and receiving electrical energy from an external supply that is a solar panel 2508 via a switching circuit that includes switches S11, S12, S13, S14, S15, S21, S22, S23, S24, S25, S31, S32, S33, S34 and S35 from supply lines including neural (L0), Line 1 (P1), Line 2 (P2), Line 3 (P3) and DC Line (DC).

As can be seen in FIG. 25, Source 1 (2502), Source 2 (2504) and Source 3 (2506) are coupled to line 0 (L0) via switches S11, S21, S31 and S41, respectively, coupled to the Line 1 (P1) via switches S12, S22, S32 and S42, respectively, coupled to the Line 2 (P2) via switches S13, S23, S33 and S43, respectively, coupled to the Line 3 (P3) via switches S14, S24, S34 and S44, respectively and coupled to the DC Line (DC) via switches S15, S25, S35 and S45, respectively. The solar panel is coupled between the line 0 (L0) line and the DC line (DC).

In one embodiment, the electrical system 2500 is used to generate a controllable voltage profile including three voltage outputs. A first voltage output is generated between line 0 and Line 1, a second output voltage is generated between line 0 and Line 2 and a third output voltage is generated between line 0 and Line 3. The voltage output on these three combinations of lines (L0-L1, L0-L2 and L0-L3) can be a substantially steady voltage output over time (such as a DC voltage) or can be a varying voltage output over time (such as sinusoidal (AC), triangular etc). The sources (Source 1, Source 2, and Source 3) can be a battery system or can be a voltage generator.

The switching circuit (S11, S12, S13, S14, S15, S21, S22, S23, S24, S25, S31, S32, S33, S34, S35) is configured to be controlled using a controller or a device(s) with equivalent functions. The selective control of the switching circuit helps in achieving various operation states some of the achievable states are listed in the table below:

| Charging/ | Connection | |
|---|---|---|
| Discharging | Status | Conductive Switches |
| Discharging | ST107 | S11, S12, S21, S23, S31, S34 |
| Charging | ST108 | S11, S15, S21, S25, S31, S35 |

Other circuit states may be achieved by selectively activating and deactivating various switching devices coupled with the circuit module. In some embodiments the solar panel 2508 is connected with Source 1 to charge it during the day via turned on switches S15, S11; then in another state of the switching circuit, Source 1 discharges into the grid (not shown) at night via turned on switches S11 and one S12, S13, or S14; depending on which phase source 1 is to connect/discharge to. In some embodiments, Source 2 or Source 3 are charged by the solar panel 2508 instead. In some embodiments, two or more sources can be connected in parallel with the solar panel 2508 to receive charge from it. In some embodiments, two or more sources can be connected in series to receive charge from the solar panel 2508. In some embodiments, two or more sources can be connected in parallel or in series to the same phase to discharge into the grid. However, there must be at least enough sources connected so that all 3 phases of the grid receive charge from the sources.

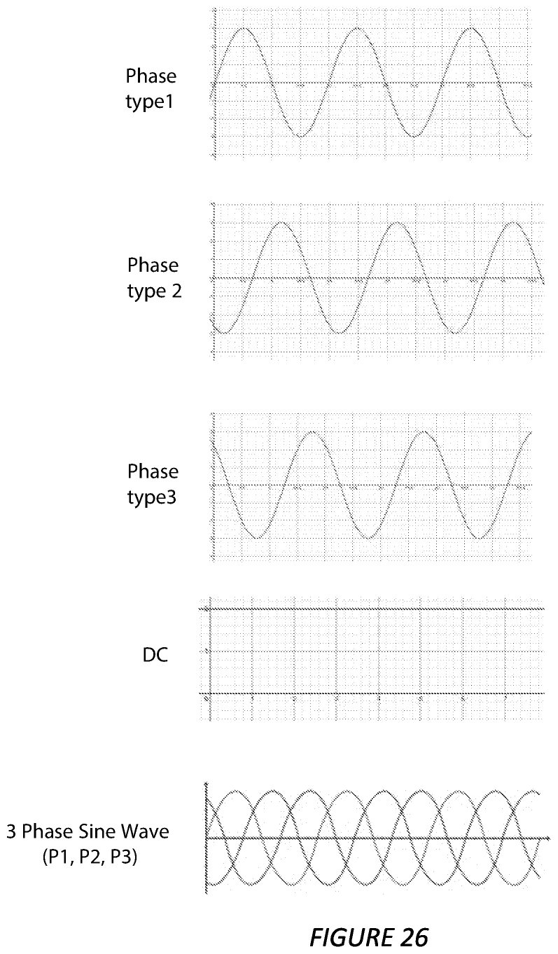

In accordance with an embodiment, an electrical system uses three sources i.e. Source 1, Source 2 and Source 3, that are used with a circuit module 2500 to generate a 3-phase sine wave voltage output (Phase type 1, Phase type 2, and Phase type 3). The electrical system is charged over a DC output received from a solar panel 2508 as shown in FIG. 26. The sources include battery packs that are charged over line 0 (L0) and direct current lines (DC). When each of the sources is sufficiently charged, each of the sources provides a sine wave output. In this example, Source 1 generates a type 1 sine wave voltage output P1 over the line 0 and the line P1, Source 2 generates a type 2 sine wave voltage output P2 over the line 0 and the line P2 and Source 3 generates a type 3 sine wave voltage output P3 over the line 0 and the line P3. These three sine wave voltages are approximately 120-degree phased, resultantly providing an AC supply as depicted in the figure. DC (DC type 1, DC type 2) will be generated from the solar panel 2508, and is used to charge the sources. The AC loads (not shown) would operate as expected when they are coupled to the lines neutral (L0), Line P1 (P1), Line P2 (P2) and Line P3 (P3). The electrical system can also be used to generate other forms of voltage outputs.

FIG. 27 a power supply system 2700 that is already known in the art. The system requires a maximum power point tracker (MPPT) 2704, an inverter 2708, a solar cell 2702 and a battery system 2706 to generate three-phase voltage output, to deliver to the loads 2710. The voltage output is delivered over lines i.e line 0 (L0), Line 1 (L1), Line (L2) and Line (L3). A grid 2712 is used to charge the battery system 2706.

A power supply system 2800 according to another embodiment of the invention is shown in FIG. 28. The power supply system uses an electrical system 2802, that eliminates the requirement for MPPT in extracting the maximum power efficiency from a solar source. The states of the switching circuit allow a solar panel to be connected to the electrical system without the use of an MPPT. For example, a rechargeable energy storage unit configured to selectively receive power via the circuit module can be connected with a solar DC source and the voltage between the solar DC source and the rechargeable energy storage unit controlled in such a way that the power provided by the solar DC source is maximised. In some embodiments, the rechargeable energy storage unit is configured to produce a DC voltage. This may at least in part be achieved by controlling the voltage across the energy storage unit and/or a number of series connected energy storage units by controlling a combination of: the switching assembly inside an energy storage unit, and the states of the switching circuit to manipulate connections of one or more energy storage units to one or more of the phases of the power supply system.

MPPT or Maximum Power Point Tracking is an algorithm that is included in external controllers used for extracting maximum available power from a PV (Solar) module under certain conditions. The voltage at which a PV module can produce maximum power is called “maximum power point” (or peak power voltage). Maximum power varies with solar radiation, ambient temperature and solar cell temperature. Usually, the preferable solar voltage would be determined by the external controller through pre-programmed lookup tables on voltage vs current, with potentially some other determinations (resistance measurements etc). In some cases, it could also be determined by the PV module itself and communicated to the external controller. MPPT then checks the output of a PV module, compares it to battery voltage then fixes what is the best power that PV module can produce to charge the battery and converts it to the best voltage to get maximum current into battery. It can also supply power to a DC load, which is connected directly to the battery. In this respect, it contains a key DC-DC converter function. Because in some embodiments of the invention, one or more of the switching circuit and the switching assembly are configured by the controller (the source controller(s) or the circuit controller or both) to produce a controllable voltage output, the DC-DC converter aspect of the MPPT is no longer required. The controller simply needs to determine the voltage being generated by the PV module at any given time, and change the voltage of the connected rechargeable battery source(s) to match the PV module's voltage in order to extract power from the PV module efficiently. The voltage of battery sources needs to be a lower voltage compared to the PV modules voltage to receive charge from the PV module. For example, the voltage of the battery sources can be a fixed amount lower than the PV module's output voltage.

A prior art use of MPPT in power supply systems is depicted in FIG. 27, and can be compared with an exemplary embodiment of the invention depicted in FIG. 28. According to some embodiments, the power supply system uses an electrical system 2802, that eliminates the use of an inverter. In some embodiments, the states of the switching circuit to manipulate connections of one or more of the battery packs to one or more of the phases advantageously do not require any of the battery packs to switch polarity for the system to generate a 2 phase (split-phase) or a 3 phase AC output. The states of the switching circuit therefore allow sources to be connected to the electrical system without the use of an H-bridge or an inverter. A prior art use of an inverter in power supply systems is depicted in FIG. 27, and can be compared with an embodiment of the invention depicted in FIG. 28.

It is to be understood that a variety of the electrical system (e.g. 2814) and circuit modules disclosed with present invention can be used with the disclosed system.

For an exemplary purpose, the electrical system 2802 uses an electrical system 2814 to provide electrical energy or to receive electrical energy. The electrical system 2814 includes three or more sources that are coupled to line 0 (L0), Line 1 (L1), Line 2 (L2), Line 3 (L3) and DC input line (DC In) and DC output line (DC Out) via a switching circuit. The electrical system 2814 can be considered as a derivation of the generic electrical system explained in an earlier embodiment with FIG. 13. The system is connected to a grid and a solar panel, and it can operate in charging or discharging modes.

Accordingly, in some embodiments the controller is configured to determine one or more sources connected to at least one input are rechargeable sources which require charging (demand sources), to determine a one or more sources connected to another input are suitable for supplying charging current (supply sources), and operate the switching circuit to connect the supply sources and the demand sources to a common set of electrical lines. In some embodiments, a demand source is also called a load.

Following description is provided for n=3 (for simplicity reason), however, it shall be appreciated that for other value of n (more than 3), in similar configuration can be achieved. It should be noted that additional switches would be required when value of n is more than three. For instance, when the value of n is 6, total number of 36 switching devices would be needed, i.e. 6 switching devices coupled to each source. When the value of n is 3, the system includes three sources i.e. Source 1 (2804), Source 2 (2806) and Source 3 (2808) for providing electrical energy to external loads (DC load 1, DC load 2, Phase load 1, Phase load 2 and phase load 3) or receiving electrical energy from an external supply (grid and/or solar panel) via a switching circuit that includes switches S11, S12, S13, S14, S15, S16, S21, S22, S23, S24, S25, S26, S31, S32, S33, S34, S35, S36 from supply lines that are neural (L0), Line 1 (L1), Line 2 (L2), Line 3 (L3) and DC input line (DC In) and DC output line (DC Out). As can be seen in the figure, Source 1 (2804), source (2806) and Source 3 (1108) are connected to the neural line (L0) via switches S11, S21 and S31. Furthermore, Source 1 (2804), source (2806) and Source 3 (2808) are connected to the line 1 (L1) via switches S12, S22 and S32, respectively. Similarly, Source 1 (2804), source (2806) and Source 3 (2808) are connected to the line 2 (L2) via switches S13, S23 and S33, respectively, whereas, Source 1 (2804), source (2806) and Source 3 (2808) are connected to the line 3 (L3) via switches S14, S24 and S34, respectively.

In some embodiments, the electrical system 2814 is used to generate a controllable voltage profile that includes 3 phase voltage outputs. One voltage output is generated between line 0 and line 1, second output voltage is generated between line 0 and line 2 and third output voltage is generated between line 0 and line 3. The voltage output on these three combinations of lines (L0-L1, L0-L2 and L0-L3) can be a substantially steady voltage output over time (such as a DC voltage) or can be a varying voltage output over time (such as sinusoidal (AC), triangular etc). The sources (Source 1, Source 2, and Source 3) can be a battery system or can be a generator.

The switching circuit (S11, S12, S13, S14, S15, S16, S21, S22, S23, S24, S25, S26 S31, S32, S33, S34, S35, S36) is configured to be controlled using a controller or a device(s) with equivalent functions. The selective control of the switching circuit helps in achieving various operation states It shall be understood that any of the above described embodiments of the inventions may be adopted based on parameters such as strength and drawback of each of these embodiments, the battery cell properties such as battery type (including chemistry, battery size and others), type of the terminal used on the battery packs, battery cost, battery voltage, longevity of the cell, fault probability of the battery cell, switching device properties (including type, resistance/energy losses, longevity of the switching device), application type (including utilisation and importance of reliability), difficulty in changing battery cell packs, and other practical scenarios.

### Interpretation

This specification, including the claims, is intended to be interpreted as follows: Embodiments or examples described in the specification are intended to be illustrative of the invention, without limiting the scope thereof. The invention is capable of being practised with various modifications and additions as will readily occur to those skilled in the art. Accordingly, it is to be understood that the scope of the invention is not to be limited to the exact construction and operation described or illustrated, but only by the following claims. The mere disclosure of a method step or product element in the specification should not be construed as being essential to the invention claimed herein, except where it is either expressly stated to be so or expressly recited in a claim. The terms in the claims have the broadest scope of meaning they would have been given by a person of ordinary skill in the art as of the relevant date. The terms “a” and “an” mean “one or more”, unless expressly specified otherwise. Neither the title nor the abstract of the present application is to be taken as limiting in any way as the scope of the claimed invention. Where the preamble of a claim recites a purpose, benefit or possible use of the claimed invention, it does not limit the claimed invention to having only that purpose, benefit or possible use. In the specification, including the claims, the term “comprise”, and variants of that term such as “comprises” or “comprising”, are used to mean “including but not limited to”, unless expressly specified otherwise, or unless in the context or usage an exclusive interpretation of the term is required. The disclosure of any document referred to herein is incorporated by reference into this patent application as part of the present disclosure, but only for purposes of written description and enablement and should in no way be used to limit, define, or otherwise construe any term of the present application where the present application, without such incorporation by reference, would not have failed to provide an ascertainable meaning. Any incorporation by reference does not, in and of itself, constitute any endorsement or ratification of any statement, opinion or argument contained in any incorporated document. Reference to any background art or prior art in this specification is not an admission that such background art or prior art constitutes common general knowledge in the relevant field or is otherwise admissible prior art in relation to the validity of the claims.

1. An electrical system comprising a controller and a circuit module configured to connect energy sources with multiple line outputs, the circuit module comprising:
four or more inputs comprising:
a first input configured to connect to a first energy source,
a second input configured to connect to a second energy source;
a third input configured to connect to a third energy source; and
a fourth input configured to connect to a fourth energy source;
wherein at least one of the first energy source, second energy source, third energy source, or fourth energy source comprises a controllable and variable voltage source comprising a switching assembly configured to:
disconnect any one or more of the energy storage cell units from being connected with any other energy storage cell units; and
connect in series any one of the energy storage cell units with any other energy storage cell unit;
wherein the controllable and variable voltage source comprises a rechargeable energy storage unit configured to selectively receive power from any source via the circuit module;
wherein at least one of the first energy source, second energy source, third energy source, or fourth energy source comprises a DC source;
three or more outputs configured to connect with three or more electrical lines, the three or more outputs comprising connections with:
a first set of electrical lines comprising a first electrical line and a second electrical line;
a second set of electrical lines comprising the first electrical line and a third electrical line; and
a third set of electrical lines comprising the first electrical line and a fourth electrical line,
wherein the inputs are configured to connect with the first, second, and third energy source and collectively facilitate a three-phase power supply, and
wherein the one or more of the one or more controllers are configured to:
selectively operate switching devices of one or more of the switching circuit;
selectively operate one or more switching assemblies inside one or more of the energy sources; and
operate the switching circuit for one or more of:
configuring the DC source in series with one of the one or more variable voltage sources; and
configuring the DC source in parallel with one of the one of more variable voltage sources.

2. (canceled)

3. The electrical system as claimed in claim 1, wherein:
the first set of electrical lines is configured to connect to a first electrical load;
the second set of electrical lines is configured to connect to a second electrical load,
the third set of electrical lines is configured to connect to a third electrical load, and
the first electrical load, second electrical load, and third electrical load comprise a three phase load.

4-7. (canceled)

8. The electrical system as claimed in claim 1, wherein the circuit controller is configured to operate the switchable connections of the first and second terminals to provide a three-phase star power supply to the outputs to electrical lines.

9. The electrical system as claimed in claim 1, wherein the circuit module further comprises a third input configured to connect to a third energy source;
wherein the switching circuit comprises a state where:
the second input is connected to outputs to the second set of electrical lines; and
the third input is connected to outputs to the third set of electrical lines, and
wherein the inputs configured to connect with the first energy source, second energy source and third energy source collectively facilitate a three-phase delta power supply.

10. The electrical system as claimed in claim 1, wherein the controller is configured to:
determine one or more measures of at least one energy source, including measures indicative of source performance; and
selectively operate the switching circuit to connect at least one other energy source to electrical lines either in place of, or in parallel connection with, or in series with, the at least one energy source based on the determined one or more measures.

11. The electrical system as claimed in claim 1, wherein the controller is configured to:
selectively operate the switching circuit to connect three sources to three sets of electrical lines;
determine one or more measures of each source, including measures indicative of performance;
based on the determined measures, determine which source has the weakest performance;
connect the fourth source either:
in place of, or
in parallel connection with, or
in series
with the charge storage device with the determined to have the weakest performance.

12-14. (canceled)

15. The electrical system as claimed in claim 1, wherein:
each input has a first and second terminal
the switching circuit is configured to selectively operate in states comprising at least:
a delta state in which:
the first terminal of the first input is connected to third output,
the second terminal of the first input is connected to fourth output,
the first terminal of the second input is connected to the second output,
the second terminal of the second input is connected to third output,
the first terminal of the third input is connected to second output,
the second terminal of the third input is connected to fourth output;
a star state in which:
the first terminal of the first input is connected to first output,
the second terminal of the first input is connected to second output,
the first terminal of the second input is connected to the first output,
the second terminal of the second input is connected to third output,
the first terminal of the third input is connected to first output,
the second terminal of the third input is connected to fourth output;
the controller is configured to control operation of the switching circuit between the delta and star states.

16-24. (canceled)

25. The electrical system as claimed in claim 1, wherein:
the first energy source is configured to provide a controllable voltage profile of a rectified-AC voltage output and the second energy source is a source able to provide a controllable voltage profile of a rectified-AC voltage output,
the first energy source is configured to provide a rectified AC voltage output that is approximately in phase with but of opposite polarity to the rectified AC voltage output of the second energy source, and
for a state of the switching circuit in which the first input is connected to the first set of electrical lines: the first energy source provides a half-sine-wave voltage output, and
for the second state of the switching circuit in which the first input is connected to the second set of electrical lines: the first energy source provides a subsequent half-sine-wave voltage output.

26. (canceled)

27. The electrical system as claimed in claim 1, wherein:
the first energy source has a positive controllable voltage profile,
the second energy source has a bipolar controllable voltage profile,
the third energy source has a negative controllable voltage profile, and
the controller is configured to fill selectively operate the switching circuit to provide a three-phase voltage output such that:
the first source is connected to each of the electrical lines to provide a positive voltage part-phase for each of the three phases;
the third source is connected to each of the electrical lines to provide a negative voltage part-phase for each of the three phases; and
the second source is connected to each of the electrical lines to provide both a positive and negative part-phase for each of the three phases.

28. The electrical system as claimed in claim 1, wherein:
the first energy source and the second energy source have a positive controllable voltage profile,
the third energy source and the fourth energy source have a negative controllable voltage profile, and
the controller is configured to:
selectively operate the switching circuit to connect the first input, second input, third input, and fourth input to the three electrical lines to thereby provide a three-phase voltage output such that:
the first energy source and the second energy source are respectively connected to electrical lines to provide a positive voltage part-phase for each of the three phases, and
the third energy source and the fourth energy source are respectively connected to electrical lines to provide a negative voltage part-phase for each of the three phases.

29. The electrical system as claimed in claim 1, wherein the controller is configured to:
determine a desired three phase voltage profile,
determine voltage profile information of three sources suitable to collectively provide a three phase voltage output, and
operate the switching circuit based to connect the three sources to three electrical lines based on the determined desired voltage profile and the determined voltage profile of each of the three sources.

30-31. (canceled)

32. The electrical system as claimed in claim 1, wherein:
at least one variable voltage source is configured to output a part or a whole of a substantially sine-wave voltage waveform, and
the controller is configured to operate the switching circuit to connect the DC source in series with the controllable and variable voltage source so that an AC output is produced by the electrical system.

33. The electrical system as claimed in claim 1, wherein:
at least one of the DC sources is a DC Solar source providing an output voltage that is substantially a direct current,
at least one energy source is a controllable and variable voltage source acting as a DC source outputting substantially a direct current,
at least one of the energy sources is a second controllable and variable voltage source outputting a part or a whole of a substantially sine-wave voltage waveform, and
the controller is configured to:
change the state of the switching circuit to connect the DC Solar source in parallel with the first controllable and variable voltage source;
connect the first controllable and variable voltage source in series with the second controllable and variable voltage source; and
cause an AC output to be produced by the electrical system.

34. The electrical system as claimed in claim 1, wherein at least one of the energy sources is one or more of:
a DC (supply) source providing a voltage output that is substantially a direct current (DC) voltage output, for example from DC output,
a DC (supply) Solar source providing a voltage output that is substantially a direct current (DC) voltage output,
a DC EV charger (supply or demand) source receiving or providing a voltage input that is substantially a direct current (DC) voltage input,
a capacitor,
a rotating machine,
a grid (supply or demand) source receiving or providing a voltage profile that is substantially an AC voltage input that is substantially an AC voltage input,
an AC (supply or demand) source providing a voltage output that is substantially an alternating current (AC) voltage output,
a rectified-AC (supply or demand) source providing a voltage output that is substantially a rectified alternating current (rectified-AC) voltage output,
a supply source comprising one or more of a solar power module, a mains/grid supply, an EV charger and/or a battery pack,
a demand source comprising one or more of a mains/grid supply (configured to receive back-feed power), an EV charger and/or a rechargeable battery pack, and
a supply and demand source comprising a controllable and variable voltage source comprising a switching assembly operable to cause the controllable and variable voltage source to provide a controllable and variable voltage profile;
and the system further comprises at least one energy source.

35. The electrical system as claimed in claim 1, wherein:
in one state of the switching circuit, the controller is configured to connect sources to charge from one or more of:
a DC source,
a DC Solar source, or
a DC EV charger source, and
in another state of switching circuit, the controller is configured to connect sources to discharge into the grid.

36. The electrical system as claimed in claim 35, wherein:
the DC source is a Solar source, and
the controller is configured to:
determine or receive an optimum DC voltage for a controllable and variable voltage source to interface with a DC Solar source so that a Maximum Power Point current is drawn from the controllable and variable voltage source; and
operate one or more of: switching circuit states and switching assembly states to substantially match the optimum DC voltage.

37. (canceled)

38. The electrical system as claimed in claim 1, wherein the controller is further configured to control charging of a variable voltage source from the DC source.
